(19) United States
(12) Patent Application Publication
(10) Pub. No.: US 2002/0184043 A1
(43) Pub. Date: Dec. 5, 2002

(54) Systems and methods for managing business metrics

(76) Inventors: Egidio Lavorgna JR., Ridgefield, CT (US); Ramesh Thuravil, Stamford, CT (US); Richard Metz, Wilton, CT (US)

Correspondence Address: John S. Beulick, Armstrong Teasdale LLP, Suite 2600, One Metropolitan Sq., St. Louis, MO, 63102, US

(21) Appl. No.: 09/873,815

(22) Filed: Jun. 4, 2001

(51) Int. Cl. G06F 17/60

(52) U.S. Cl. 705/1

(57) ABSTRACT

A method for management of business metrics using a system including a server and at least one user accessible device communicative with the server, the server having a database and a web interface, the method providing user with a web interface configurable to a template accommodating business metrics data by the user. An apparatus comprising a computer, a server configured with a database enabled for storing and retrieving a web interface, the server additionally configured to upload and store business metrics data in a database, and a network communicative with the server and a user device connected to the network.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to a business metrics management system and method and more particularly to a web based system for capturing and utilizing business metrics to manage business operations.

As used herein, the term “business metrics” means business measurements such as business numbers and data which are measurements of some facet of business activity or observations of a facet of business operations. Typical business metrics include service quality, rating customer relationships, productivity and numbers indicative of employee satisfaction. Such business metrics are very useful in managing business entities such as corporations to provide information to corporation management so as to enable management to operate their business efficiently. Capturing, analyzing, reporting and assessing business metrics can be a highly valued business management tool.

The need for business metrics is more pronounced in corporations which have multiple business units, particularly if such business units are large and located in different geographical areas of the United States or world.

In large companies with multiple locations, a business metrics management system can facilitate sharing of information across business locations and units. In addition, manual compilation of data can be dramatically reduced. Additionally, the availability of a readily customizable spreadsheet for each of several business unit is a major advantage to that business unit because this may result in capture of needed valuable business metric data thereby enhancing analysis and reporting and business management capability.

### BRIEF SUMMARY OF THE INVENTION

Systems and methods for managing business metrics are described herein. In an embodiment, the method for management of business metrics uses a system including a server and at least one user accessible device communicative with the server, the server having a database and a web interface, and the method providing a user with a web interface configurable to a template accommodating business metrics data by the user.

In another embodiment, the system comprises a computer, a server configured with a database enabled for storing and retrieving a web page interface configurable to a template, said server further configured to upload and store user input regarding business metrics in a database; and a network communicative with the server and a user operated device connected to the network.

In another embodiment, the system comprises an apparatus having associated therewith a computer, a server configured with a database enabled for storing and retrieving a web interface, the server additionally configured to upload and store business metrics data in a database, and a network communicative with the server and a user device connected to the network.

In another embodiment, the system provides an apparatus comprising means for providing a web interface to a user, means for configuring the web interface to a template, means for entering business metrics data in the template and means for storing and retrieving the template.

In another embodiment the system comprises a management system comprising a computer, a server configured with a database enabled for storing and retrieving a web page interface, said server further configured to upload and store user input regarding business metrics in a database, and a network communicative with the server and a user operated device connected to the network.

In another embodiment the system comprises a database housing business metrics data obtained from a template and additionally housing relational data associated with the business metrics data.

In another embodiment the system comprises a computer-readable medium executable by a computer for controlling the computer to receive a request to provide a web interface, provide a web interface configurable to a template, and receive business metrics data in the template and store the template.

### BRIEF DESCRIPTION OF THE DRAWINGS

FIG. 1 is an exemplary embodiment of a system diagram;

FIG. 2 is an exemplary embodiment of a login web user interface;

FIG. 3 is an exemplary embodiment of a user interface presented during creation of a template from a web interface, following a successful login by a user;

FIG. 4 is an exemplary embodiment of a user interface displayed when an authorized user has selected to create a template having one or more fields from an initial web interface form;

FIG. 5 is an exemplary embodiment of illustrative template definitions when the user has selected to create a template having one or more fields;

FIG. 6 is an exemplary embodiment of a user interface displayed when such user has elected to validate one or more selected fields of a template;

FIG. 7 is an exemplary embodiment of a user interface displayed wherein the user has elected to define select box details within one or more fields;

FIG. 8 is an exemplary embodiment of a user interface wherein the user has elected to add metric targets to one or more templates;

FIG. 9 is an exemplary embodiment of a user interface displayed wherein the user has elected to add levels and weights to one or more fields;

FIG. 10 is an exemplary embodiment of a user interface displayed wherein the user has elected to create field categories;

FIG. 11 is an exemplary embodiment of a user interface displayed wherein the user has elected to modify a template;

FIG. 12 is an exemplary embodiment of a user interface displayed wherein the user has elected to modify a template table and/or add new fields;

FIG. 13 is an exemplary embodiment of a user interface displaying wherein the user has elected to modify a template;

FIG. 14 is an exemplary embodiment of a user interface displayed wherein the user has elected to change field order;

FIG. 15 is an exemplary embodiment of a user interface displayed wherein the user has elected to modify one or more validations;

FIG. 16 is an exemplary embodiment of a user interface displayed wherein the user has elected to modify a selected box;

FIG. 17 is an exemplary embodiment of a user interface displayed wherein the user has elected to modify field categories by changing the order or adding fields;

FIG. 18 is an exemplary embodiment of a user interface displayed wherein the user has elected to modify field attributes;

FIG. 19 is an exemplary embodiment of a user interface displayed wherein the user has elected to modify field attributes;

FIG. 20 is an exemplary embodiment of a user interface displayed to an online user where the user has elected to copy a template definition;

FIG. 21 is an exemplary embodiment of a user interface displayed wherein the user has elected to open and close a reporting period;

FIG. 22 is an exemplary embodiment of a user interface displayed wherein the user has elected to upload a user help file;

FIG. 23 is an exemplary embodiment of a user interface displayed wherein the user has elected to view uploaded files;

FIG. 24 is an exemplary embodiment of a user interface displayed wherein entities are shown which a user may add to a template;

FIG. 25 is an exemplary embodiment of a user interface displayed wherein a new entity can be created on the screen interface;

FIG. 26 is an exemplary embodiment of a user interface displayed for adding entities to a template;

FIG. 27 is an exemplary embodiment of a user interface displayed wherein a user desires to modify from a template;

FIG. 28 is an exemplary embodiment of a user interface displayed wherein the user desires to remove a business entity from a template;

FIG. 29 is an exemplary embodiment of a user interface displayed wherein the user desires to view the business entity hierarchy of a template;

FIG. 30 is an exemplary embodiment of a user interface displayed wherein the user desires to copy a system business entity structure;

FIG. 31 is an exemplary embodiment of a user interface displayed wherein a user can create system access for other users;

FIG. 32 is an exemplary embodiment of user types;

FIG. 33 is an exemplary embodiment of administration authority considerations in granting user access;

FIG. 34 is an exemplary embodiment of operation of business metrics entry;

FIG. 35 is an exemplary embodiment of a reporting feature showing a dashboard created by selecting metric package and reporting year;

FIG. 36 is an exemplary embodiment of reporting showing a dashboard created by selecting canned business entity sets or a custom business entity selection;

FIG. 37 is an exemplary embodiment showing a dashboard having a visual display based upon metrics targets, which have been entered by a user depicting speed, yield, abandoned rate, resolved on first contact and critical yield in four respective columns;

FIG. 38 is an exemplary embodiment of a trend analysis of a selected metrics package wherein a user selects a reporting year, a start date and an end date;

FIG. 39 is an exemplary embodiment of another trend analysis of a selected metrics package wherein a user selects a series of top twenty-five businesses as selected entities and selects abandoned rate as a select measure;

FIG. 40 is an exemplary embodiment of another trend analysis of a selected metrics package which illustrates a trend analysis for a reporting period and an abandoned rate;

FIG. 41 is an exemplary embodiment of Who's in and Who's out for a metrics package for a business unit Information Technology metrics—Software License Management System (ITM SLMS) for reporting year 2000 and for Q4-2000 (4^{th} Quarter year 2000) as the reporting quarter;

FIG. 42 is an exemplary embodiment of Who's in and Who's out for a metrics submission status for a reporting period of October 2000 for several business unit entities including Auto Financial Services (AFS), Aircraft Engines, Americom, Appliances, Aviation Services, Corporate Research and Development (CRD), Capital Market Services and Card Services along with a respective correlating submission status;

FIG. 43 is an exemplary embodiment of an illustrative Summary Report created by an online user by selecting a metrics package and reporting period;

FIG. 44 is an exemplary embodiment of an illustrative Metrics Summary Report that displays selected field categories along with entities;

FIGS. 45-47 are exemplary embodiments of Custom Reports of online users;

FIGS. 48-50 are exemplary embodiments of business metrics interface showing Help Desk Scores;

FIG. 51 is an exemplary embodiment of a detail report which shows a Help Desk (HD) Metrics including users supported, number of calls, speed yield, speed median, speed span, abandoned rate, resolved on first contact, critical yield, number of incidents, critical median, critical span, urgent yield, number of incidents, urgent median and urgent span;

FIG. 52 is an exemplary embodiment of modifying users and shows a list of login ids (computer identifications) which would be formatted according to server 10 acceptable format;

FIG. 53 is an exemplary embodiment of viewing reports depicting a dashboard wherein an authorized user selects a business metric package;

FIG. 54 is an exemplary embodiment of a user interface displayed by a successful login by a user when an authorized user has selected to create a template having one or more fields from an initial form;

FIG. 55 is an exemplary embodiment of a user interface displayed by a successful login by a user when an authorized user has selected to add validations for defined metric fields;

FIG. 56 is an exemplary embodiment of a user interface displayed by a successful login by a user when an authorized user has elected to create calculations based on several metric fields;

FIG. 57 is an exemplary embodiment of a user interface displayed by a successful login by a user when an authorized user has elected to define ranges and limits for red, yellow and green colored light targets for each metric on this exemplary user interface;

FIG. 58 is an exemplary embodiment of a user interface which allows the administrator to create new business entities or add already existing available entities to a template;

FIG. 59 is an exemplary embodiment of a user interface which allows a successfully logged in user the ability to attach entities to a template from among a group of business entities;

FIG. 60 is an exemplary embodiment of a user interface which allows a successfully logged in user the ability to copy an entire structure from one template to another;

FIG. 61 is an exemplary embodiment of a user interface which allows a successfully logged in user the ability to create new user profiles and grant access. This also allows the user the ability to create new user profiles;

FIG. 62 is an exemplary embodiment of a user interface which allows a successfully logged in user the ability to grant a user access to templates;

FIG. 63 is an exemplary embodiment of a user interface which allows the administrator to grant a user access to entities;

FIG. 64 is an exemplary embodiment of a user interface which allows a user access to enter data into templates;

FIG. 65 is an exemplary embodiment of a user interface which illustrates an exemplary metrics data entry for a business unit aircraft engine entity;

FIG. 66 is an exemplary embodiment of a user interface which shows a metrics submissions status;

FIG. 67 is an exemplary embodiment of a user interface which shows a lists of entities and their performance with each selected metric in the form of red, yellow and green colored traffic lights.

### DETAILED DESCRIPTION OF THE INVENTION

Systems and methods that facilitate integrated web based business metrics management are described below in detail. The systems and method facilitate electronic creation, submission, analysis, integration, and automation of business metric information and web-based business metrics reporting.

Online configurable screens can be used in the creation, entry of and reporting of business metrics onto a web based platform. An example of a web based embodiment is described below.

The systems and methods are not limited to the specific embodiments described herein. In addition, components of each system and each method can be practiced independently and separately from other components and methods described herein. Each component and method can be used in combination with other components and other methods.

In one aspect, the method is a computerized method for creating and, if desired, storing and using business metrics in managing, monitoring, reporting or directing business unit operations. This computerized method provides a capability to create and manage such business metrics, and reduces the potential for mistakes in manually (via human) handed business metrics. Further this method provides enhanced capability for business management to determine business unit efficiency which in turn can be the basis for management business decisions to enhance business operations.

In an aspect, the method sums up data from individual business units such as subsidiaries to a parent unit. In another aspect, the method provides for customized and customizable metric entry templates for individual business units, yet provides an integrated and automatic high volume system for collection of business metrics laterally and vertically for a corporation with one or more business units which have business metrics. The method secures data which could otherwise become lost data with exchange of data using paper. The method eliminates or substantially reduces labor intense mathematical calculations such as compiling and statistical analysis and consolidation work. Significant business cost savings can be achieved by using the invention. Such cost savings include those brought about by having a system and its maintenance at a single location. The method provides summing up data and provides averages of numerical data from a subsidiary business unit to its parent business unit.

Using a business metrics record accessed by user in management from the web based business metrics system allows management to make a better informed management decision in response thereto, which in an embodiment, is then provided to a business unit as feedback instruction for implementation. Further follow-up of business metrics from a business unit can be the basis for management follow-up as to the business managerial effectiveness of a business unit.

Business metrics include business development reports, operating reports, financial statements, compliance issues, employee attendance, employee productivity, product quality, response time, help desk operations and help desk contacts.

In an exemplary embodiment, the system allows an authorized user to create a business metric template from a web page interface, and allows a user to enter business metric data into a created business metric template and generate a record or report therefrom containing raw or compiled business metric information. In another embodiment, the record may be compiled or otherwise acted upon by the system in accordance with predetermined criteria to provide an analysis record or a reporting record. In another embodiment, business managers of a business unit review the report and issue instruction to the business unit to improve the operation of the business unit.

Architecture of Metrics Application:

This application was designed to be of a 3 tier architecture comprising the following three tiers:

Client,

Web server/application server,

Database server.

Client is defined as any device with a web browser which can support html 4.0 , client cookies and ECMA script. Typically, user interacts with the application from the client.

Web server or application server which resides in the middle tier is any server software which is capable of listening for and servicing Hyper Text Transport Protocol (HTTP) requests and supports Java Servlets, Java Server Pages and Java Database Connectivity (JDBC). Most of the application logic resides in this tier in the form of Java Servlets, Java beans and Java Server Pages.

Database server resides in the 3^{rd} tier. Database must be of type relational. Though this application has been developed using Oracle as the database, it is possible to port the code to other brands of relational databases, if necessary. Some of the application logic resides in this tier in the form of database stored functions and triggers.

Application Design:

Following were the primary considerations in application design.

Feature Generalization.

All features and functionality which were considered to be incorporated into this application was generalized so that they will be useful for wider user base.

Universal Accessibility.

Though several technologies and standards were available in the marketplace, only a few of them were implemented or supported by all vendors whose technologies formed the building blocks for metrics application. This created the need to choose the right combination of technologies/standards so that the metrics application can be accessed by the widest possible user population without the need to install any special software on their client machines.

Complete Control to the User

User was given complete control on the application with no need for intervention by IT staff in its everyday usage.

Design Internals:

There are five broad types of operations a user can perform in metrics application which are as follows:

Template creation

Entity creation

User creation

Metrics entry

Reports

Template creation.

This is the most salient feature in this application.

By creating a template, a user designs a screen with required number of fields for which he/she has to collect information. Later, the intended audience uses this screen to enter the values for each metric field on it.

Application stores all metrics field attributes which are specified on the template creation screen in database tables. These attributes are later retrieved to construct the screen on the fly by the metrics entry function.

For each template, two tables are created in the database to store metrics data entered through the metrics entry screen. One database trigger is attached to the first table to perform the rollups. When a user enters data into a template through the metrics entry screen, this trigger gets fired and performs the rollups on the entered data and inserts the data for the parent records, if any, into the second table.

Entity Creation.

In the context of the metrics application, an entity most commonly is either a business, unit of a business or a department or group within a unit of a business. These entities report metrics on a metrics entry screen.

Using this feature, a user creates a hierarchy of entities and attach them to his/her template. Different templates can have different levels of hierarchies as there are no limits imposed on the depth of the hierarchy.

Application stores the parent-child relationship among the entities in a simple database table. However, it uses a complex SQL query to retrieve the entities in the hierarchical order.

User Creation.

Comprehensive user management functionality is provided in the application. Users are created and given permissions to access entities. As almost every business runs in a hierarchical model, privileges can be granted by a user responsible for an entity at a higher level to the user of its child entity and so on. There are four privilege levels which can be assigned to users which are as follows:

Master Administrator—Has complete access to all parts of the application.

Template Administrator—Has complete access to the template to which he/she is the

Administrator.

Group Administrator—Has access to his/her group of entities. Can create users and entities below his/her entity level.

Normal User—Has only metrics entry and report viewing privileges.

Metrics Entry

Unlike normal web applications which contain pre-designed and saved screens, metrics entry screens are dynamically generated in this package. Metrics entry program retrieves the template definition, which was stored during template creation, from the database and constructs the screen when a request for a template screen is received from the logged in user.

Reports

Most essential reports are included in this application to view the data entered by the users. Dashboard report provides the red/yellow/green lights in a Java applet. “Who's in Who's out” report provides the hierarchical status of metrics entry by the entities.

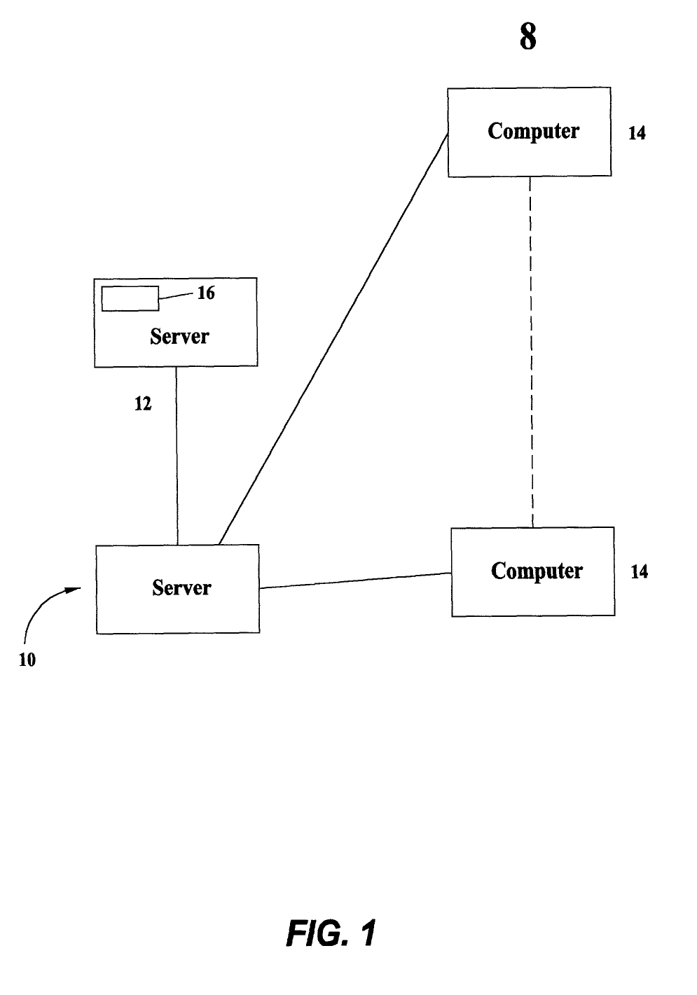

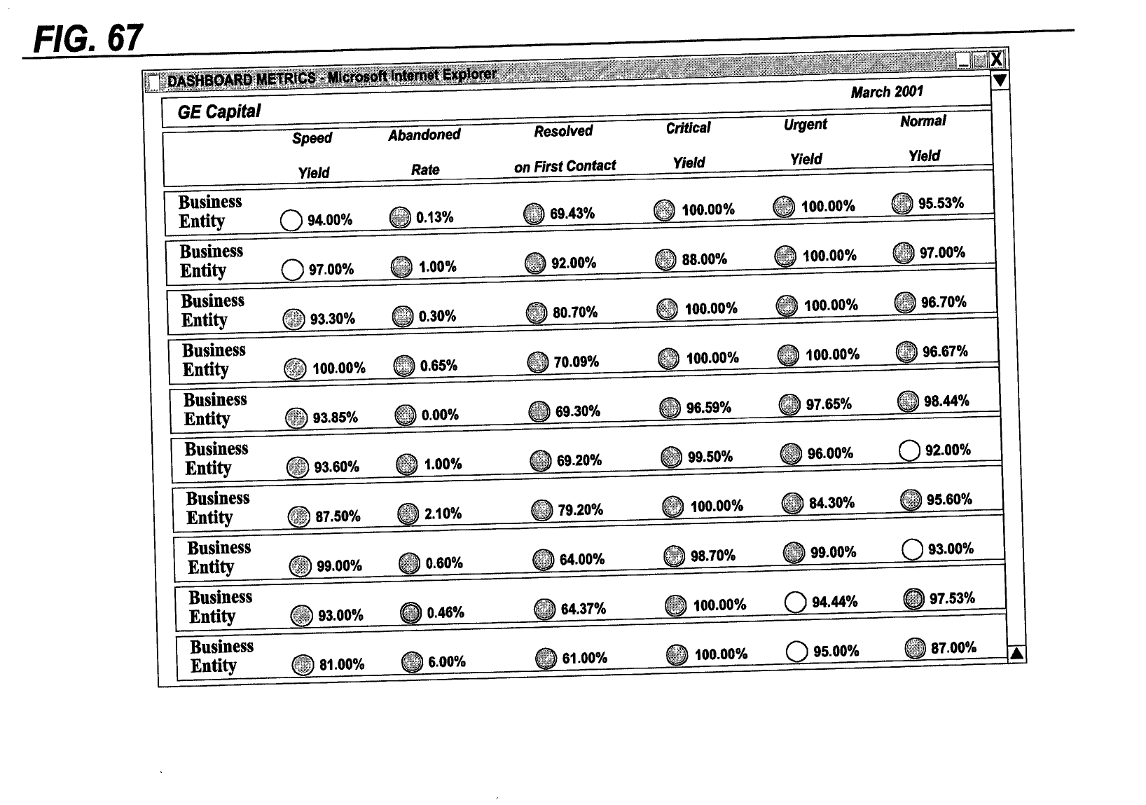

Set forth below are details regarding exemplary hardware architectures (FIGS. 1-67) and exemplary process flow chart and exemplary screen shots. Although specific exemplary embodiments of methods and systems for generating such sheets are described herein, the methods and systems are not limited to such specific exemplary embodiments.

FIG. 1 is a system diagram of business metric system 8 that includes two servers 10 and 12, and a plurality of user (customer) devices 14 connected to and/or communicating with server 10. In one embodiment, devices 14 are computers including a web browser, (not shown) and server 10 is connected to and/or electronically communicative with devices 14 via a network such as an intranet, extranet or a wide area network such as the Internet. In an alternative embodiment, devices 14 are servers for a network of customer (user) devices. In an alternative embodiment, one device 14 may be connected to and/or communicate with the network.

Server 10 is a web server or application server. Application server 10 has application code pages and provides the pages to a user allowing the user to create a template accommodating business metrics data. Server 12 hosts a database which is enabled for storing and retrieving template information, with server 12 configured to upload and store user input in database 16.

Devices 14 are interconnected to the network, such as a local area network (LAN), an extranet or a wide area network (WAN), through one or more interfaces including dial-up access, cable modem, ethernet, wireless communication, leased circuits and other high-speed lines (such as a Digital Subscriber Line). Alternatively, devices 14 are any devices capable of electronically interconnecting to and being communicative with a network including a computer. Illustrative communication includes a web-based phone, wireless web, wireless modem, mobile wireless, satellite, appliance, cable, cable modem, digital cable modem, web based television or other web-based connectable and electronically communicable equipment. A computer system communicative and associated with a computer, a monitor, keyboard, mouse and peripheral computer associate equipment may be employed as a device 14 (client).

Server 12 includes a database 16 containing business metrics information based on one or more business units. In one embodiment, centralized database 16 is stored on database server 12 and is accessed (receives instruction) from authorized users at one of user devices 14 by having a user(s) logging onto server 10 through one of user devices 14 and communicating instructions therewith. In an alternative embodiment database 16 is accessed from server 10.

In one specific exemplary embodiment, the following commercially available hardware and software are utilized: Web server platform is iPlanet v4.1 on Sun Solaris 2.6; database server platform is Oracle 8i on Sun Solaris 2.6; JSP, Java servlets and Javascript. The intranet site operates under IE 4.0+ and Netscape 4.0+.

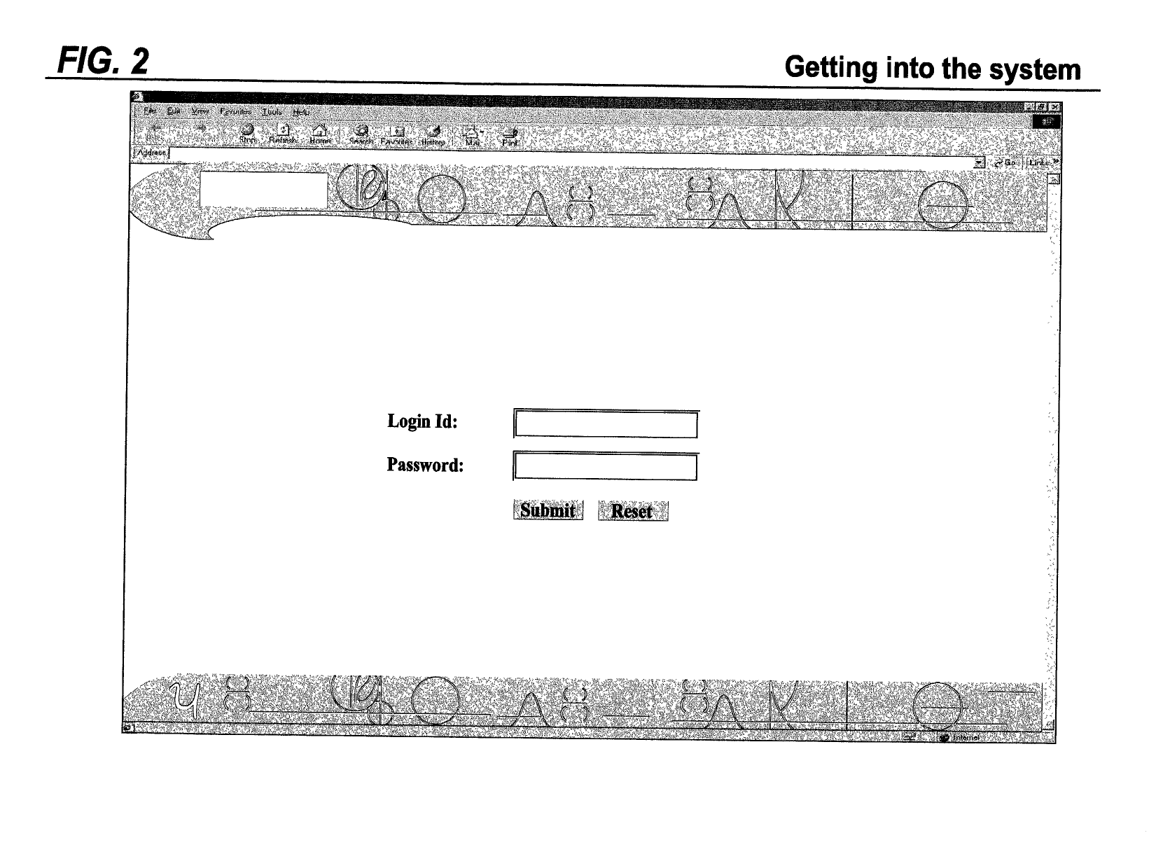

FIG. 2 is a log in screen which describes operation of a business metrics system 10. A user includes a person having system access privileges. When a user initiates a login to system 10 using device 14, system 10 verifies user authorized registration or alternatively prompts the potential user to register as a new user in a administrative system access authorization process. In one alternative embodiment, a system administrative manager having access granting privileges sets up selective new user access by establishing registered user accounts. In such a setup, the administrative manger defines (by granting), a user's access privileges.

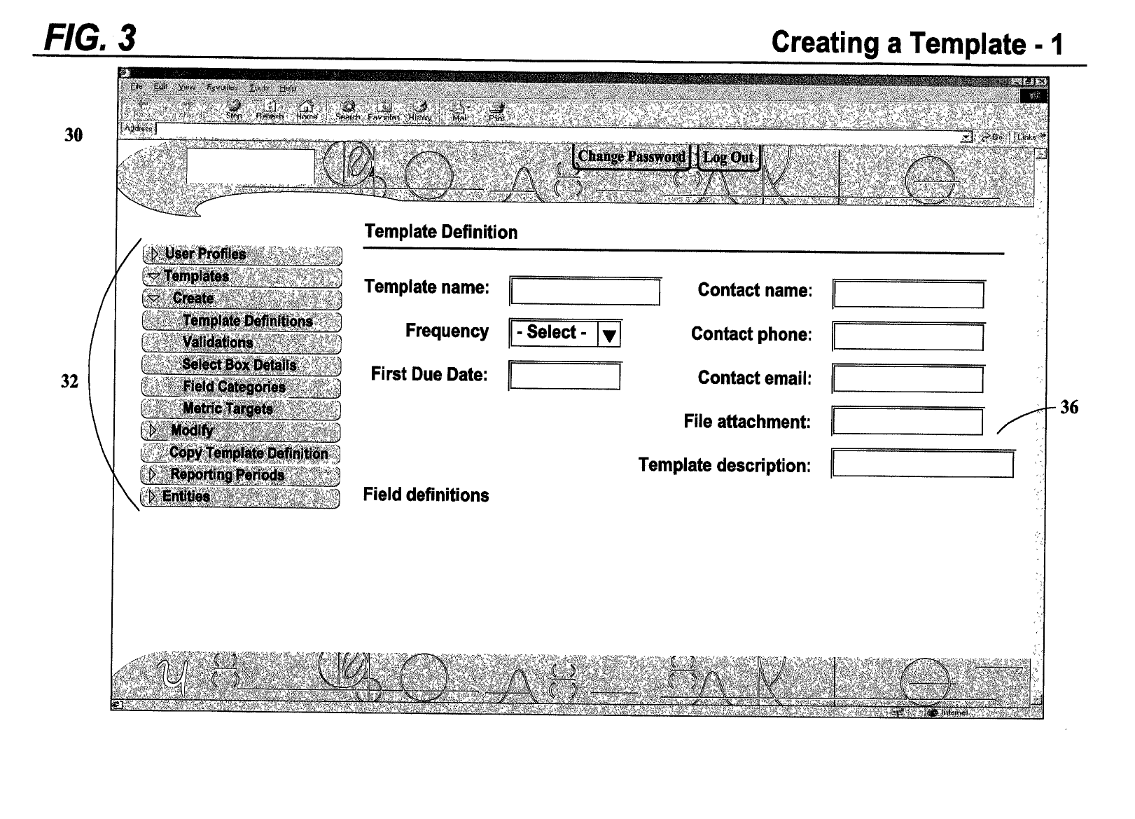

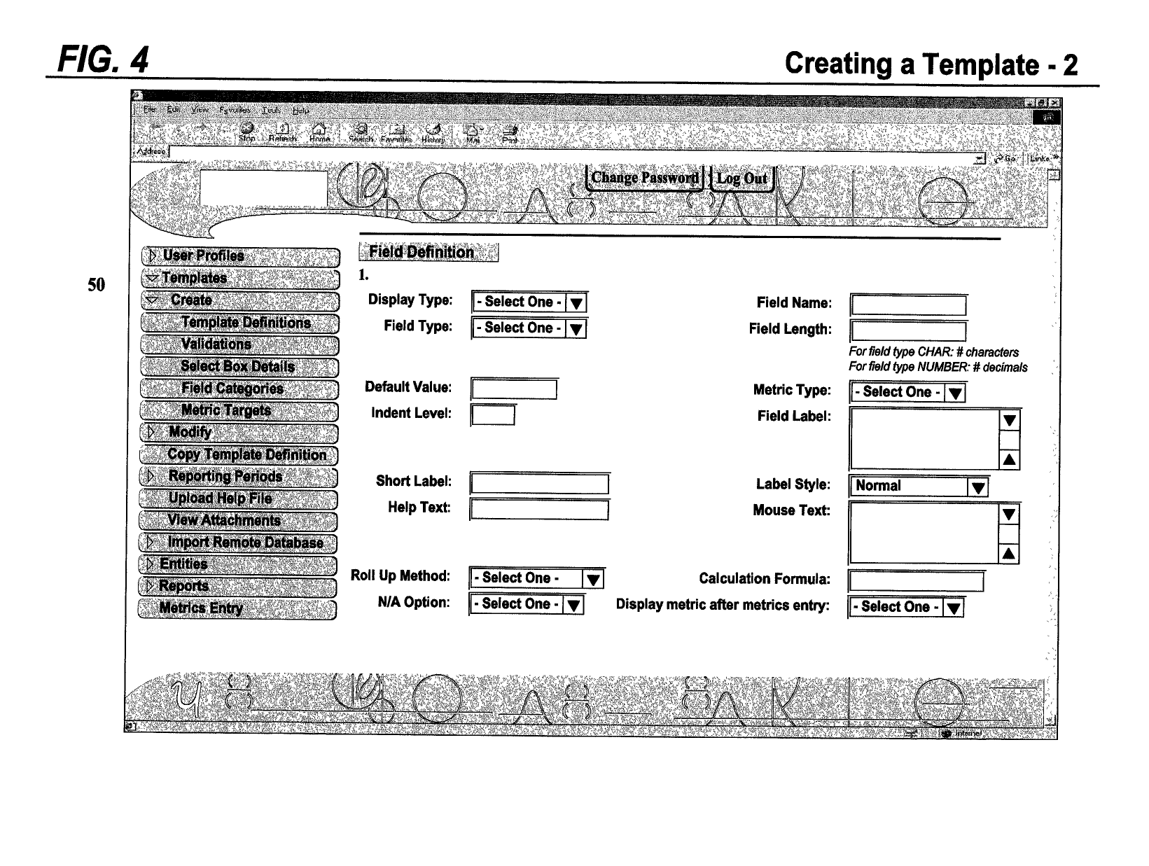

FIGS. 3 and 4 relate to the creation of a metric template by a user. As depicted in FIG. 3, after a successful login, the user is online with server 10. The user has the online capability to prompt server 10 for a web page user interface providing pull-down menu 32. Applications server 10 accepts instruction from the user and downloads a user configurable web interface.

As shown in FIG. 3, pull-down menu 32 from the left frame in the web interface provides a tab selection to a user for selecting one or more template related tabs whereby user can create a template from a web interface provided by server 10 which can accommodate business metric data. Selection of a tab by a user causes server 10 to accept instruction from the user and server 10 retrieves a web page for the user and supplies that web page to the user. Typically server 10 provides a form initially to user upon the user's request to server 10 to create a first template. On this page user specifies necessary attributes (without coding) to create a template for use in this business metrics system and method. Pull-down menu 32 of the web page interface includes individual major tabs for user profiles, templates, create, modify, copy template definition, reporting periods and entities as shown in FIG. 3. Individual tabs are provided under major tab “Create” including template definitions, validations, select box details, field categories and metric targets.

Initially, the user has available a web page template definition interface 30 as an initial form or web interface. As noted above, scroll pull-down menu 32 further includes a plurality of independently selectable major tabs shown in a hierarchy stacked arrangement, including illustratively user profiles, templates, entities, reports and matrix entry (as will be described more in detail hereinafter.

Template definition web page interface 30 gives an authorized user the electronic capability to create a web page based template which includes template name, frequency, first due date, contact name, contact phone, contact e mail address, file attachment and template description. As one or more fields are filled in by a user, a web page template definition is created. The web page template is stored in the database 16 on server 12 for future retrieval from database 16 upon instruction from a user via device 14. Dynamic storage and retrieval capability can be provided by the servers using a relational database of server 16.

Further, pull down menu 32 shown in FIG. 3 additionally provides a user the capability to modify a created template(s) by selecting from among one or more selectable tabs such as validation, select box details, field categories and metric targets. Each of these individual tabs of pull down menu 32 will be discussed in more detail hereinafter.

One or more templates are created, modified, stored, retrieval to/from server 10. Users save created or modified templates to database 16 on server 12 as needed to retain their changes to respective templates. Saving may be accomplished by use of the submit command as shown in several Figures herein. Templates are retrieved from server 12 when and as needed by an authorized user.

Further, with respect to FIG. 3, “template name” is the name of the metric template the user is creating. Illustratively, the contact name will likely be the template owner, the frequency is typically daily, or monthly; the contact name, phone and email will typically be the user's name, phone number and email address. A typical file attachment is a help file. A help file would be a source of helpful information for a user who later uses the template for metrics entry. The template description is a brief description of the metric template the user is creating. In an embodiment advantageously a template may be created without coding on the part of a user.

After a business metric template has been created by user, (and named) the named template is uploaded and saved in the database on server 12 by a user by using the submit command to server 10 so that the named template can be subsequently retrieved, tracked, reviewed, refined, deleted and/or updated in a number of ways if and as desired by a user, which will be explained hereinafter in more detail.

FIG. 4 is an illustrative user interface which displays, a metric template with one or more fields associated with it. As used herein, a field is a row in the input interface form 50 for accepting and holding business metric data. In an embodiment, five rows of fields are initially optionally provided so that if the user wishes to have more than five rows of fields, then the user may execute the save and add command to server 10. To create additional fields, as an option, the user select a system save and create command so that the named metric template is then uploaded to server 12 (shown in FIG. 1) into database 16 for future use by a user. Thus the user implements various server 10 instruction techniques to appropriately customize, i.e. create and add additional fields as a user deems appropriate.

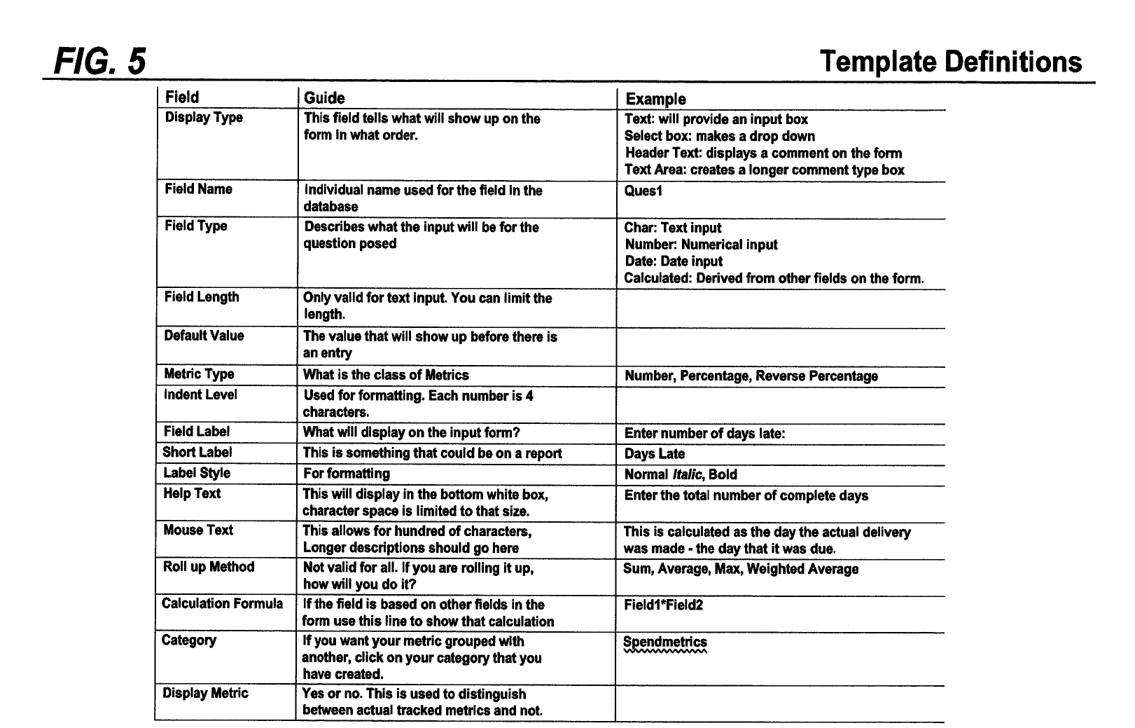

FIG. 5 is a user interface which provides several illustrative template definitions for a user to select in creating a template which are shown in three columns of FIG. 5. Illustrative, in FIG. 5, a left hand column “Field” corresponds to types of available field data entry on FIG. 4. In FIG. 5, a center column “Guide” provides information to a user as to the type of data entry which can be considered for that respective field. In FIG. 5, a right hand column “Example” provides illustrative examples for each available field in the left hand column of this Figure.

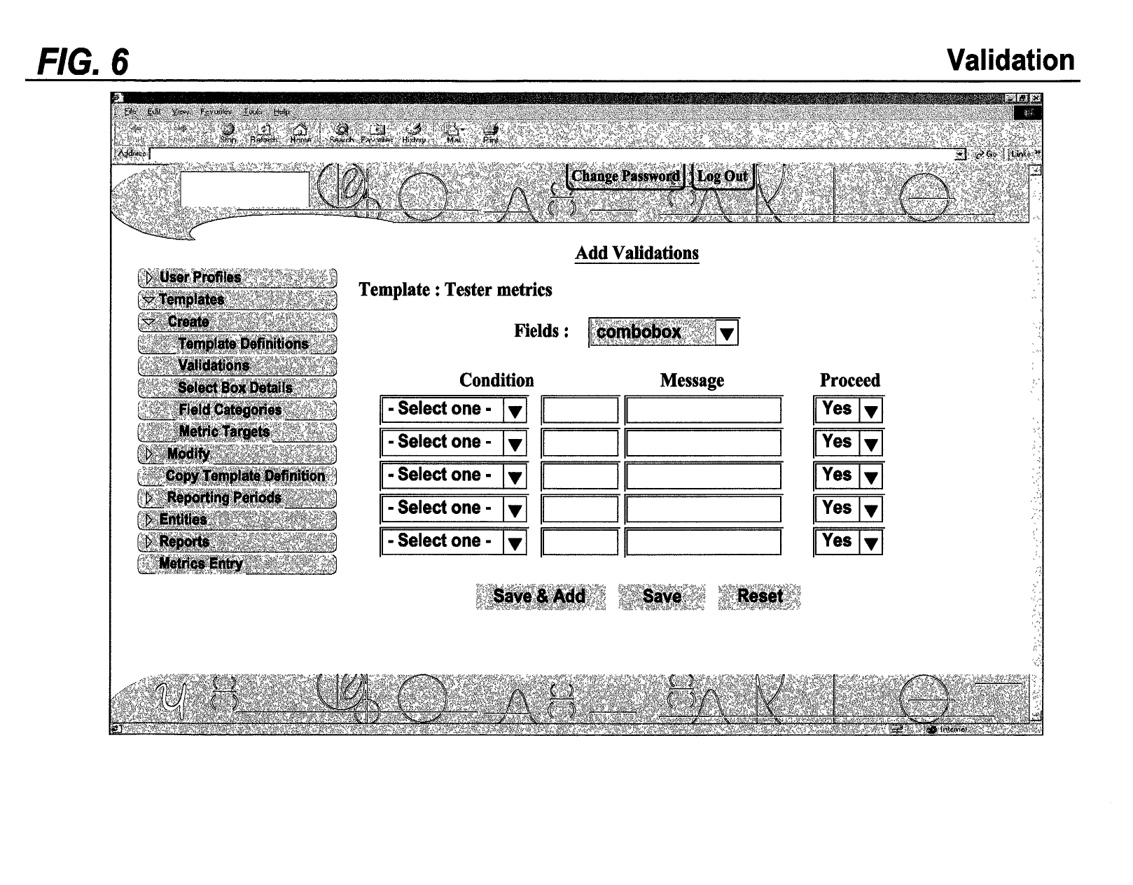

FIG. 6 is an illustrative user interface presented to a user after a successful login to system 10 (shown in FIG. 1) and after a template has been created with at least one associated field. The user interface provides the user with the capability to attached data validation to one or more of the fields which have been selected as in FIG. 5.

Validation is a useful data entry technique. Illustratively, validation is a process of ensuring that a user has completed entry of data in required fields on a template, that the data is in the right format and that only data within pre-defined ranges of values is accepted.

Illustratively, if desired, for one or more fields in FIG. 5, for example, a user can set user selected acceptable boundary data value limits, i.e. lower and upper limits for data values, ensuring enhanced business metrics data input. Illustratively, such validation is set by the user by selecting a field to be validated and thereafter selecting and inputting any upper and lower limits for each such field if and as desired. The user then saves the validation and associates it with that respective field. The validation may be changed by the user subsequently, if necessary.

After such validation, server 10 will automatically test data upon entry and reject entry of data having a value which is outside the validation data parameters for each validated field. Refinement of validation is described in detail hereinafter.

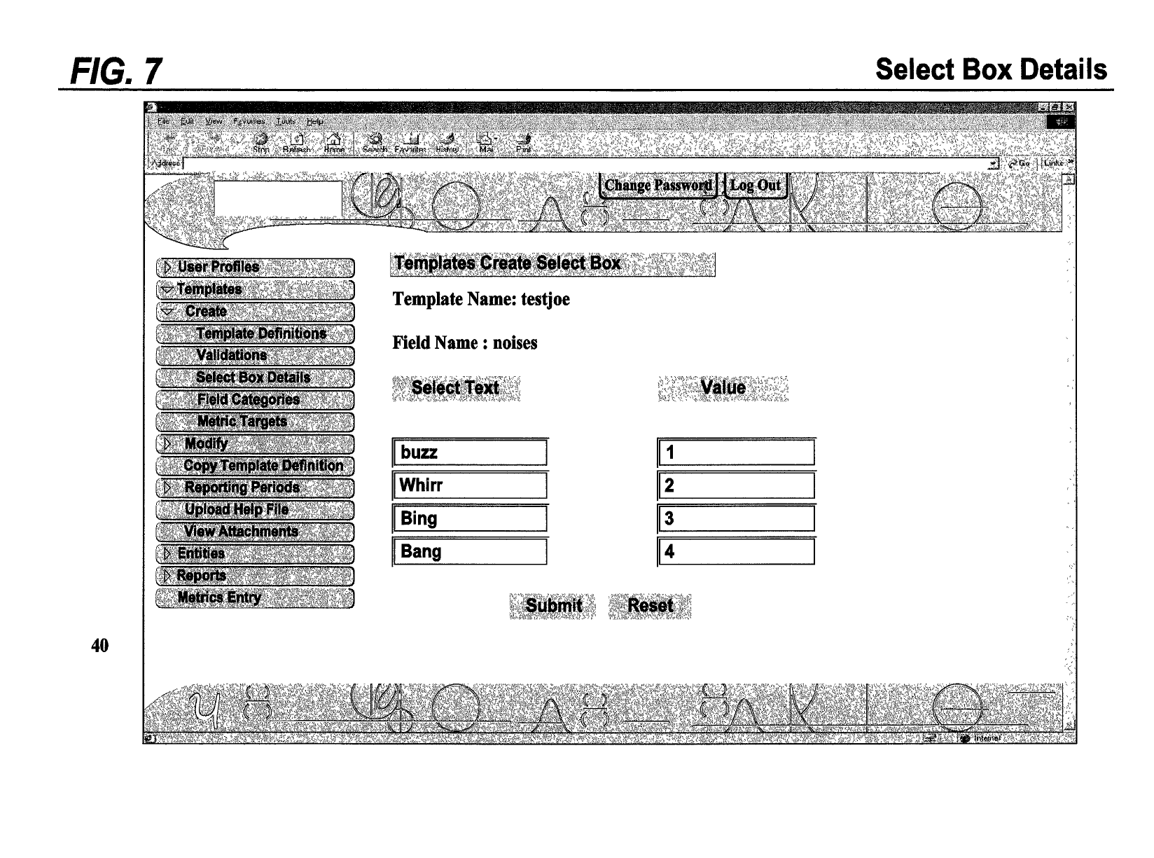

FIG. 7 is an exemplary embodiment of a user interface 40 displayed to a user after a successful login onto system 10 (shown in FIG. 1). User interface 40 provides the user the capability to further refine, without coding, a named metric template. In FIG. 7, an exemplary template is shown labeled Templates Create Select Box, with a template name of testjoe and having a field name of noises. The user may have added a select box to a named template. In that event a user may need to further define the select box details. In this Figure, the user has selected text of buzz, Whirr, Bing and Bang.

Select box is a feature which is used to instruct server 10 to provide a drop down;

In such an instance, the user interface provides the user the capability to choose select box details, In so doing, the user chooses a template to work with, chooses the field for which select box has been selected and enters the number of choices, entering a display and a corresponding value. The user then saves the refined template into server 10 by using the save command which is also termed “submit”.

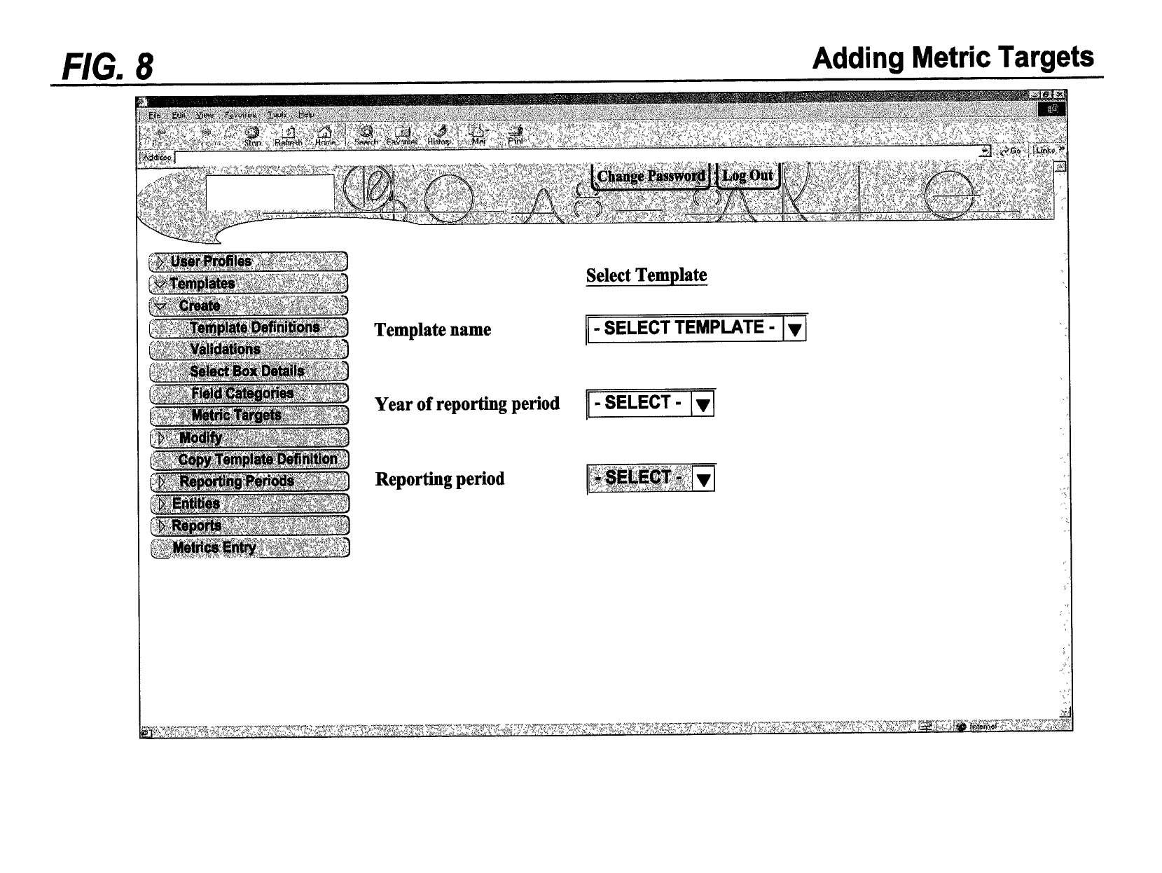

FIG. 8 provides a web page user interface for one embodiment of further refinement of a created template which enables a user to add metric targets to a selected metric template. A user selects a created metric template from a list of templates appearing in a scroll down pick list appearing on this interface. The user selects a year of reporting period and a period, for example year 2001 and first quarter. Illustratively, the year selected as a reporting year includes current and future years. The reporting period includes monthly, quarterly, biannual and annual periods of time and are selected accordingly to user needs. This refinement feature of system permits a user the advantage of being able to adjust metric targets across time to a selected business metric template. FIG. 8 also shows pull down menu 32 as previously described.

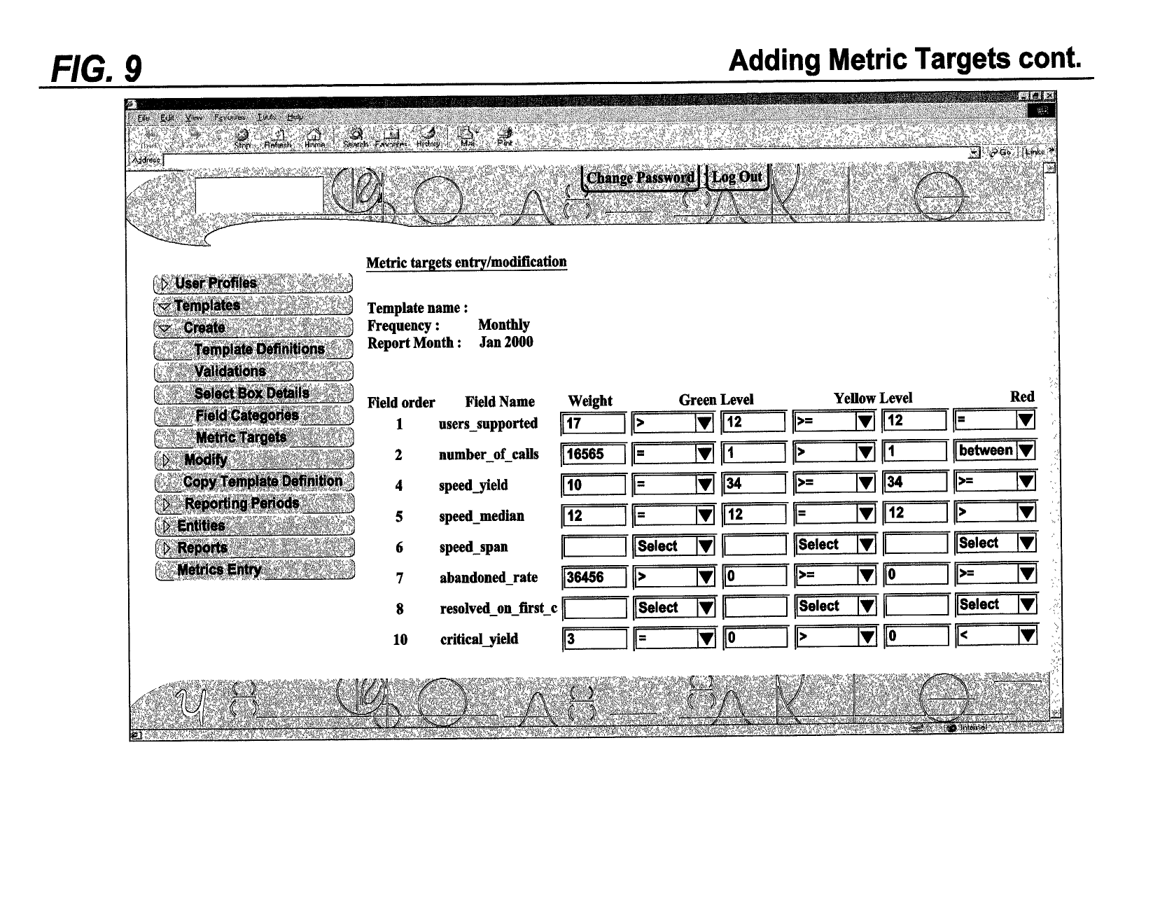

FIG. 9 provides illustrative web page user interface which allows a user to further refine and modify a named template. Using this web page interface allows the user to attach a corresponding level for each field as the user desires. Independently or in connection with a level, a weight (determined by user) can be attached for one or for several different fields for a metric template. A user may attach a level (determined by user) to a field and a weight to a field or a level to a field and a weight to a separate field. A weight is a number text if and as desired by user. Illustratively, a level can be a rating system selected by user if desired to indicate higher or lower desirable features or ratings.

In FIG. 9, A left hand column “illustrative field order” provides the user with web page/screen formatting capability to set a screen appearance priority order for each field name on a metric template, again in the absence of coding. The field order on this Figure is 1-10. The field names associated with each such field are shown to the immediate right of each respective field order number. Further in FIG. 9, the column “Weight” illustrates a situation wherein a user selected weight has been attached to several fields in that column. Further in FIG. 9, levels have been illustratively added, including a green level, a yellow level and a red level. When a user has the made desired attachments of some levels and weights to one or more fields, the further refined template is uploaded and stored via server 10 by the user by executing the system save or submit command which places the level information in database 16 for storage and retrieval as needed. The user can carry out any degree of practical refinements to web page interfaces.

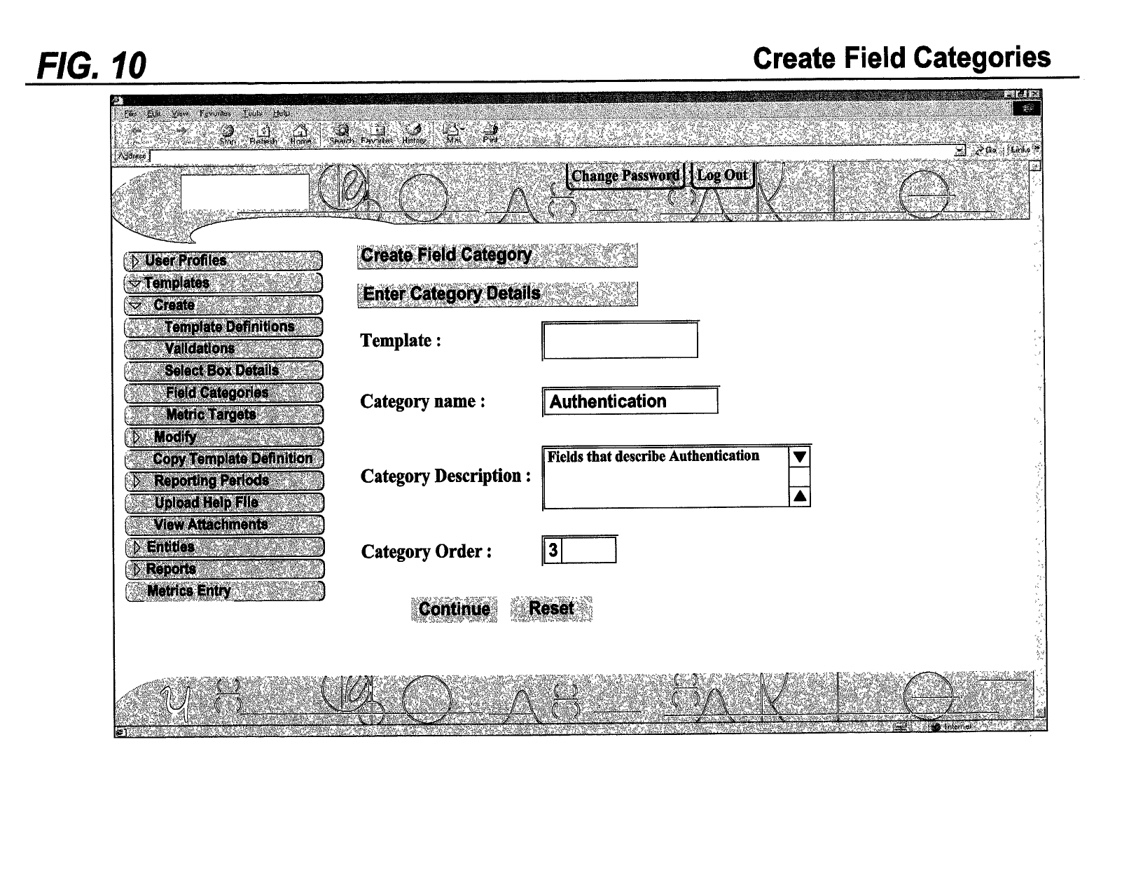

FIG. 10 provides an illustrative web page user interface which further provides a user another refinement of creating field categories for reporting purposes of questions on a named template. This enables a user to create different categories as desired by the user. The order is the order these user created categories will appear in the summary report (as will be described in more detail later hereinafter in other Figures).

Further with respect to FIG. 10, one or more categories can be associated with a named template, along with a category description and category order. The user can upload this (further refined) template to server 12 by executing the save command of server 10.

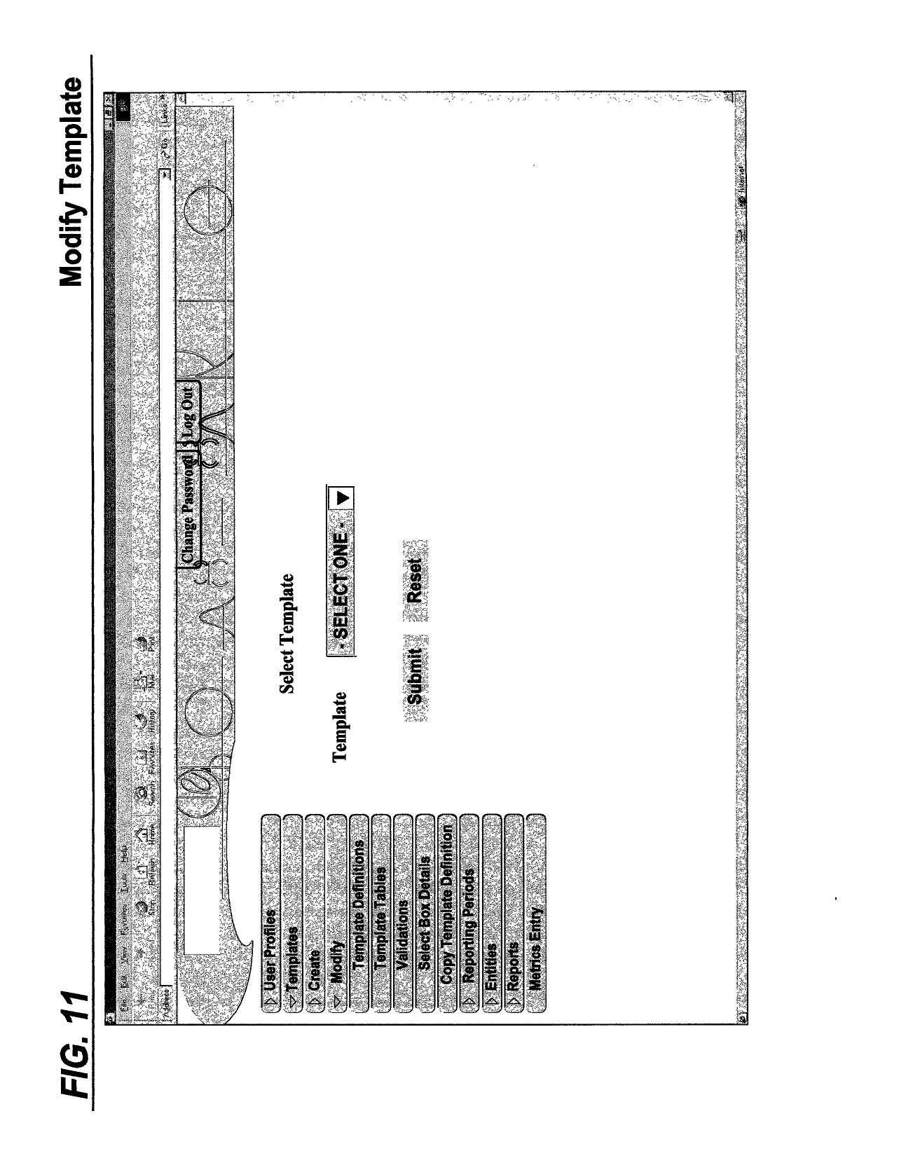

FIGS. 11-13 illustrate methods for a user to modify a selected web page template.

FIG. 11 illustrates a web page user interface showing a system feature whereby a user may modify a template. This web page interface illustrates that user may select, i.e. click a cursor on the modify tab in pull down menu 32 (described in FIG. 1) which instructs server 10 to retrieve a selected template for modification by user.

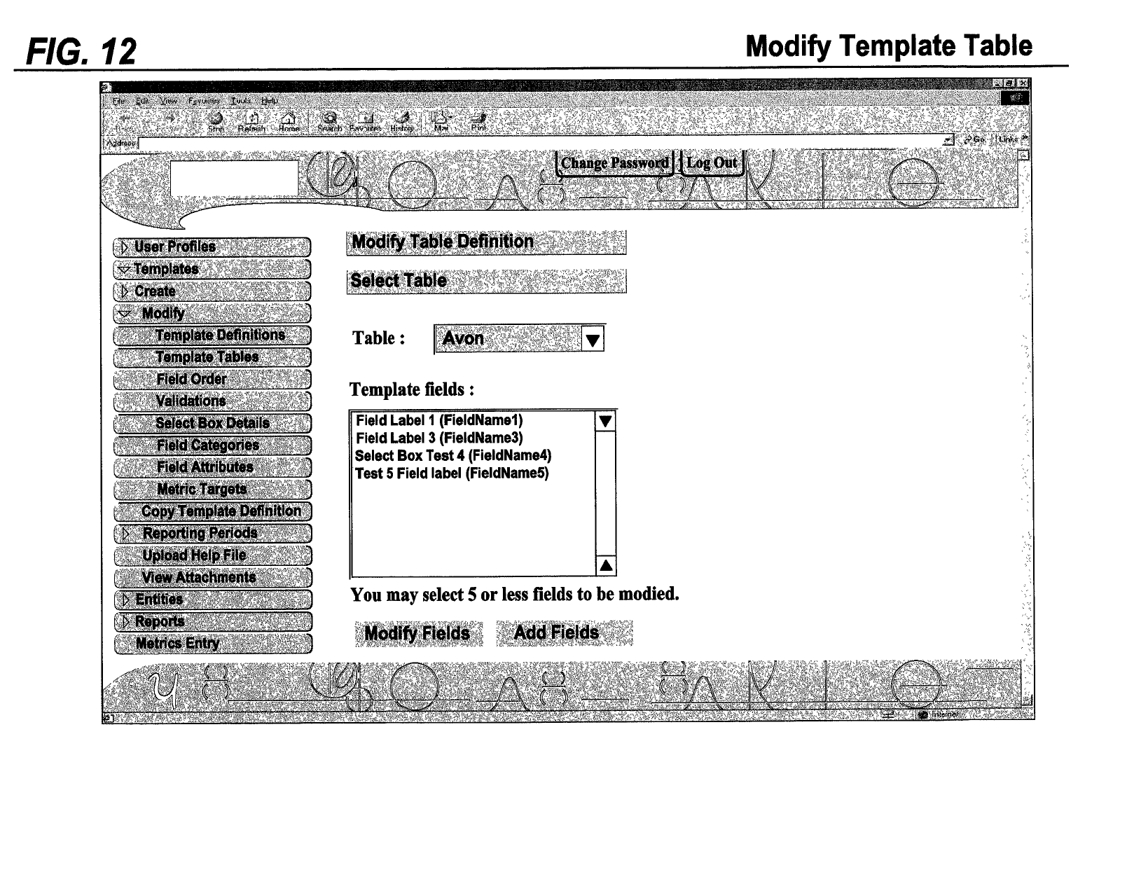

FIG. 12 provides web page interface which is the selected template described in FIG. 11 above. In this web page interface of FIG. 12, illustratively the user has available a pick list of various templates and associated template fields. The user may select the fields of a template that the user wishes to modify. Optionally the user may select modify files or alternatively the user may select an add fields command wherein the later selection instructs server 10 to provide user the opportunity to add fields.

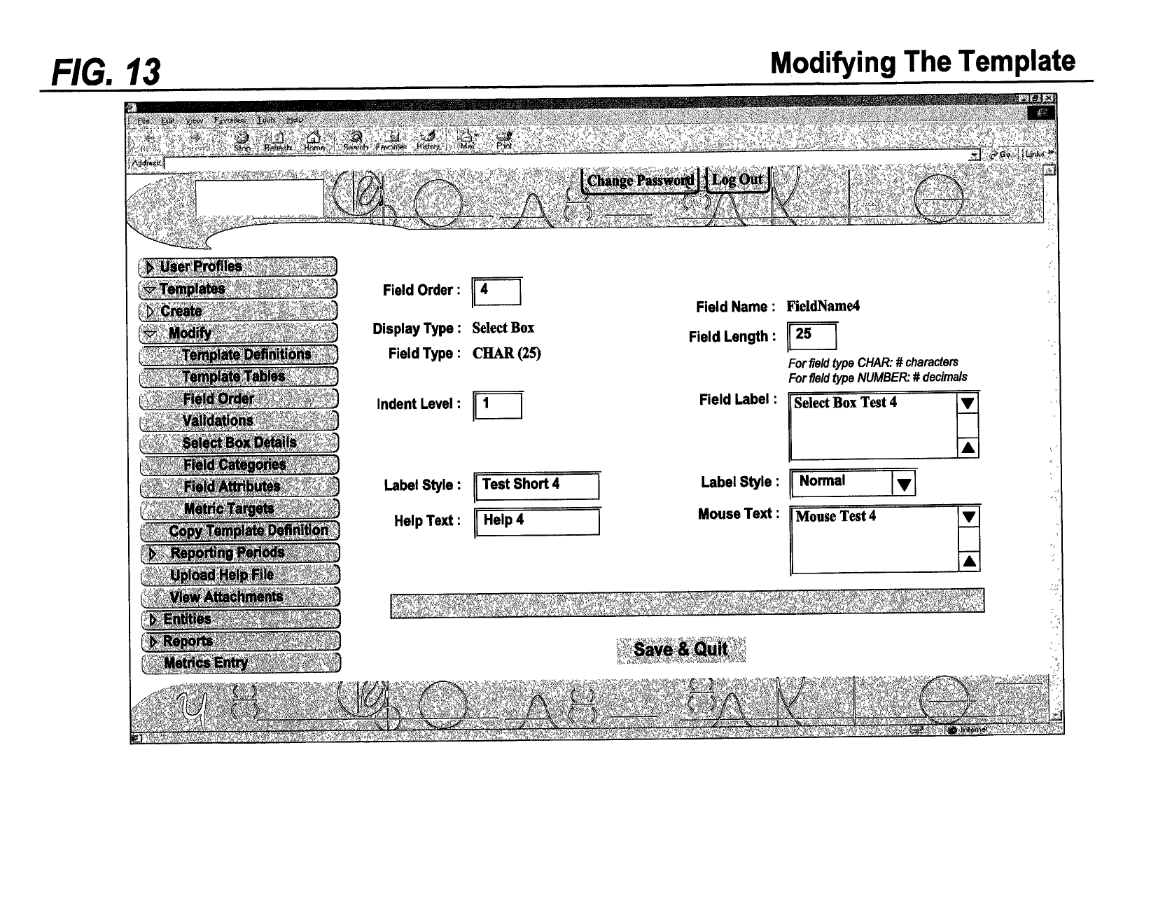

FIG. 13 provides an illustrative web page interface which further illustrates how a user may modify a template. As before, the user goes to pull-down menu 32 and selects template and modify to retrieve a web page template for user modification. Server 10 retrieves that user selected template from server 12.

Further, as shown in FIG. 13, this web page interface provides a user with the opportunity to modify all field data entry values except for those fields associate with internal database information. Following modification, the user uploads any modified templates to server 12 by executing the save or submit command.

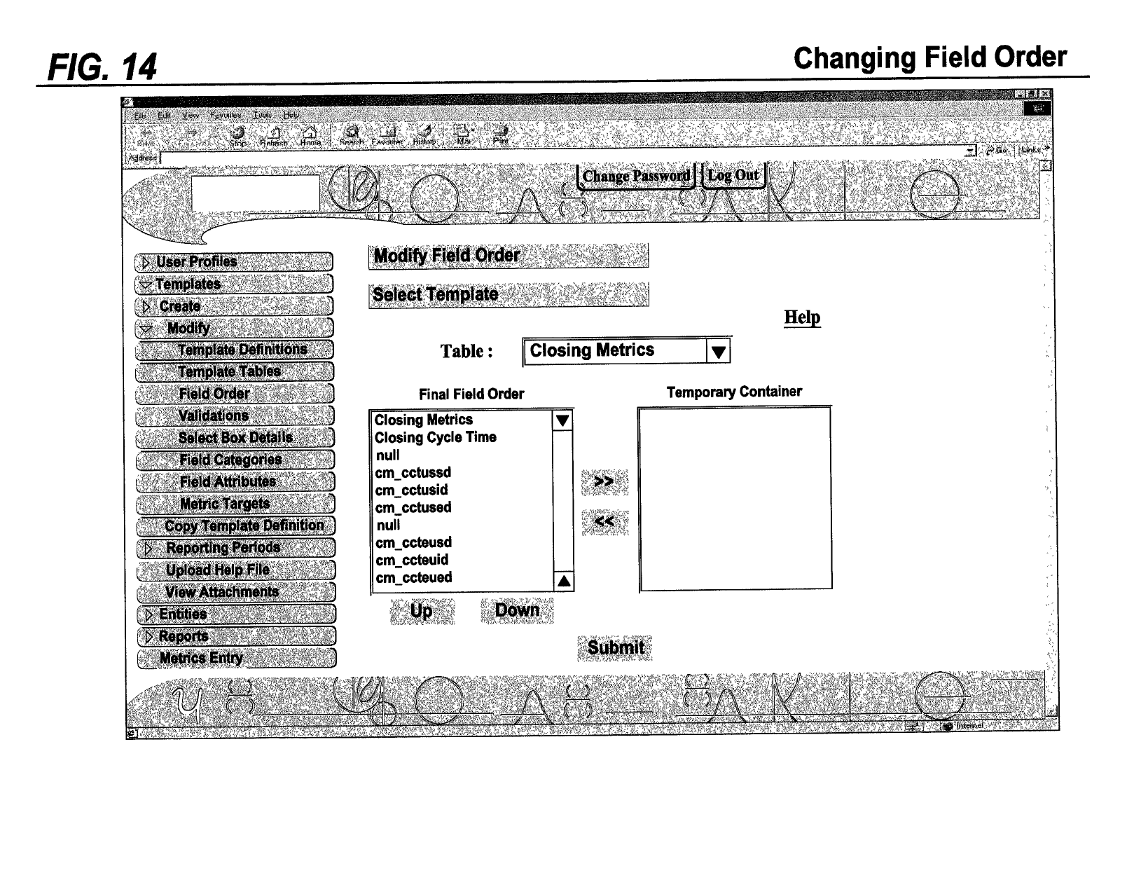

FIG. 14 provides web page interface which illustrates how a user may change (via sorting) the Final Field Order. For example, a user may desire to have a particular field appear prior to or after a different field on an interface or screen or report. If the user wishes to make this change in field order, a template is retrieved from server 12 by the user. The interface of that template shows a “Final Field Order” which is associated and electronically interchangeable with a system electronic temporary container via drop and drag if desired. An up and down scroll is provided for Final Field Order. Temporary Container may be used to store one or more metrics from Final Field Order. In this manner, further customization of the metric template is accomplished. The refined/adjusted/modified template is uploaded to server 12.

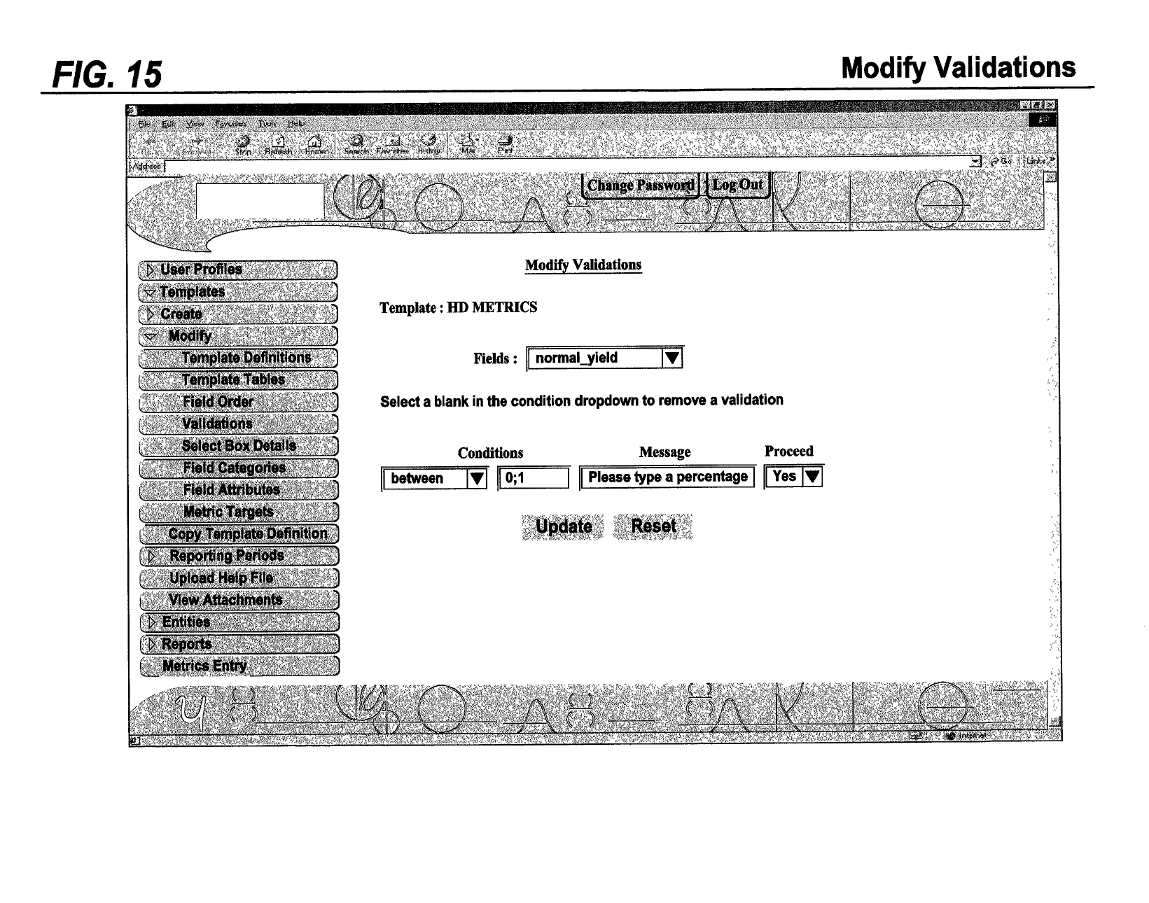

FIG. 15 provides an illustrative web page user interface which illustrates how a system user may modify validations. Validation modification may be desired by a user in the event the user becomes aware that initially selected lower and upper data parameters need to be adjusted. It may be that adjustment is needed to the user set limits on data values which are more realistic of the metrics of a particular business system. In using this interface, the user may select and retrieve the template for which validation adjustment is desired and then select the field whose validation are desired to be modified by a user. The user enters a new validation parameter or parameters for any field desired. The user then selects the update command which causes the update on validation to be updated and stored in server 12.

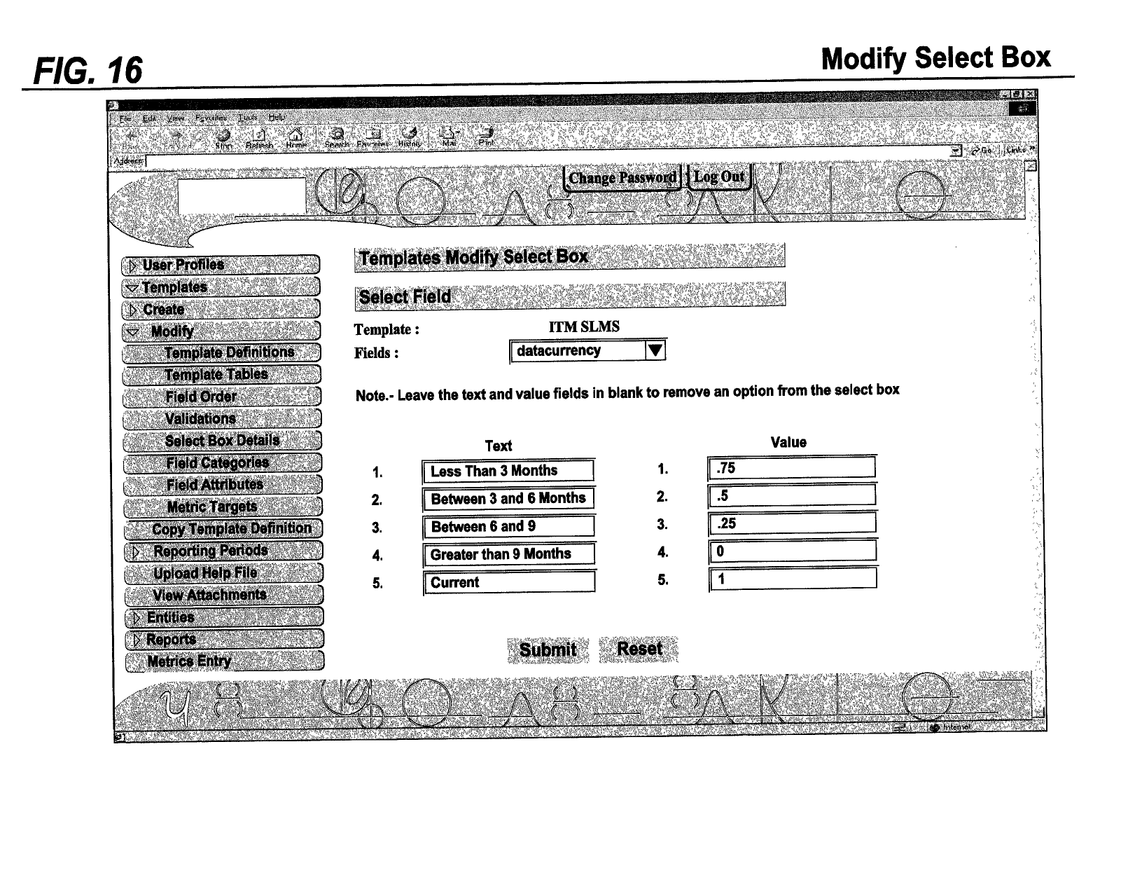

FIG. 16 provides web page user interface whereby user may modify select box (previously described above) of a field. A user selects and retrieves the desired template and selects the field associated with the select box which is to be modified. The updated text and value stored are entered and the submit command is used to upload this modified select box information into server 12. The user will leave the text and value fields in blank to remove an option from the select box.

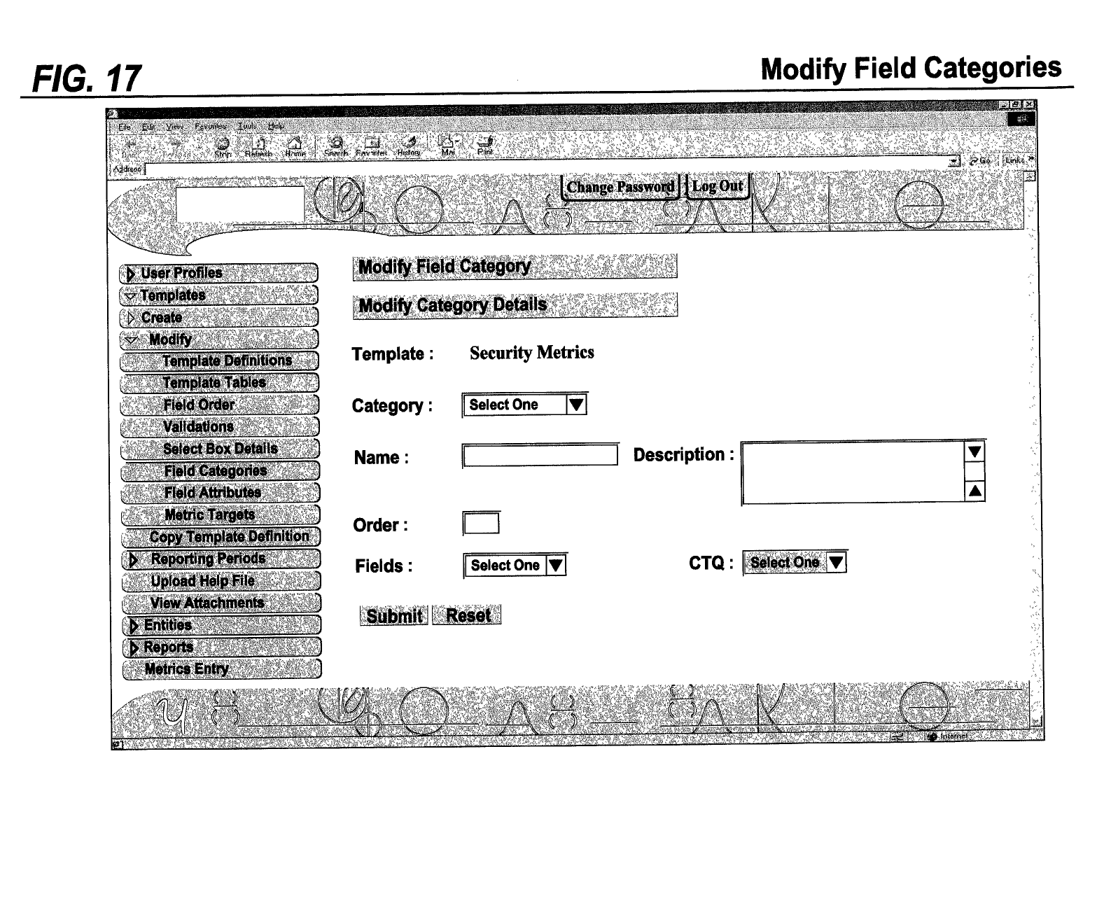

FIG. 17 provides web page interface which provides a user with a method for modifying field categories. (See Figures above) Illustratively, template is selected (retrieved) along with a category and a name, description, order and fields may be entered. The user then selects the submit command whereby the update of this interface is uploaded and save to the metric business database of server 12.

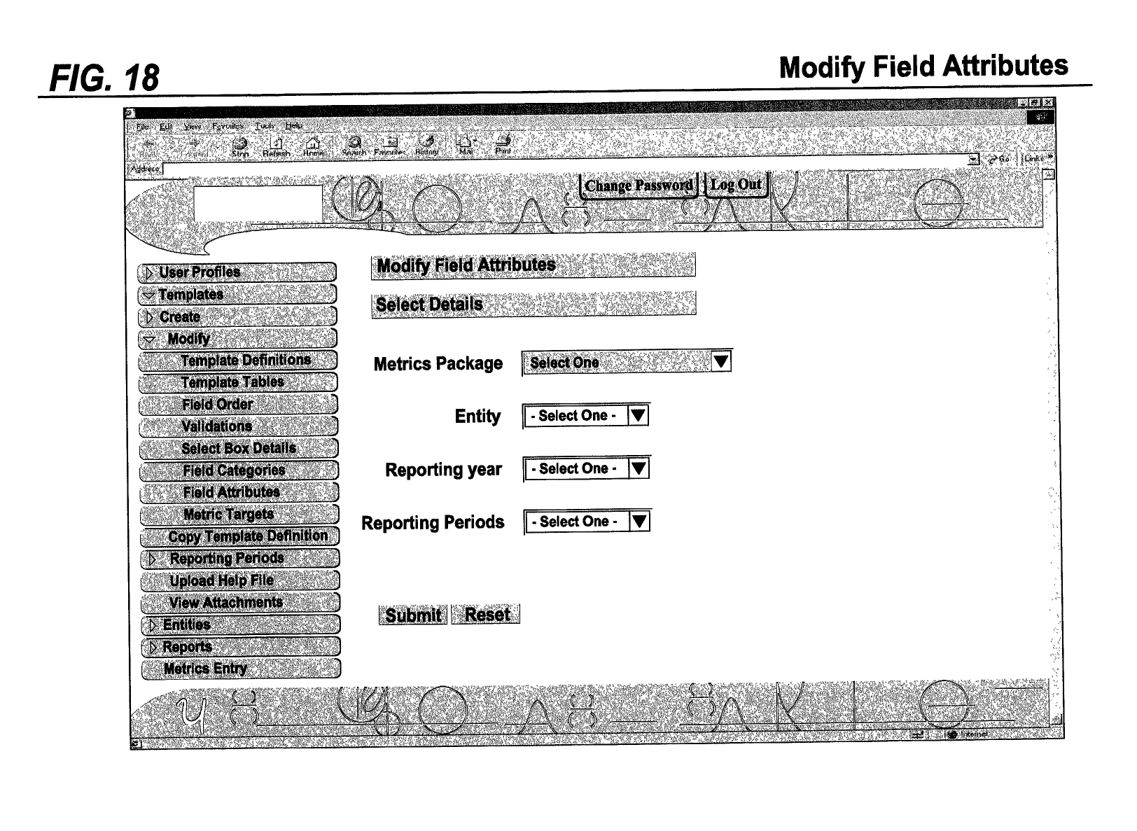

FIG. 18 provides web page user interface whereby a user may modify field attributes. A user selects a metric package, an entity, a specific reporting year, reporting year. Changed/new values are then entered and the user employs a system submit command to upload modified field attributes to the business metrics database of server 12.

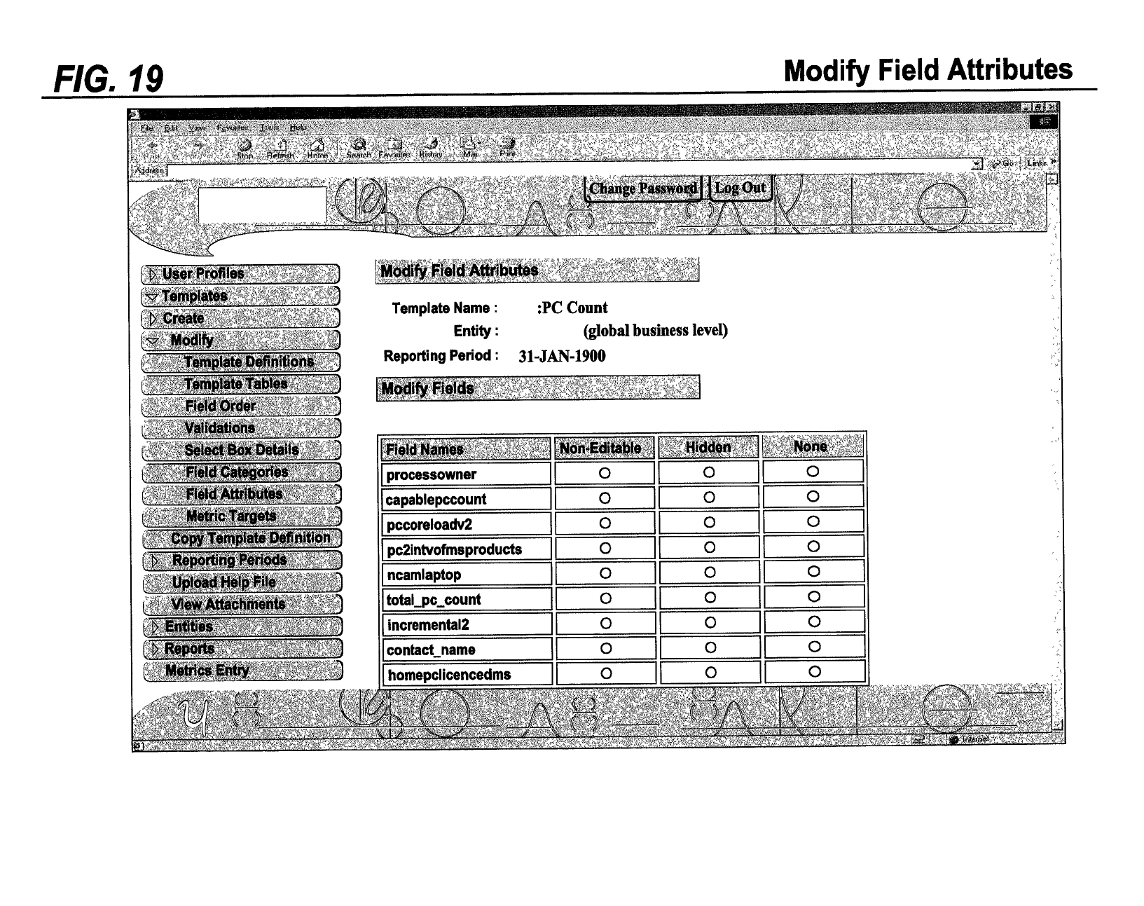

Further refinement of a metric template is provided to a user of system 10 and is shown illustratively in FIG. 19. A user selects/retrieves a template for a particular business entity. The user may then further modify fields of that selected template by adding and thereby associating manipulative and/or visual restrictions to and with such fields as non-editable, hidden or none. The optional user selection of none leaves the field unchanged. A user may then save this modification by entering the save command of server 10 and upload the modification to server 12

Further in FIG. 19, field names are shown as processowner, capablepccount, pccoreloadv2, ncamlaptop, total _pc_count, incremental2, contact_name and homepclincensedms. Independent available restrictions include Non-Editable, Hidden and None.

In some instances for efficiency, users of this business metrics system, may find it expedient to copy template definitions.

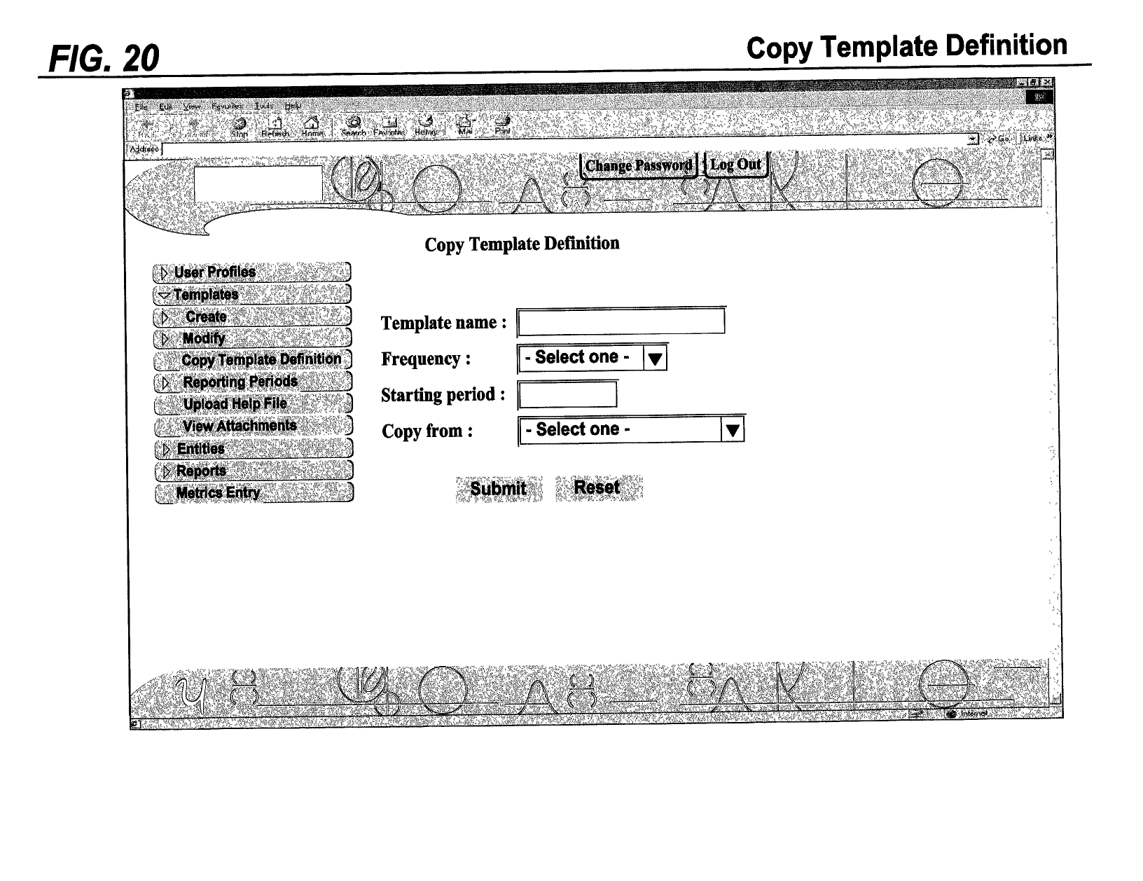

FIG. 20 provides an illustrative user web page interface. In using this interface, user selects and enters a name for the copy of this template, the frequency, and starting date in a data format such as MMDD/YYYY, wherein MM is a format for month, DD is a format for day and YYYY is a format for year. A user selects the template to be copied by the system and selects submit. Thus the desired template will have been copied and is uploaded to server 12.

As a part of the customization provided in this business metrics method and system, a user may add one or more new reporting periods for a selected template.

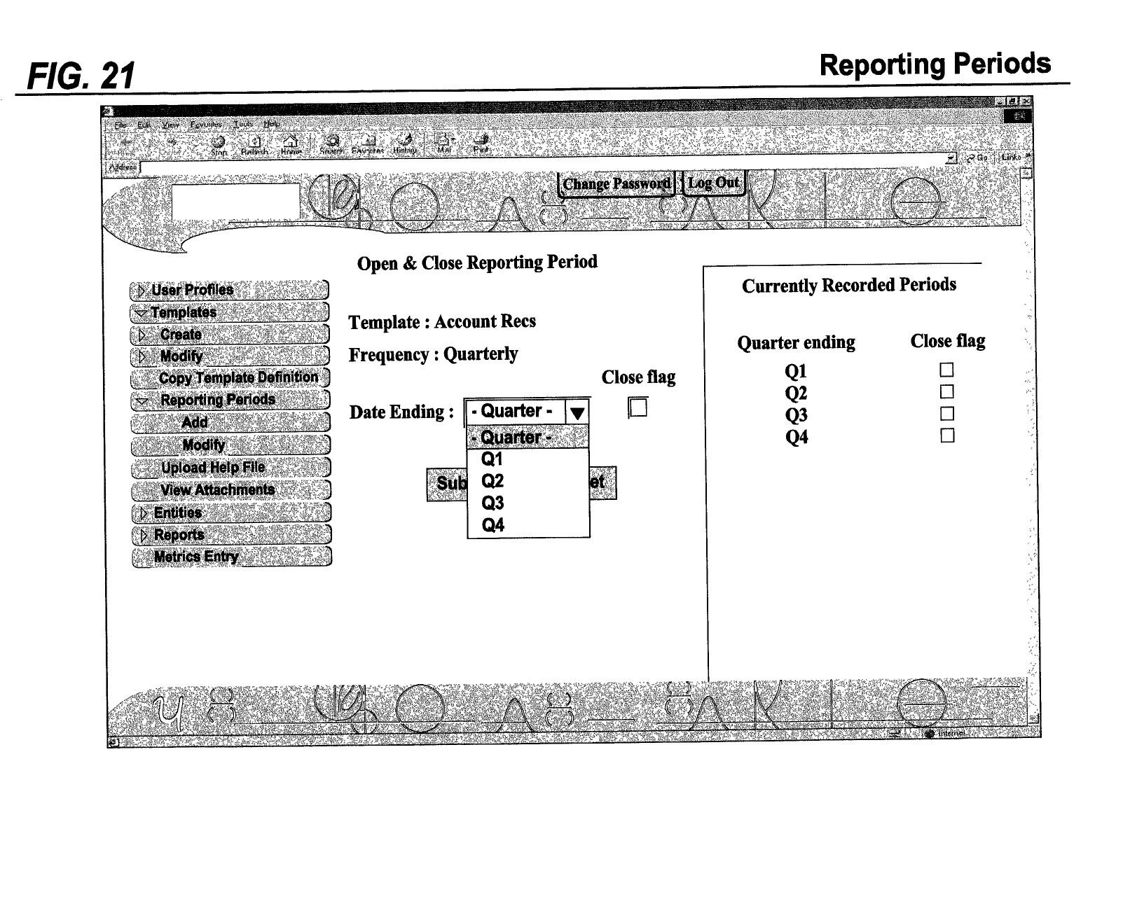

Illustratively, FIG. 21 provides an illustrative web page interface which relates to Reporting Periods. In using this interface, a user selects a template and a frequency, the user then selects a quarter of a year which the user wishes to add. This selected quarter will then appear for end users in the metrics entry. A user closes on this interface screen and on the modify reporting periods screen.

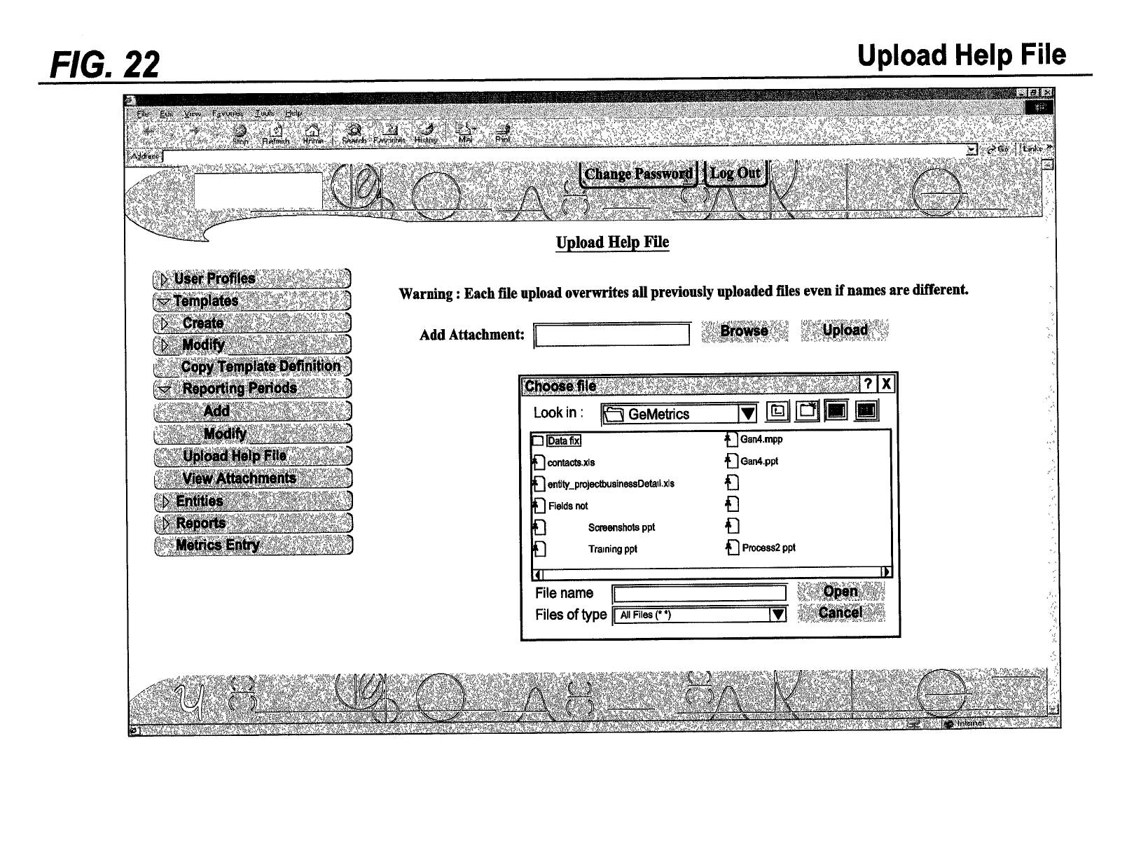

Because some users may find it helpful to refer to help files during use of this system and method, FIG. 22 provides an illustrative web page user interface. A help file in any readable format may be attached to a template by retrieving the desired template and enter the name/location of the file desired to be attached in the add attachment entry area for this interface. A user then saves the update template by executing the save command and uploaded the help file to server 10. An exemplary choose file, in selecting a help file, is shown in this Figure.

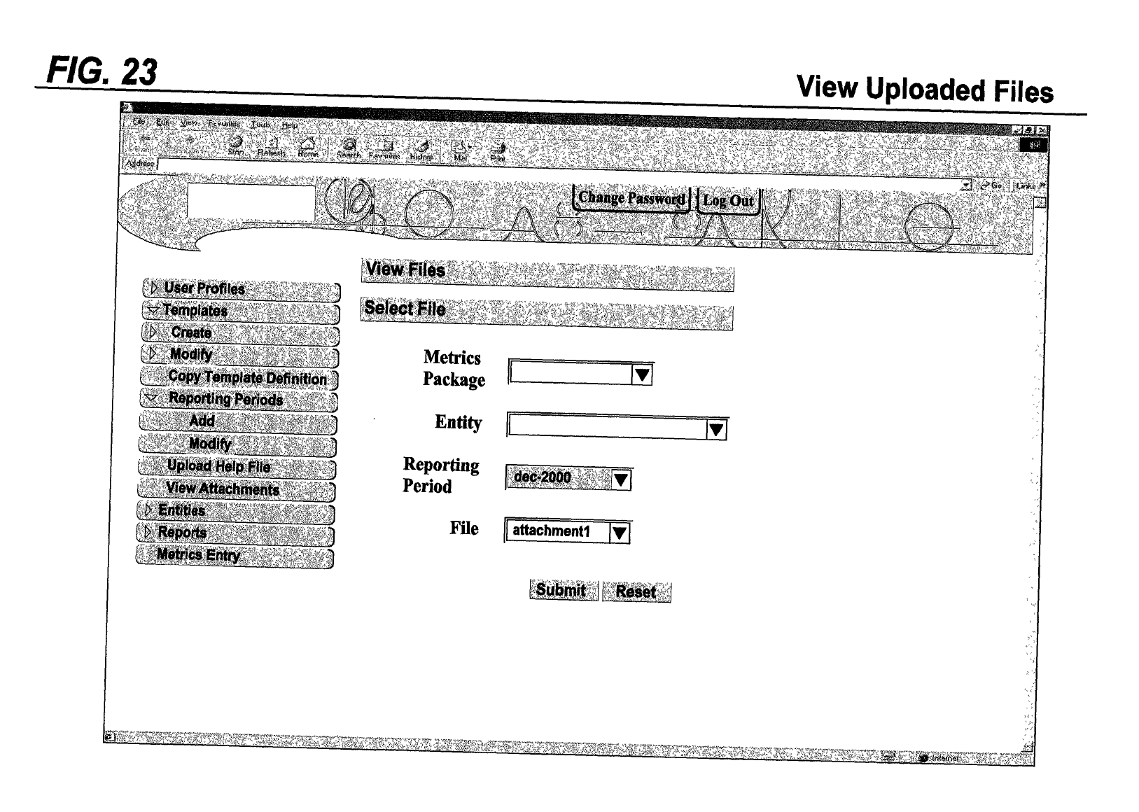

This system and method provides a user a way to view one or many uploaded files. FIG. 23 provides web page interface whereby a user selects view files on a retrieved template and then select one or more files to be viewed by user. User selects a desired metrics package, entity, reporting period and file. This feature may be used to view uploaded files, such as those which could be action plans to further improve business metrics if desired.

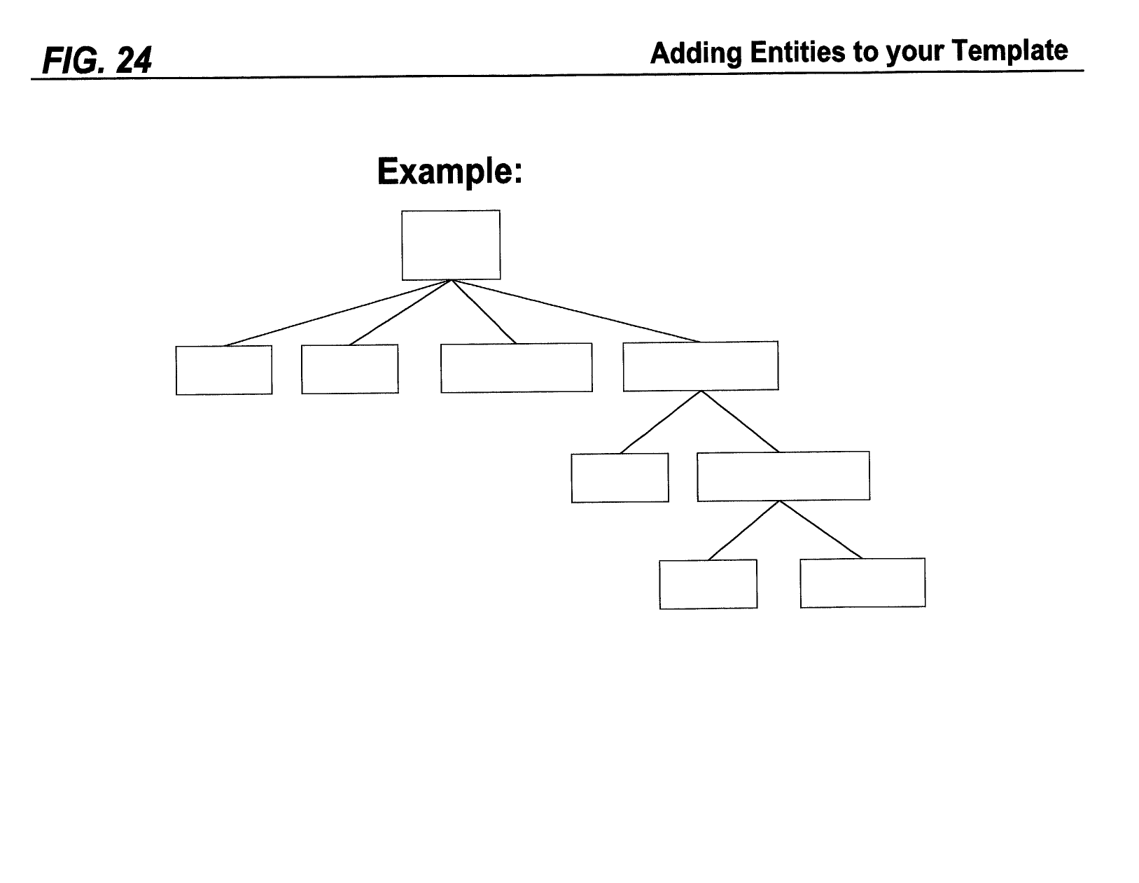

Attaching entities is a useful optional feature of this system and method. FIG. 24 illustrates a way for a user to do this. In FIG. 24, a business unit structure is diagrammed so that the order of listing of selected entities is clear. An exemplary business hierarchy is one in which there is one or more instances of business parent and business subsidiary hierarchical reporting relationships. Sometimes these are termed business parent and business child relationships.

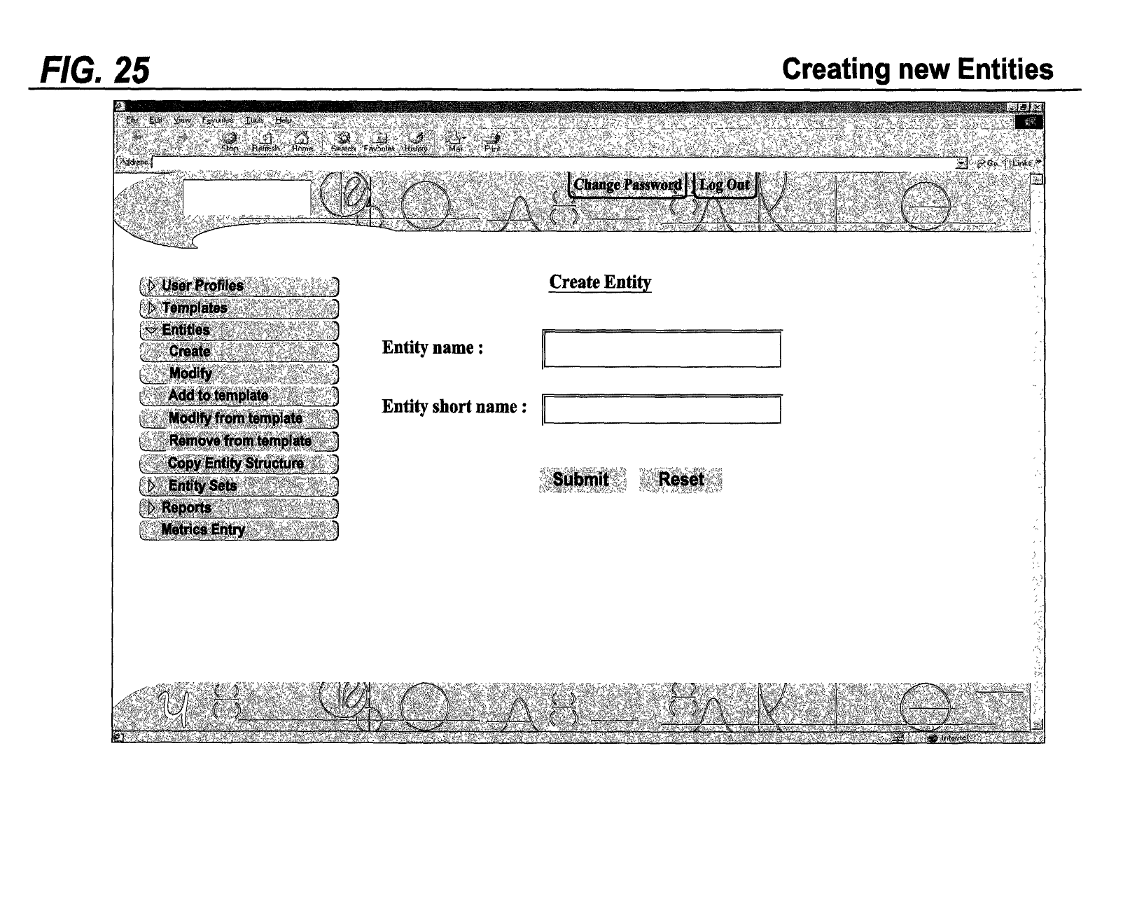

FIG. 25 provides an illustrative web page user interface whereby a user may create new entities such as those described in FIG. 24 above which may include business parent business child relationships. In using this interface, a user would enter a full entity name in the entity name data entry area and a shortened entity name in the entity short name area. In an embodiment, the entities created in this interface will correspond to those entities illustratively shown in FIG. 24 previously.

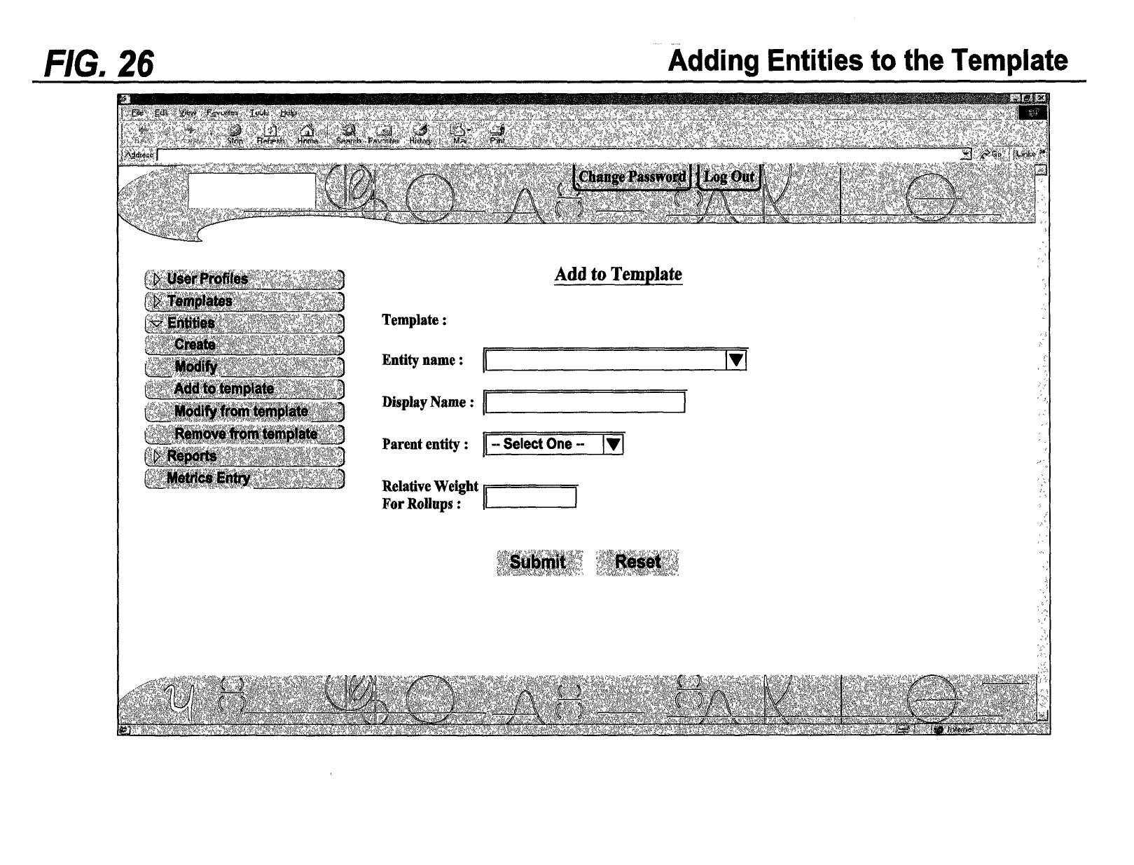

At times it is desirable for a user to add business entities to a template or templates. FIG. 26 provides user interface to add entities to template features. In using this illustrative interface, a user would retrieve the interface previously created in Figures above and start with the top of the entity chain, for example the top of the business structure in FIG. 25. A user could select that name and give it a different display if desired. The parent entity could be left blank. For relative weight, the value one can be entered. A user then enters the submit command which instructs server 10 to save that entity on server 12. For the entities following, the user would enter the appropriate parent name or designation. For relative weight the user will provide an user selected numerical multiplier value which will allow business entity size to be taken into account when the business organization structure is rolled up to the parent. The arbitrary multiplier value is a numerical value, whole or decimal/fractional, selected by user.

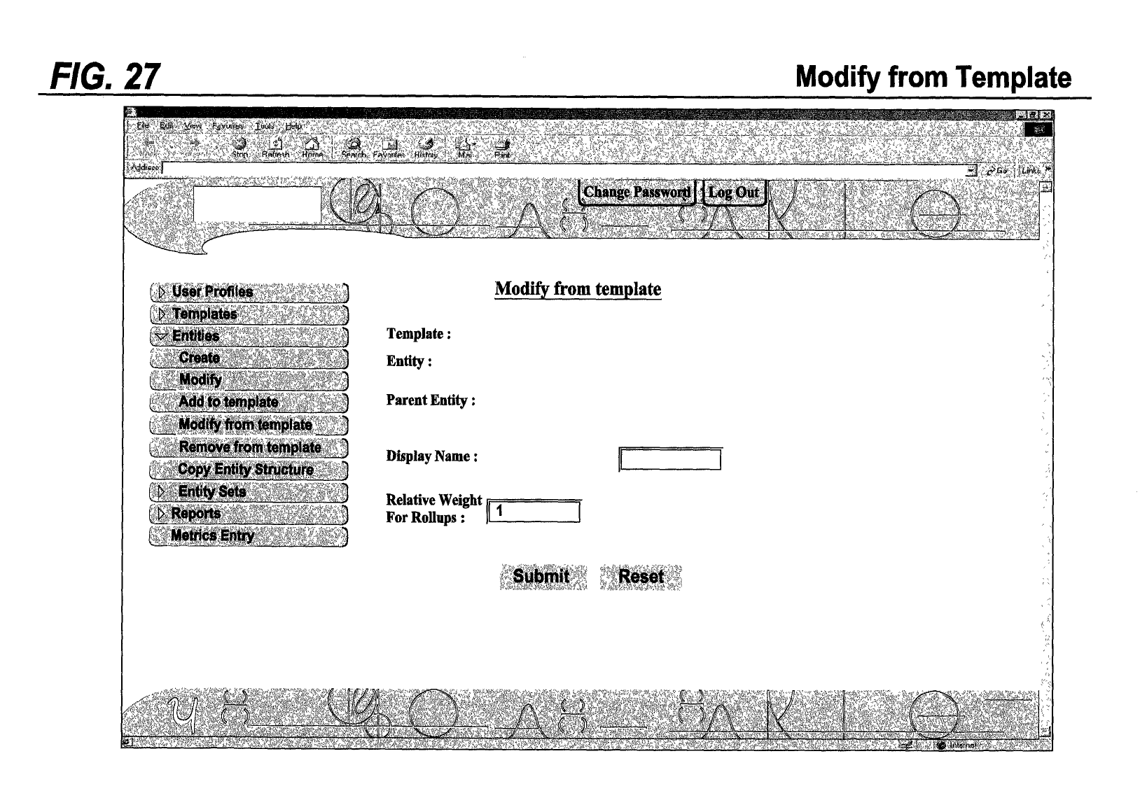

FIG. 27 provides a web page user interface whereby a user may change the display name that will appear on reports or the rollup weight. A user may enter revised display names and rollup weights. A user then submits the revised template to server 10, which saves the revisions on server 12. As used herein, rollup weight is a technique for data entry which is an instruction to server 10 to list the output in a organization structure/format envisioned by user.

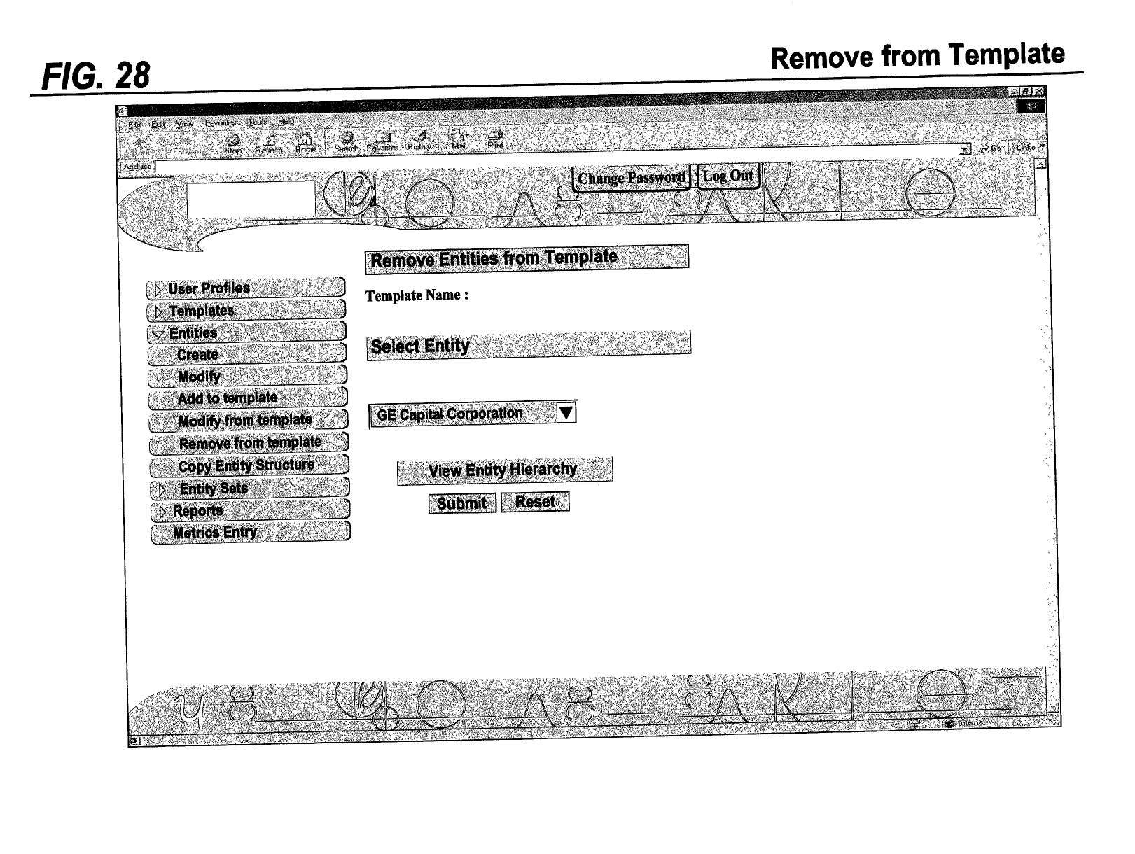

FIG. 28 provides a web page user interface whereby a user may remove one or more business entities. Upon instruction from a user, an entity can be removed if there is no data in it or the entity has no “child” business entity, which follows it. The choice of removing a business entity is optional with the user.

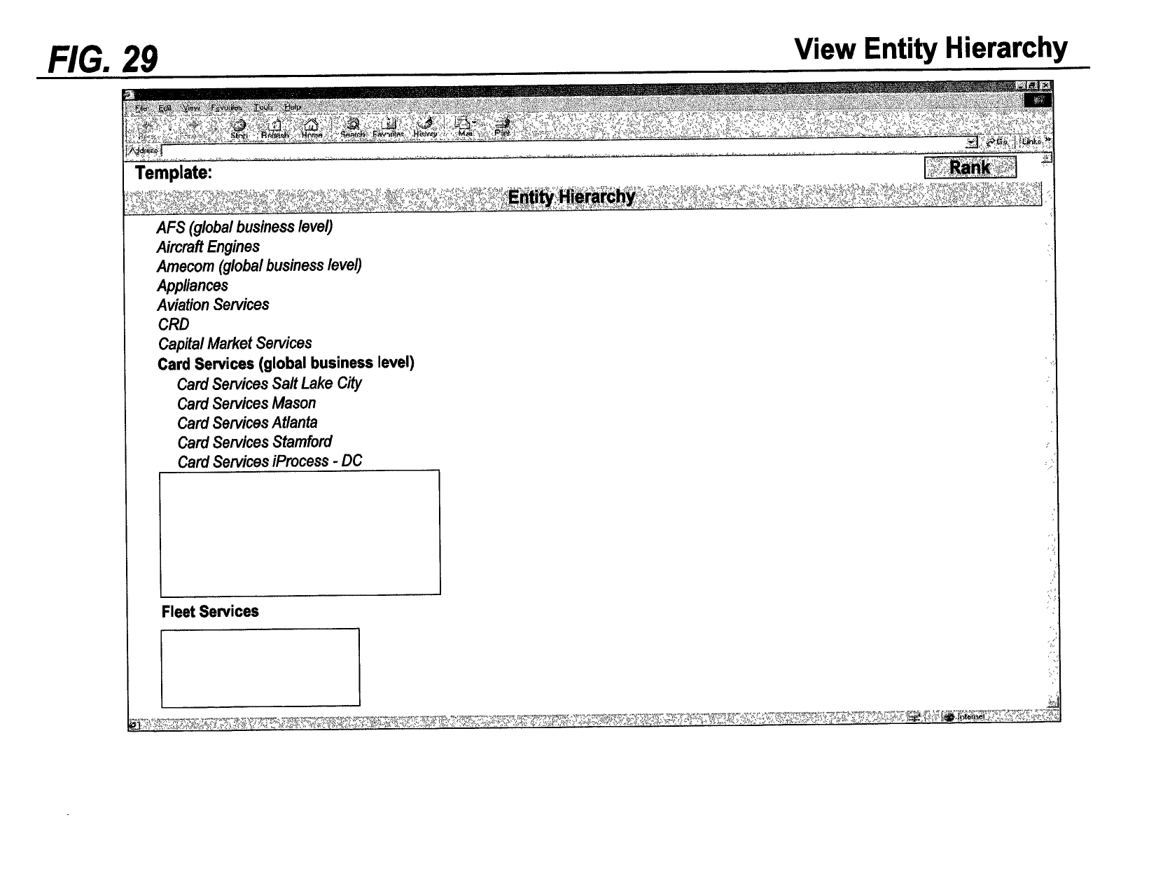

FIG. 29 provides a feature of this system and method in web page interface “View Entity Hierarchy.” This feature of this system and method provides an interface whereby a hierarchy listing is provided of various business entities for a selected template. A user may utilize this interface by selecting the view hierarchy for this display. A hierarchy listing is useful to business managers who may be reviewers of templates of this method and system. A print function is shown associated with this function.

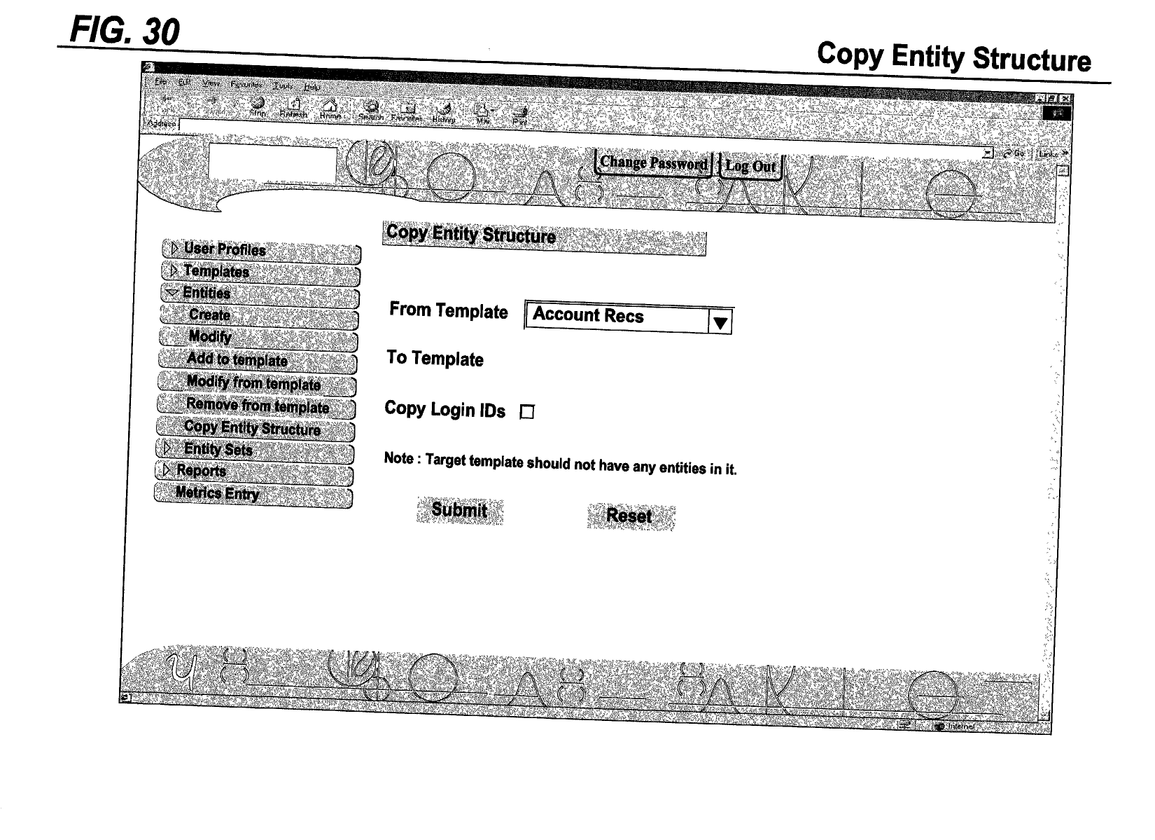

Further refinements are provided in this system and method. FIG. 30 provides a user interface where the entity structure may be copied. This facility may be used for different templates which have the same entity structure. This affords the user the advantage of having to create the entity structure once if desired. A user may bring up this template copy it as desired to other templates. Copies are then saved to the business metrics database server 12.

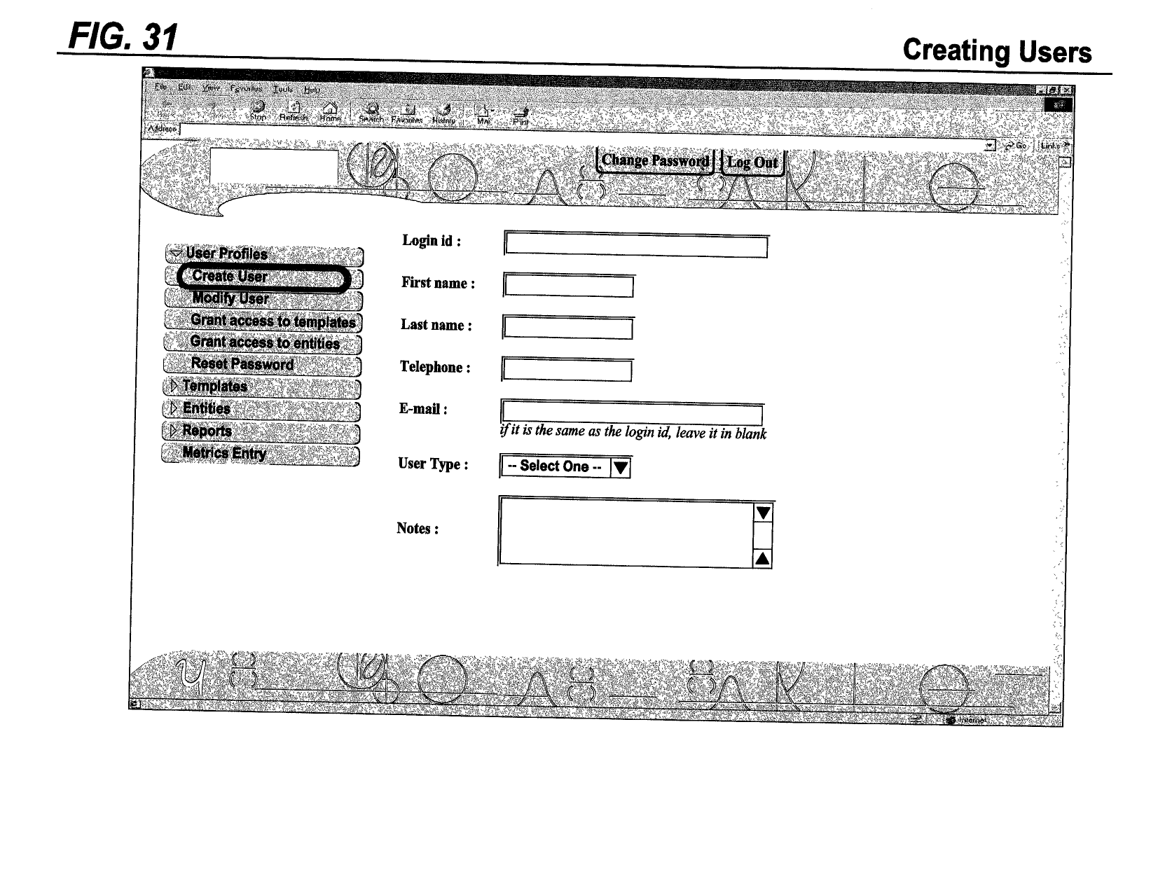

FIG. 31 provides a web page user interface whereby a user may create server 10 access for other users. In doing this, illustratively a user creates access for other users to server 10 within a select group, such as a group of users having a common business interest. This feature is created by adding a login id (identification), a first and last name, telephone number, e mail (electronic mail) address, identifying user type and optionally entering notes. These users are then stored in server 10 by uploading this information.

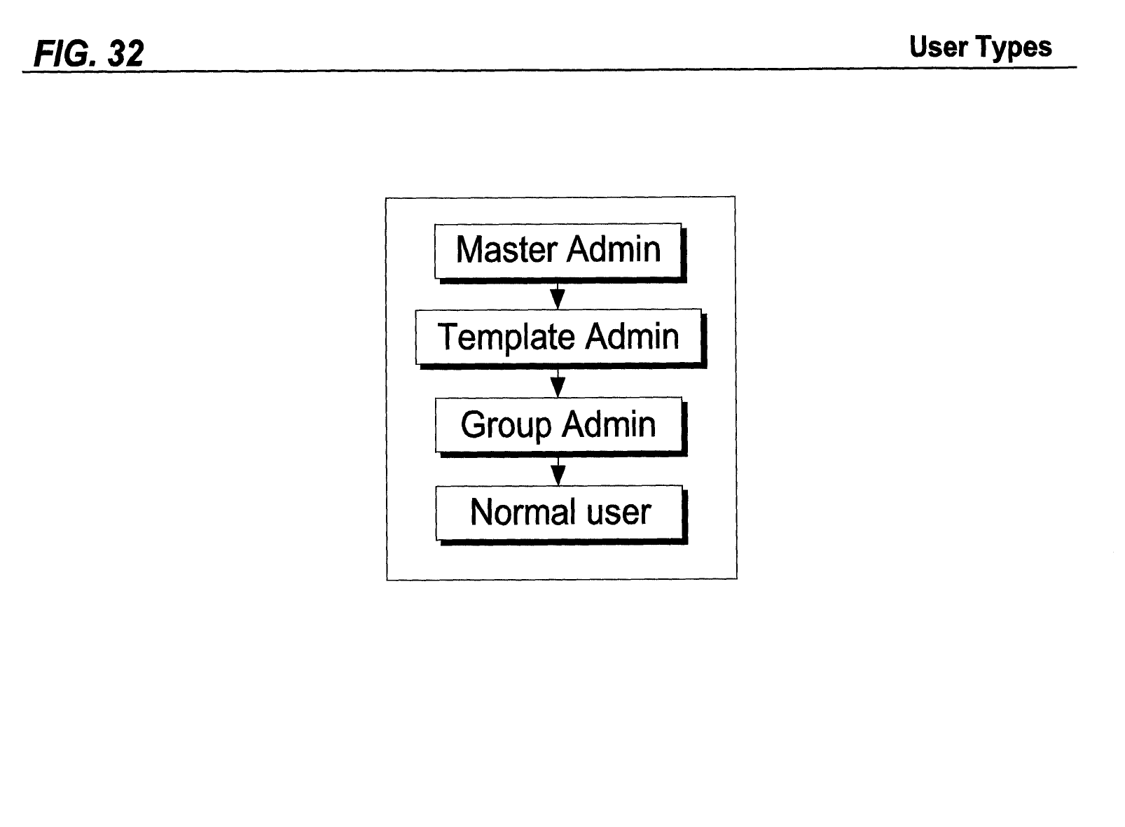

FIG. 32 depicts a typical list of administrative rights/user types or classifications. In this Figure, an illustrative administrative hierarchy is shown for master administrators, template administrators, group administrators and other users, name normal user(s).

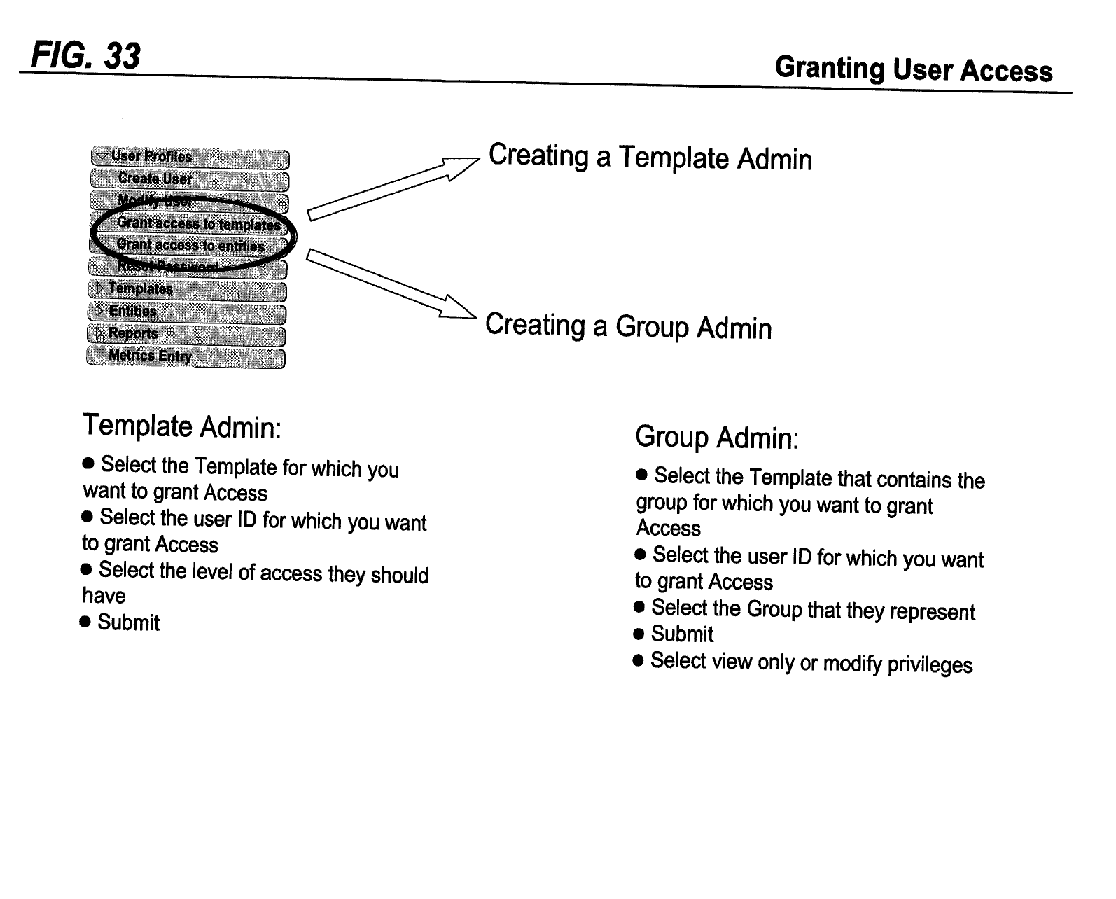

FIG. 33 provides illustrative web page user interface which illustrates a method of granting user access. In using this system, a template administrator access and a group administrator access may be created if desired.

In creating the template administrator, a user would select the template or templates for which user wishes to have a template administrator have system access. The user selects a level of access that a template administrator should have. The user then executes the submit/save instruction to server 10.

A similar procedure may be followed by a user in creating a group administrator. Illustratively, the user selects a template that contains the group for which user wishes to grant access to a group administrator. The group is selected. User selects view only or modify privileges. The view privilege means that the user may only view files and interfaces in the system, while the modify privileges allows the user to modify one or more files or interfaces in the system. User then submits the updated group administrator access to the system and the server 10 uploads and saves the updated user access authority files in database 16 on server 12. Access rights vary illustratively from viewing rights to authorship rights. The template administrator may select the template for a user to grant access, select the ID (user computer identification) of the user for which the administrator wishes to grant access and may select the level of access that that administrator is providing to the user. The template administrator then saves this user associated information to server 12 via using the submit or save command to server 10.

Further with regard to FIG. 33, a group administrator may select the template that contains the group for which the administrator wishes to grant access, select the user ID for which the group administrator wishes to grant access, selects the group that the users represent and then may save this associated information to system 10 by using the save or submit command to system 10. The group administrator may select view only or modify privileges and provide one or more of these to the user.

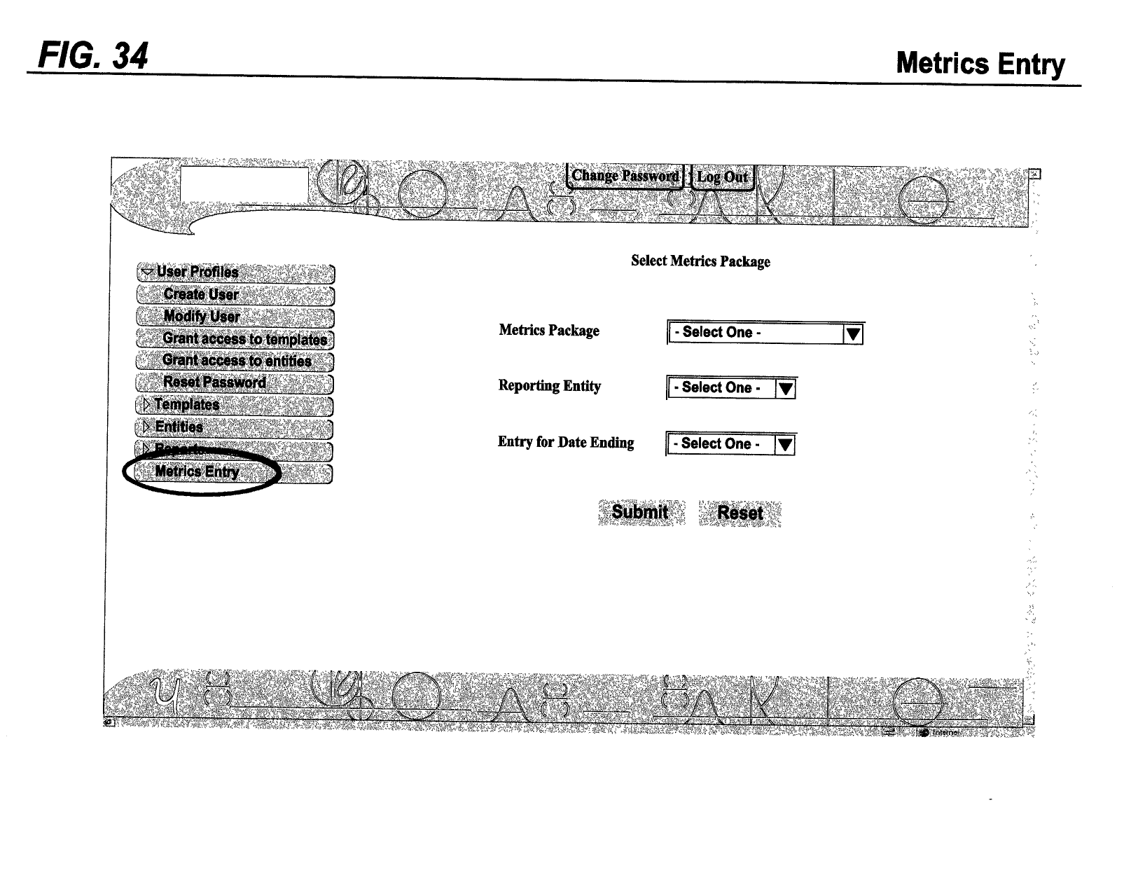

The foregoing FIGS. 1-33 have provided a description of a system and method of managing business metrics. FIGS. 34-67 hereinafter provide more nonlimiting description of a system and methods for managing business metrics.

Reporting is an important aspect of this system and method of managing business metrics in that reporting of business metrics enables management to manage business units with this additional business tool.

FIG. 34 provides an exemplary user interface. A user selects Metric Entry from pull down menu 32 (see FIG. 1) In entering metrics data, a user selects the metrics package, reporting entity and entry date of data entry. A user selects the submit command to server 10. Server 10 retrieves the template information from database 16 on server 12 and rapidly constructs the data entry screen which is then sent to the device 14 for the corresponding metric data entry as selected by user.

FIGS. (35-53) provide exemplary web page interfaces which shows the reporting feature of this system and method for managing business metrics.

Dashboards are useful views of a web page interfaces and are typically selected and setup because of user desires to view some selected information together at one time in one web page view.

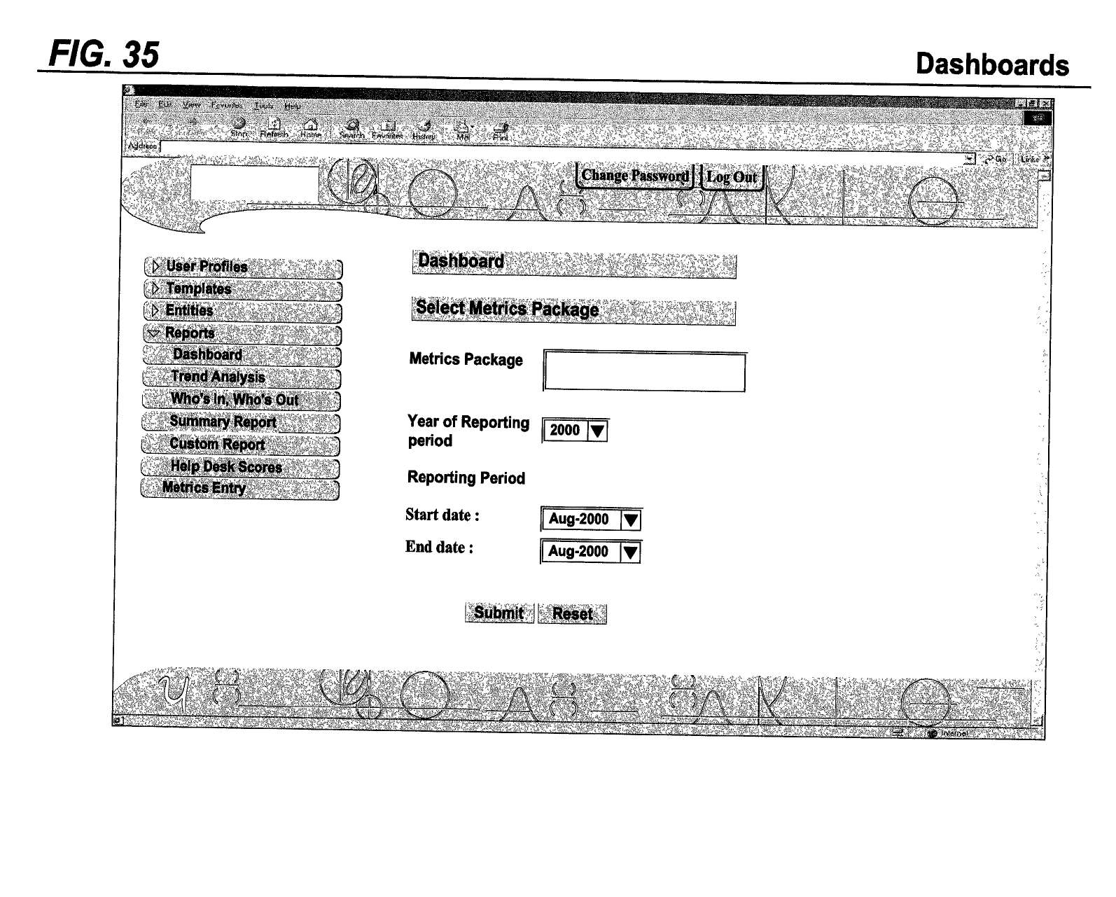

FIG. 35 provides an illustrative web page dashboard user interface which may be viewed by a user desiring a report from server 10. In using this interface the user enters a metrics package that the user wishes to see on a dashboard. After the metrics package is selected, user selects the template and period for reporting thus creating the dashboard shown in this Figure.

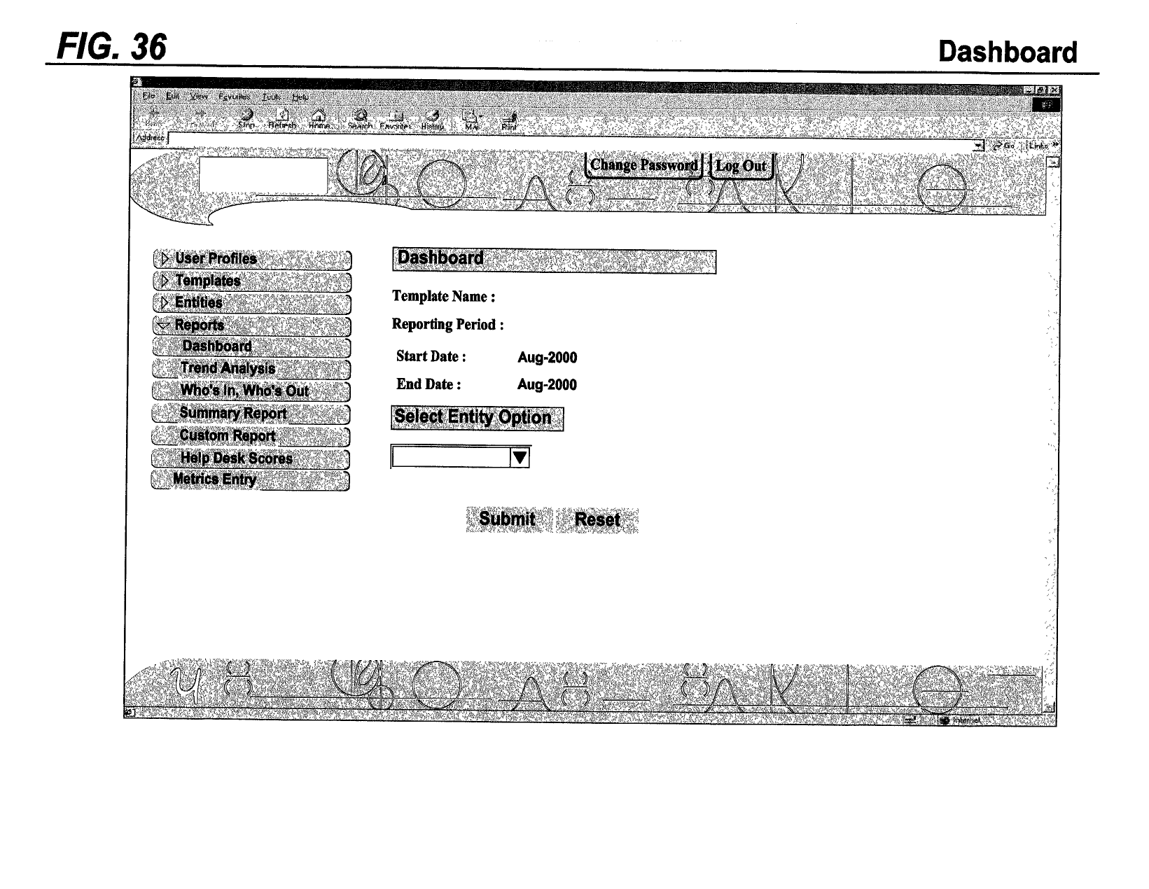

FIG. 36 provides another illustrative web page dashboard user interface. User may select pre-selected “canned” business entity or create a custom business entity selection. In creating either entity set, a user selects reports under pull down menu 32 (see Figure) and selects dashboard. A user then selects entity options.

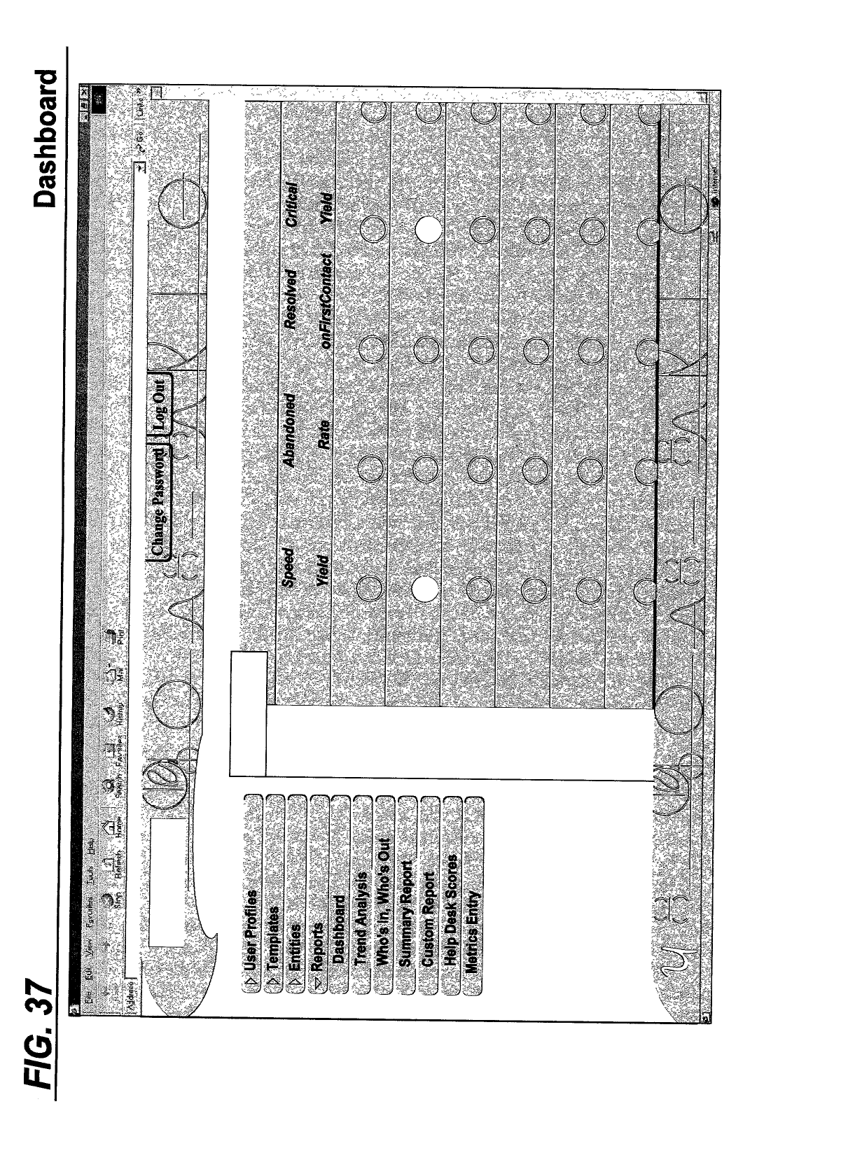

FIG. 37 provides another illustrative dashboard web page user interface which shows speed yield, abandoned rate, resolved on first contact and critical yield for a selected template.

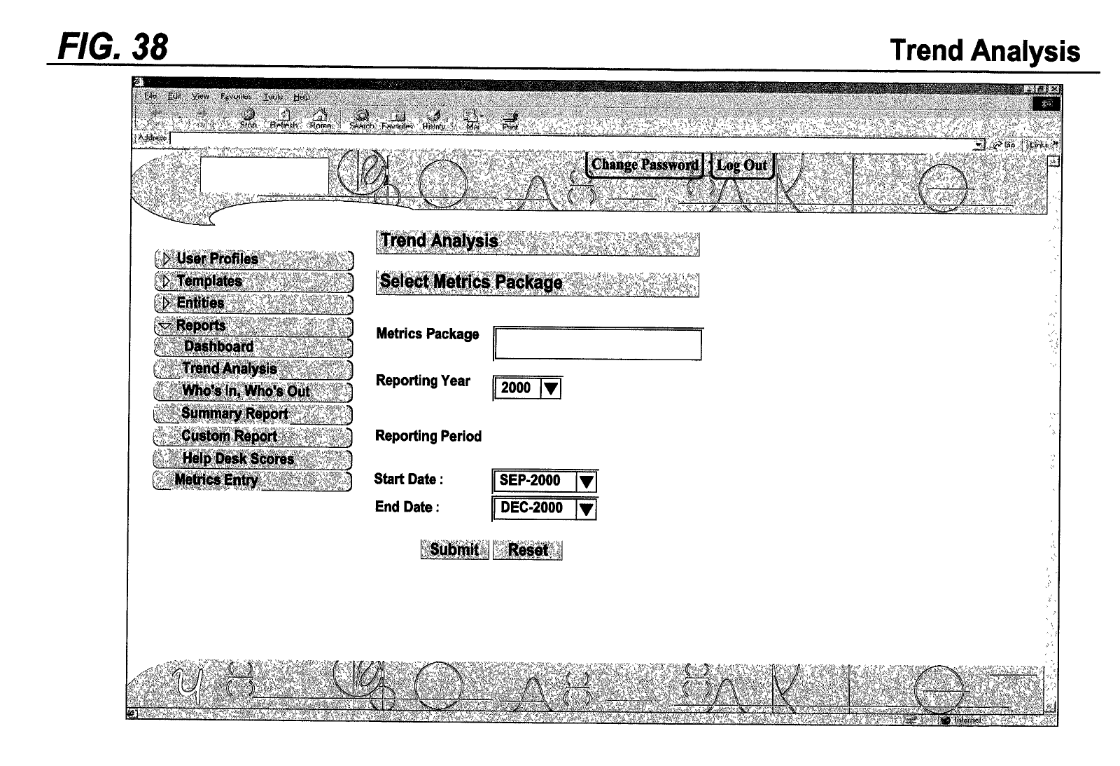

FIG. 38 provides another illustrative web page dashboard user interface which shows a trend analysis. User selects reports from pull down menu 32, dashboard and trend analysis and identified a metrics package. A user enters metrics targets for all files/information that user wishes to see on a trend analysis graph. User selects the template and the period or year for reporting. The format of such reports will be web page format. Further, this Figure shows a reporting period having a start date of September 2000 and an end date of December 2000.

If desired one or more mathematical computations may be performed on inputted business metrics data. Illustratively, a mathematical computation may be performed on such inputted/uploaded business metrics data, wherein such computation may include one or more of summing, averaging, time weight averaging, comparing and performing a trend analysis. In particular, trend analysis is useful to detect changes in business operations over time. Such trend analysis is illustratively done by comparing business metrics data taken at several different times and plotting that comparison over time such as a period of elapsed time. Trend analysis output is an example of a useful physical product of this method and system.

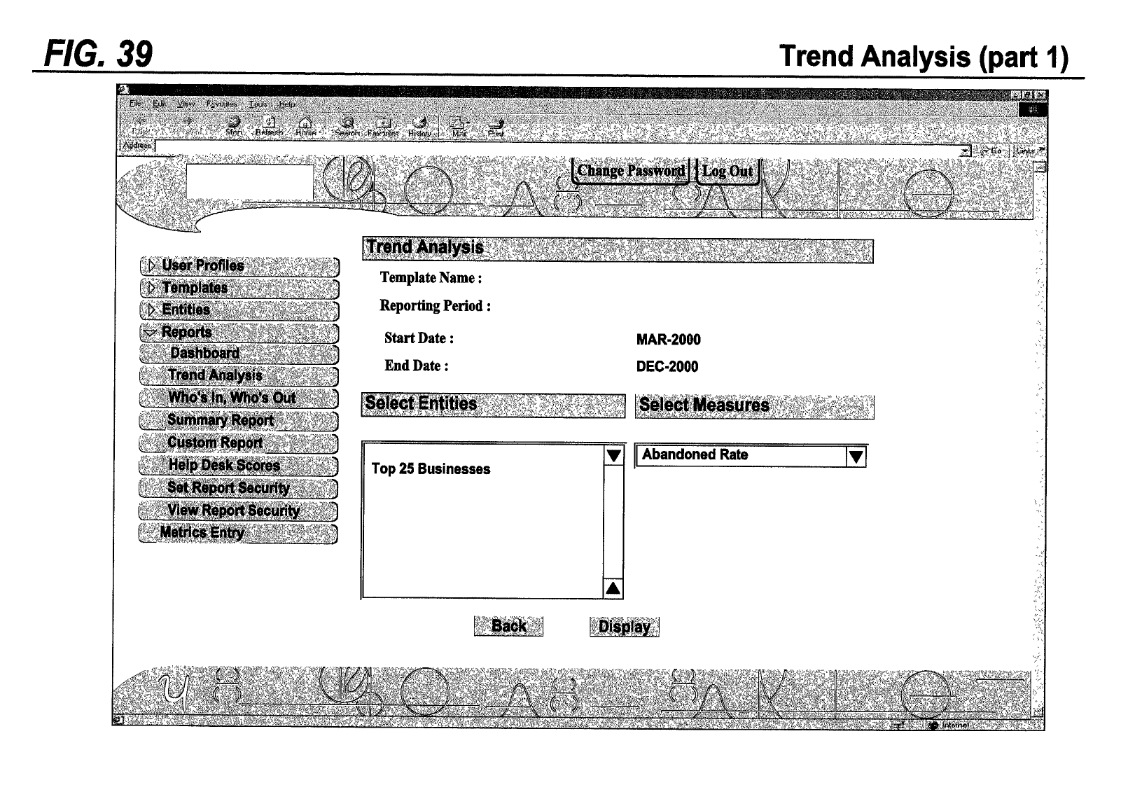

FIG. 39 provides an additional dashboard user interface relating to trend analysis. A user selects reports from pull down menu 32 and trend analysis. A user selects an entity, sets up top or selects multiple businesses using the control button and the user then selects a measure (metric) or more, that that user wishes to have graphically plotted as a trend analysis. Server 10 then graphically plots the user selected data according to the parameters the user provided to system 10.

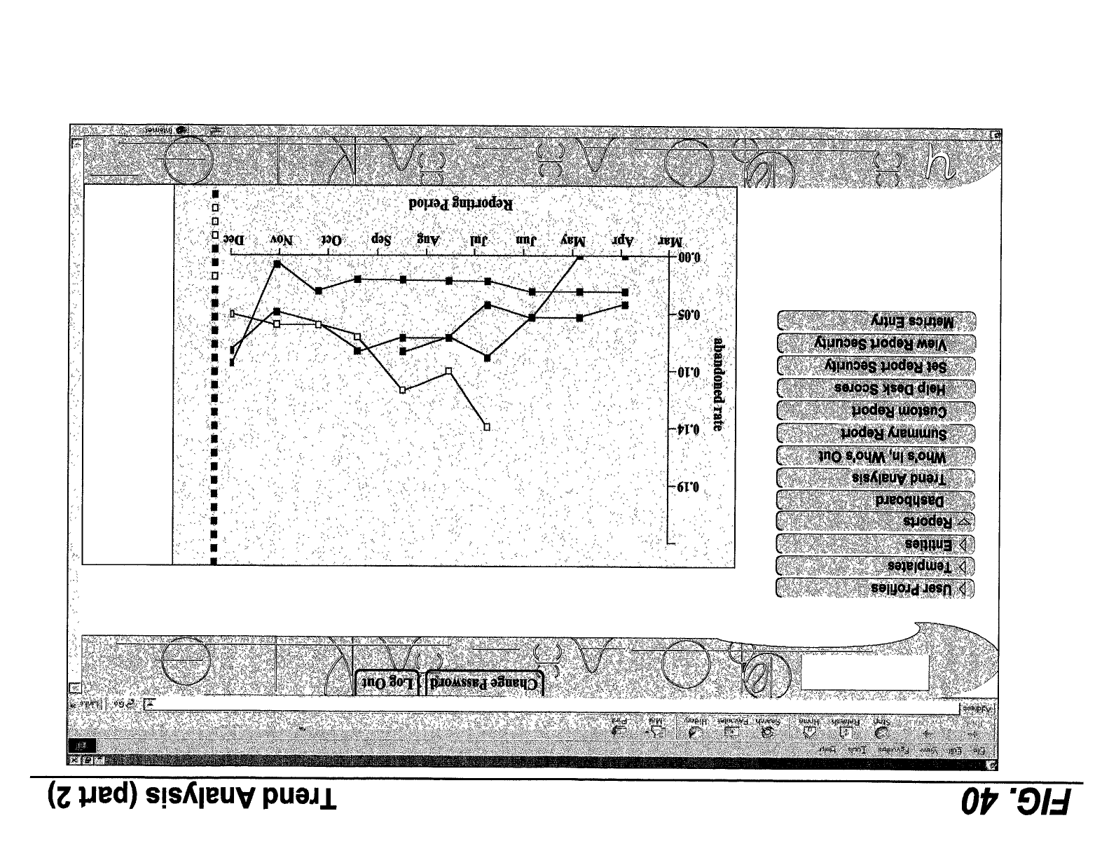

FIG. 40 provides an illustrative trend analysis which in abandoned_rate is shown on the abscissa and months are shown in a reporting period on the ordinate. Trend analysis is a useful and powerful mathematical analysis of one or more sets of data, which attempts to predict or point out the general drift, tendency, or direction of a set of data as is related to time or another related set of data. Trend analysis is used to project possible business shifts or changes in operation. Several trend analysis may be shown on the same output.

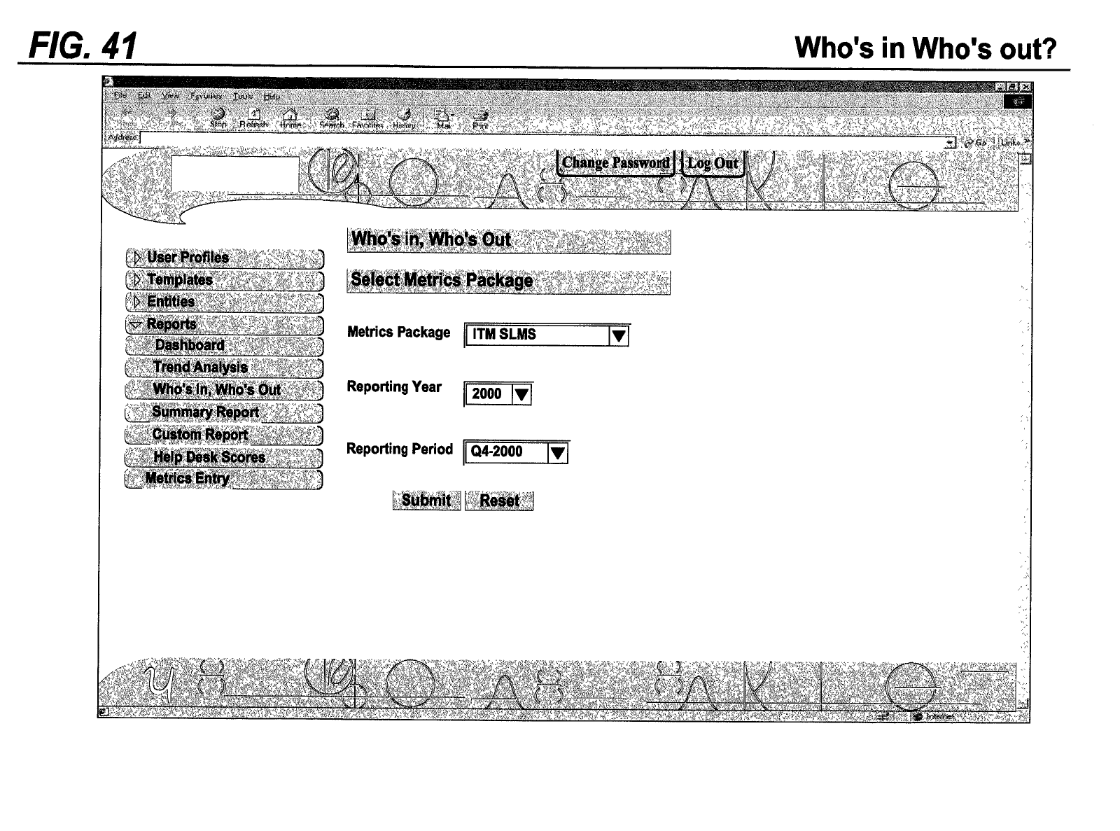

FIG. 41 provides an illustrative user interface package which provides a method to identify which business unit or user has submitted metrics and which business unit or user has not submitted metrics. Illustratively this is conveniently termed Who's in Who's out? Server 12 has stored a list of business units which have the capability to provide business metrics to the system. Upon user request for identification of those system users who have not submitted business metrics, server 10 retrieves the information from server 12 and compares a list of the names of the business units which have supplied business metric data with a list of the names of business units which have the capability to supply business metric data and provides a resulting comparison list of those business units which have not supplied business metric data to the user. The information as to which business units have supplied business metrics and who has not supplied business metrics is termed Who's in Who's out?

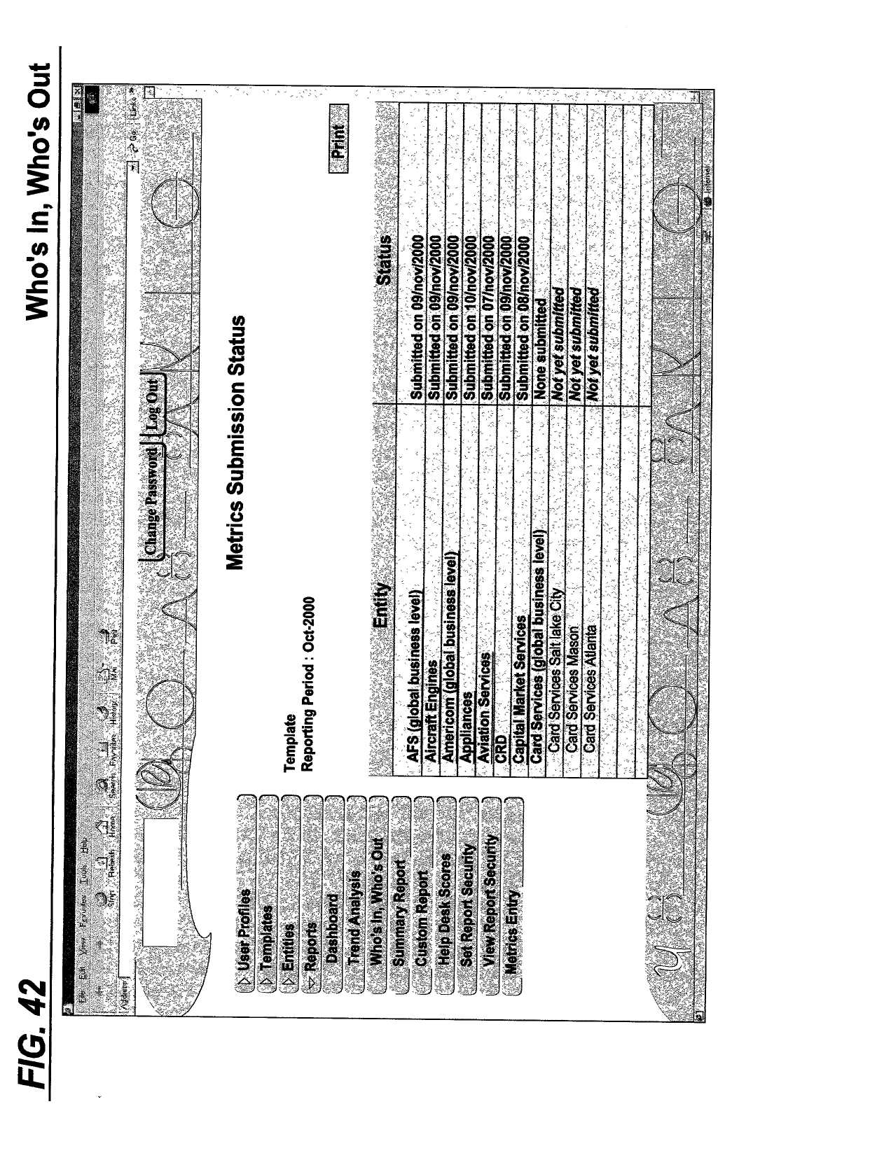

FIG. 42 is similar to FIG. 41 in that illustrative web page user interface package. FIG. 42 provides further identification as to which business entity has submitted business metrics and which business entity has not submitted business metrics. This allows system identification of those business units whom may need additional time to permit entry of their business metrics data or managerial prompting to provide business metrics data.

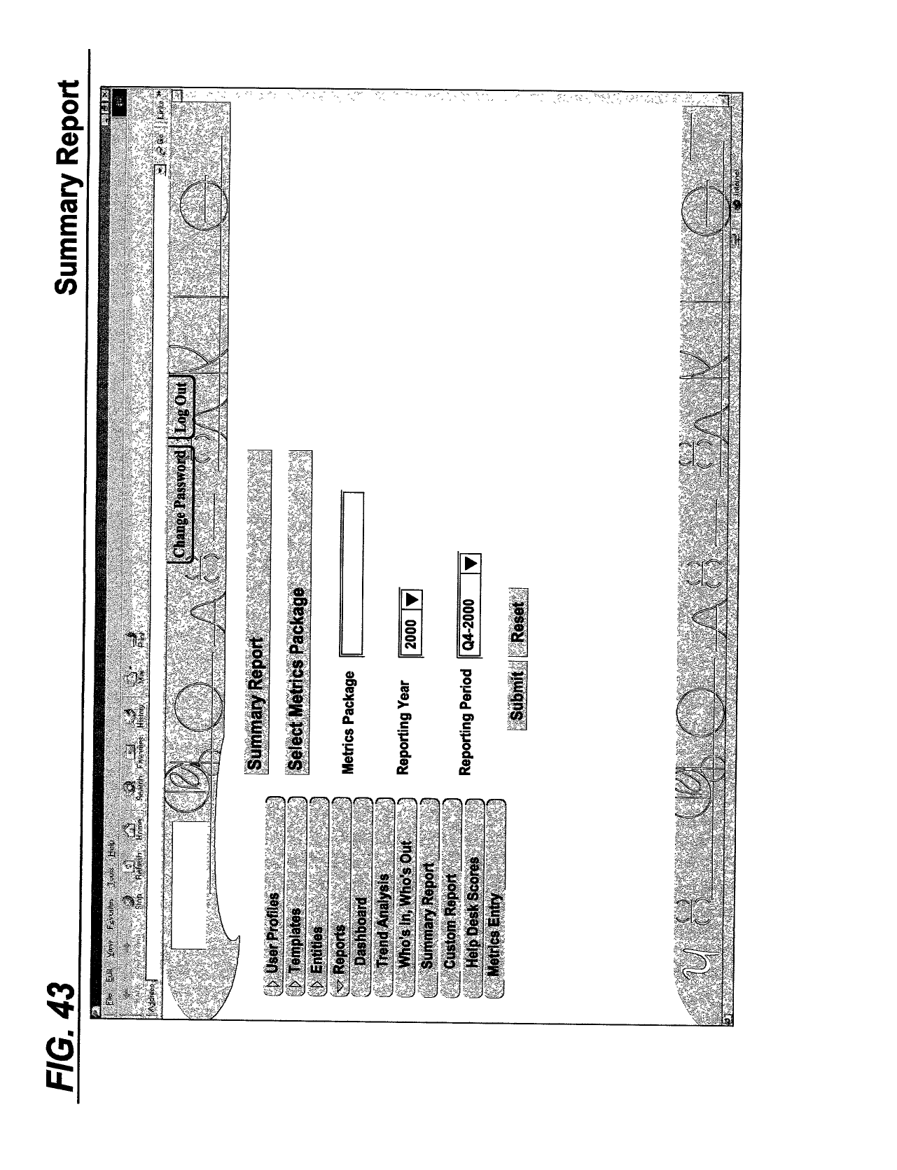

FIG. 43 is an illustrative web page user interface in summary report form. In this user interface, a web base user creates a web page look and/or appearance for a summary report. A user selects the metrics package and reporting period for which the user would like to see in a summary report format. As on other Figures, the user is provided with a submit command and a reset command. The submit command (icon) allows the user to instruct serve 10 to save information on the interface to server 12 with database 16. The reset command allows a user to clear information from the selected fields.

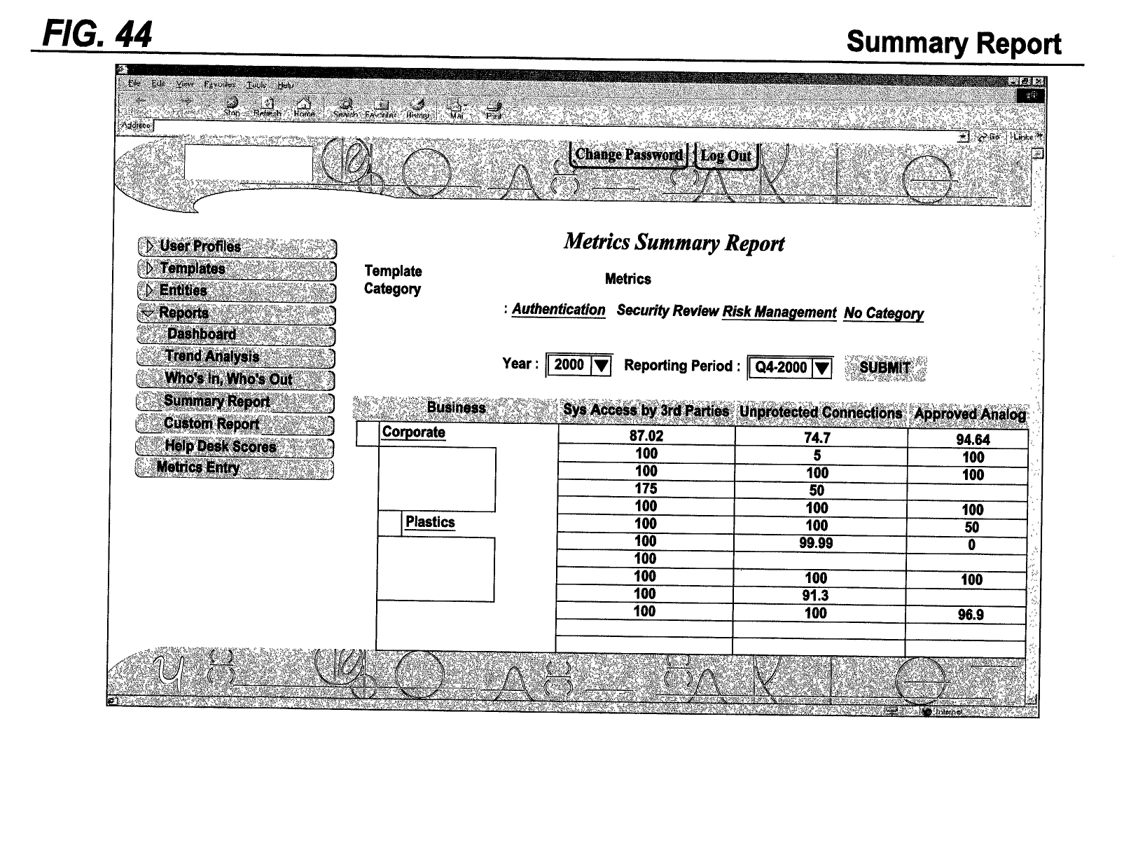

FIG. 44 is an illustrative user interface in Summary Report Form. This interface allows a user to select from template categories such as authenticate, security review, risk management, and no categories as field categories that a user built into the template (which are displayed at the top of this report.) A user may select a specific entity to “drill” down to the actual metrics of that business entity. FIG. 44 shows businesses which are corporate and plastics. Metrics shown are for system access by third parties, unprotected connections and approved analog.

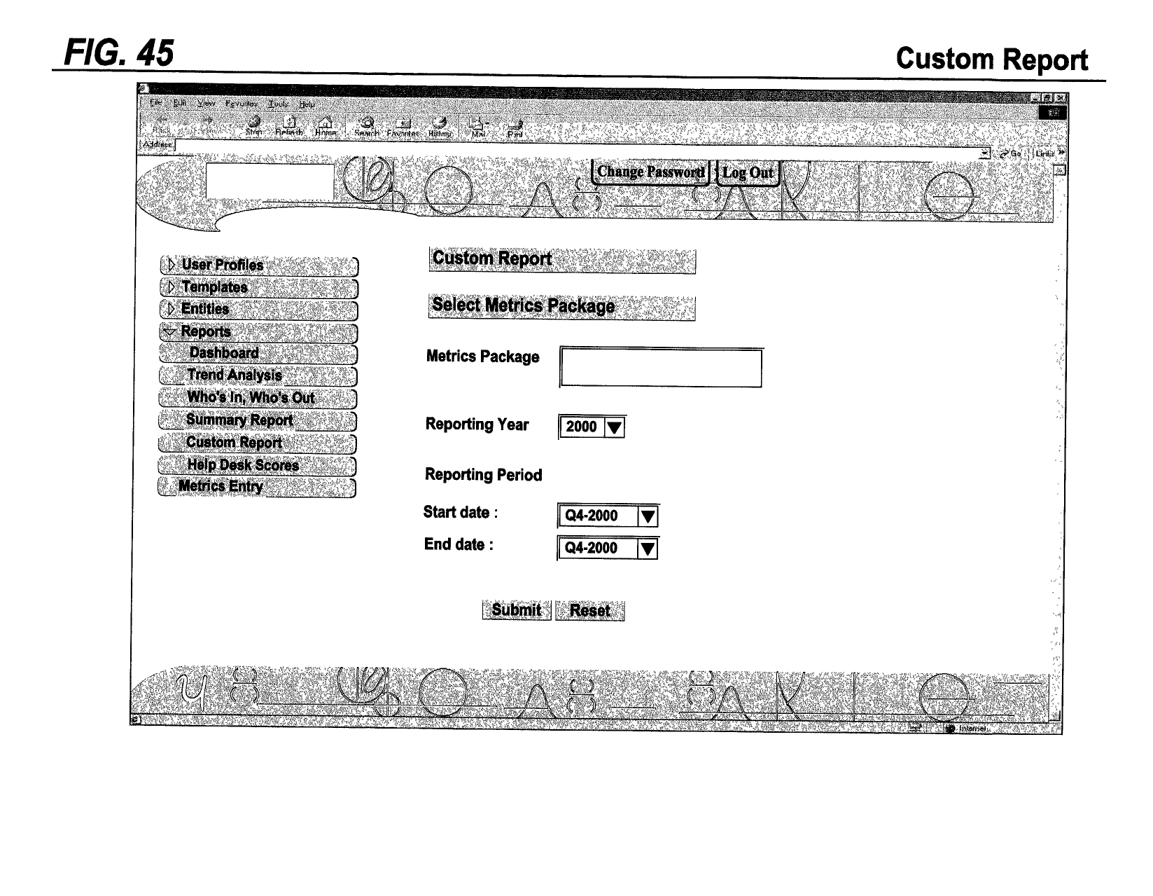

FIG. 45 is an illustrative web interface titled Custom Report. A user may created a custom report by selecting a template, a business metrics package and selects a reporting period that user would like to view in spreadsheet format.

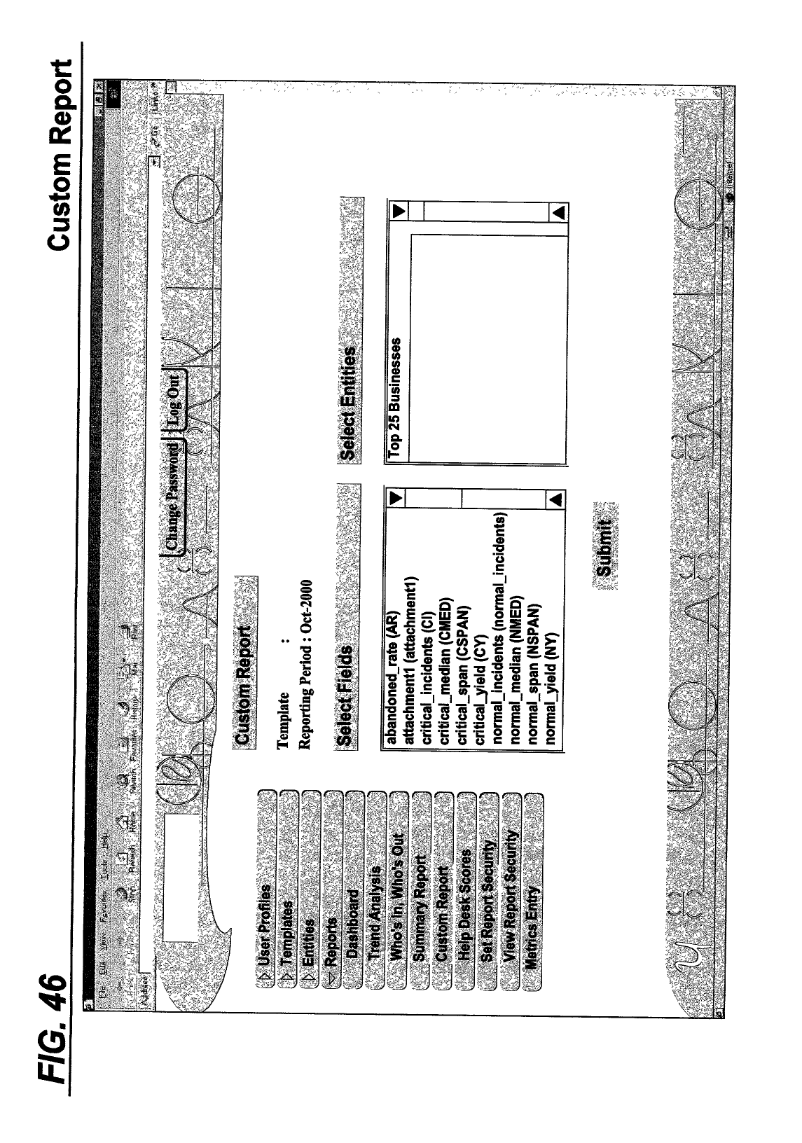

FIG. 46 is an illustrative user web page interface having the title Custom Report format. A user selects the fields that will be visible from a pick list provided under Select Fields and selects entities from illustratively a pick list of top twenty-five businesses.

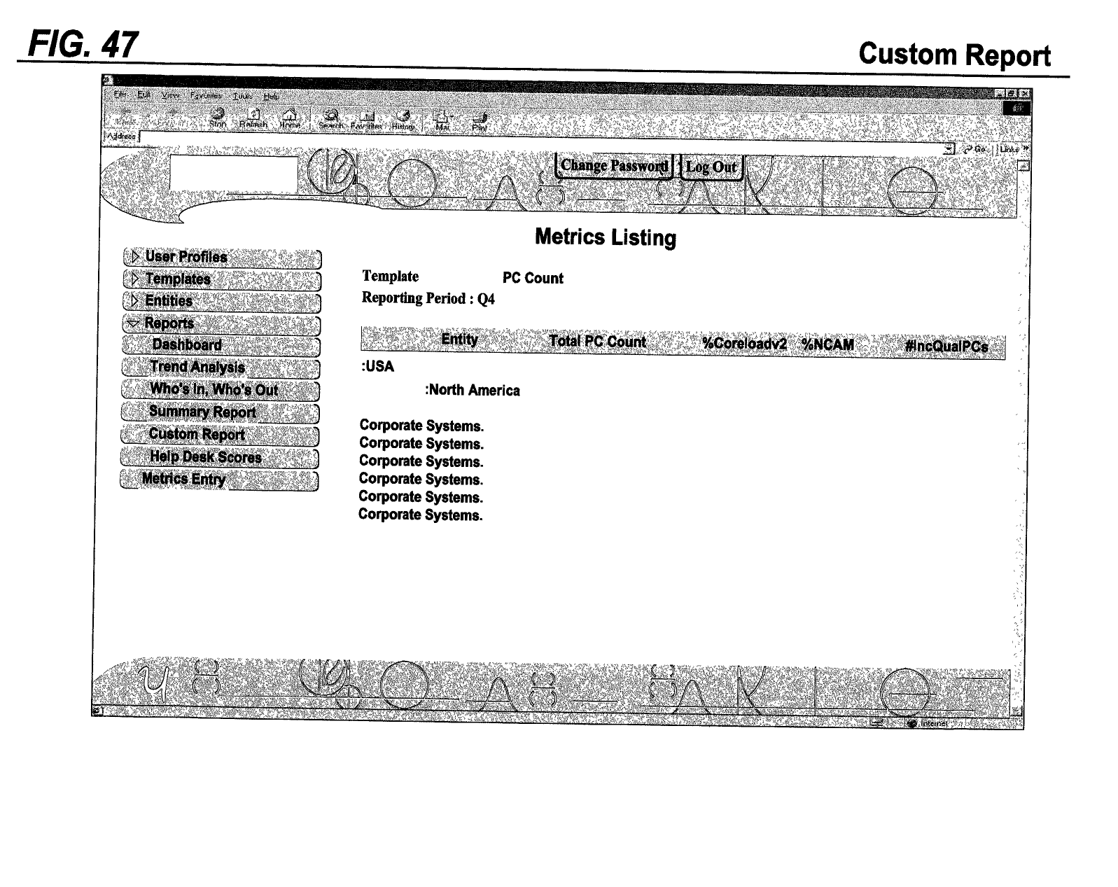

FIG. 47 is an illustrative user web page interface titled Custom Report format. This illustrative table displays raw business metrics data from the business metrics database on server 12. This web page user interface allows the user to select metrics data using a mouse, for example, copy the data and then paste it in appropriate accounting type spreadsheet software for example by using a clipboard feature on computer device 14.

A help desk is used to provide assistance to computer users, particularly to users of computers and computer based networks. Help desk scores are of interest. Many business units which provide help desks are especially interested in how effective the help desk staffing is or has been to users of systems of the business unit. Typically business metric data for a help desk may include response time, number of phone calls taken, length of the phone call and number of repeat phone calls to the help desk.

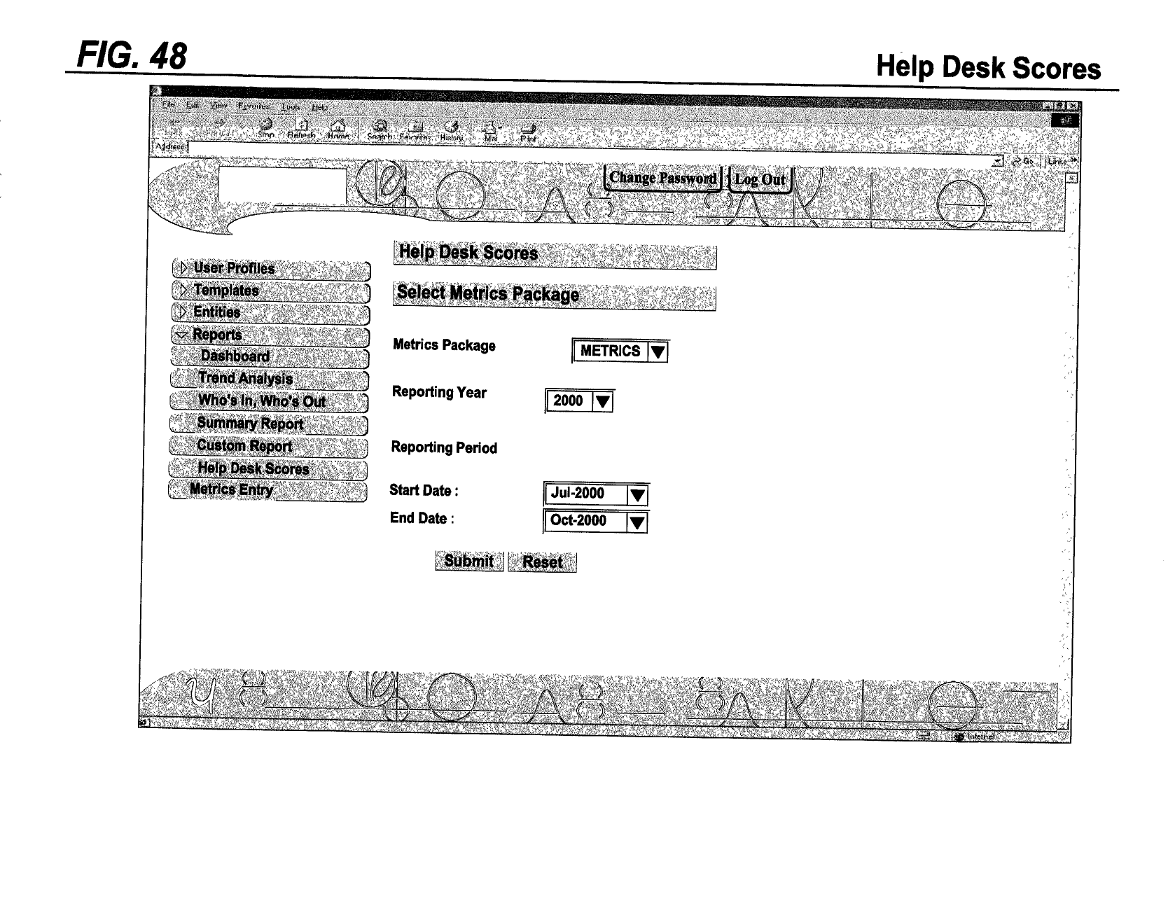

FIG. 48 is an illustrative user web page interface which provides Help Desk Scores. This illustrative user interface is called a Help Desk report. Using user inputted business metrics data, this system and method compiles the inputted data by performing a calculation on the inputted data. User selects a reporting period and the resulting metric is displayed. For example, a statistical analysis is a mathematical computation done on input data.

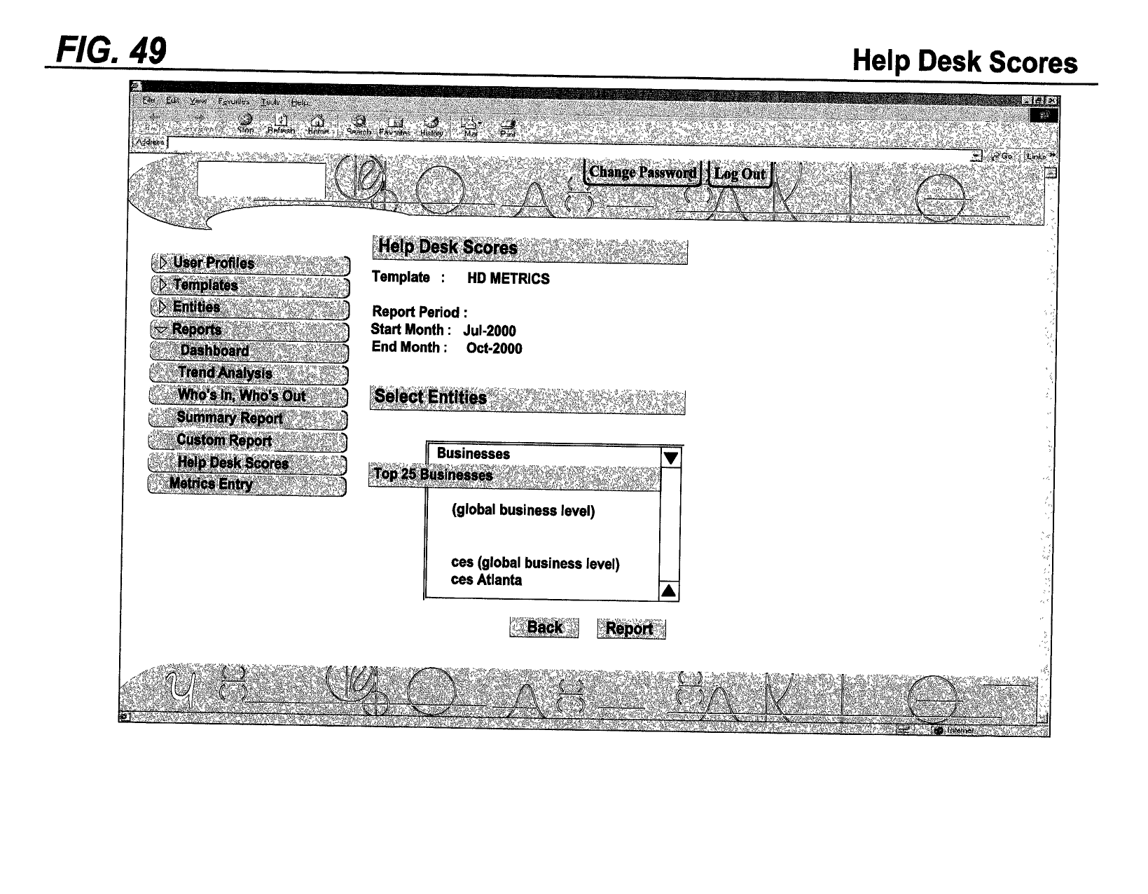

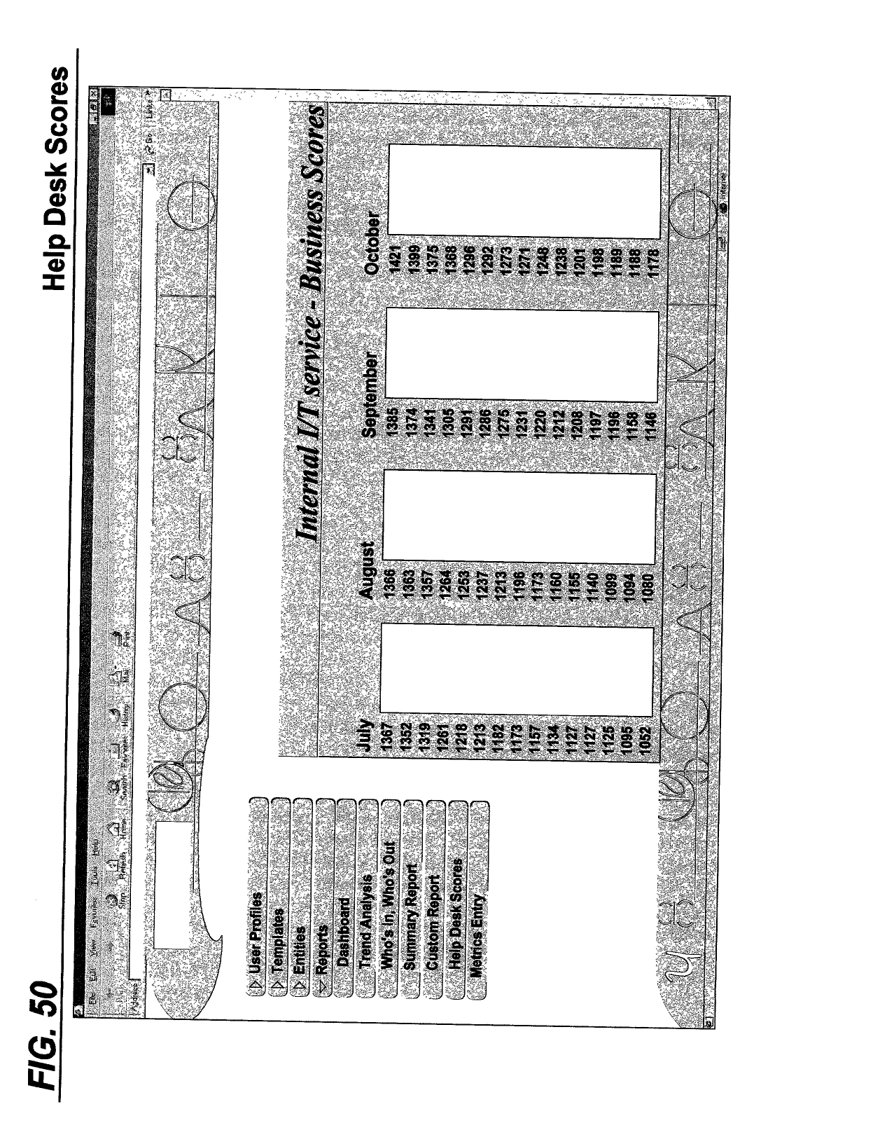

FIGS. 49-50 are is illustrative web page user interface which provides Help Desk Scores. FIG. 50 shows a web page user interface which provides Help Desk Scores by month for internal I/T (information technology) service which are shown as business scores.

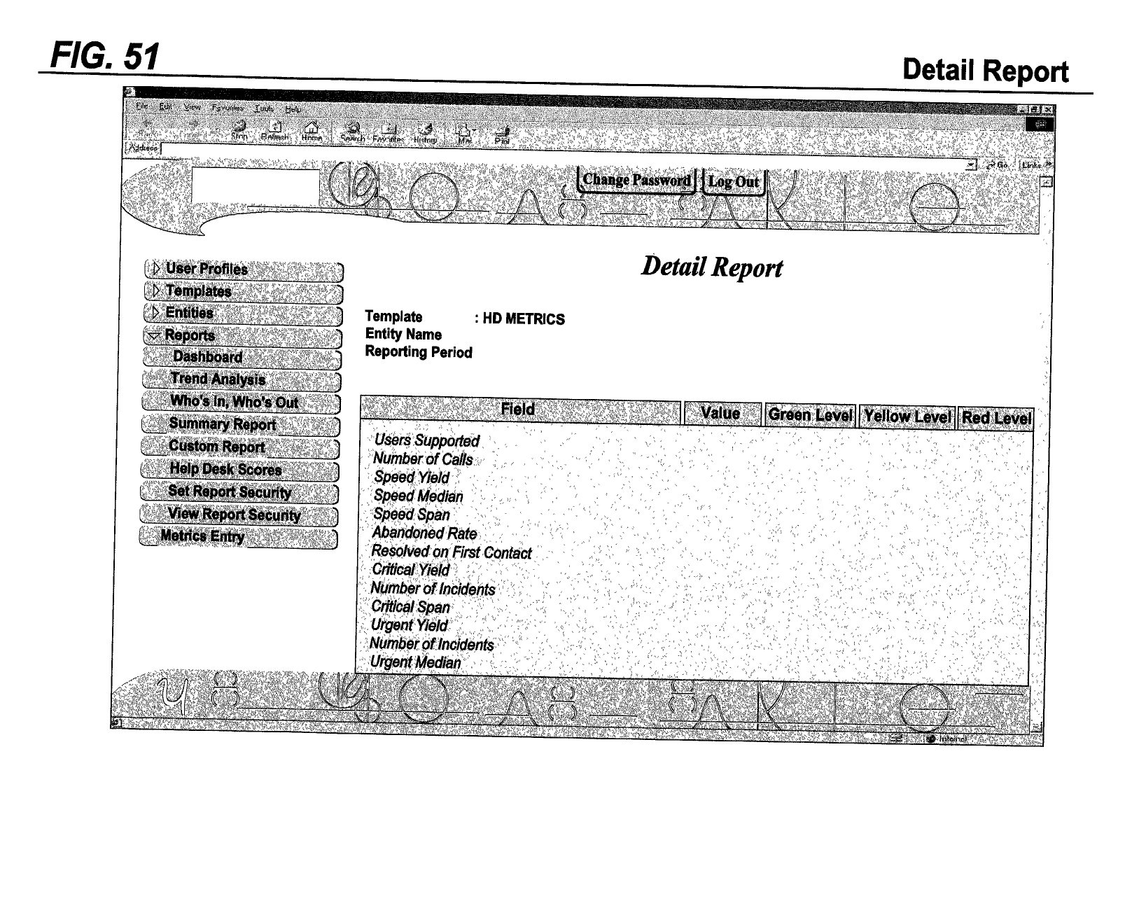

FIG. 51 is an illustrative web page user interface which shows an illustrative detail report. This illustrative detail report is for a template named HD Metrics and provides metrics for users supported, number of calls, speed yield, speed median, speed span, abandoned rate, resolved on first contact, critical yield, number of incidents, critical median, critical span, urgent yield, number of incidents, urgent median and urgent span.

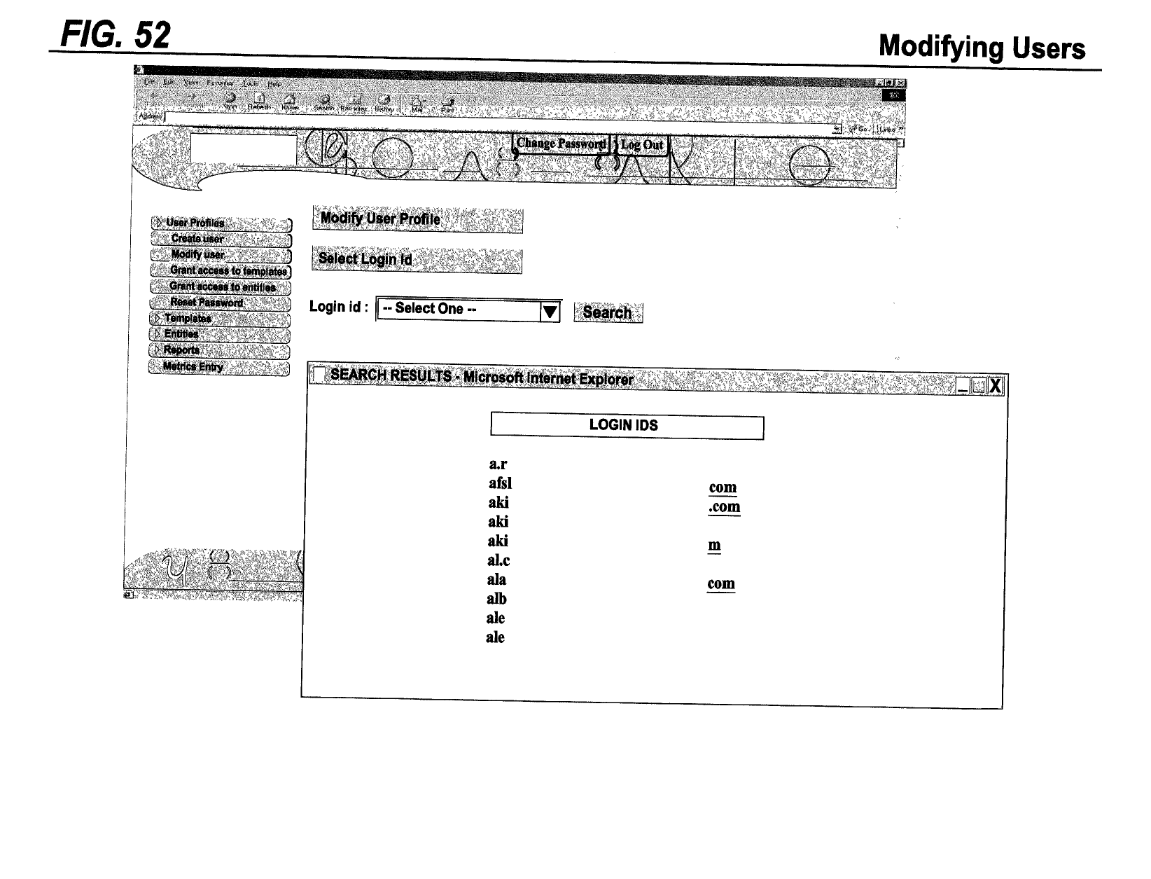

FIG. 52 is an illustrative web page which shows that users may be modified. Illustratively logins are employed to identify various users of system 10.

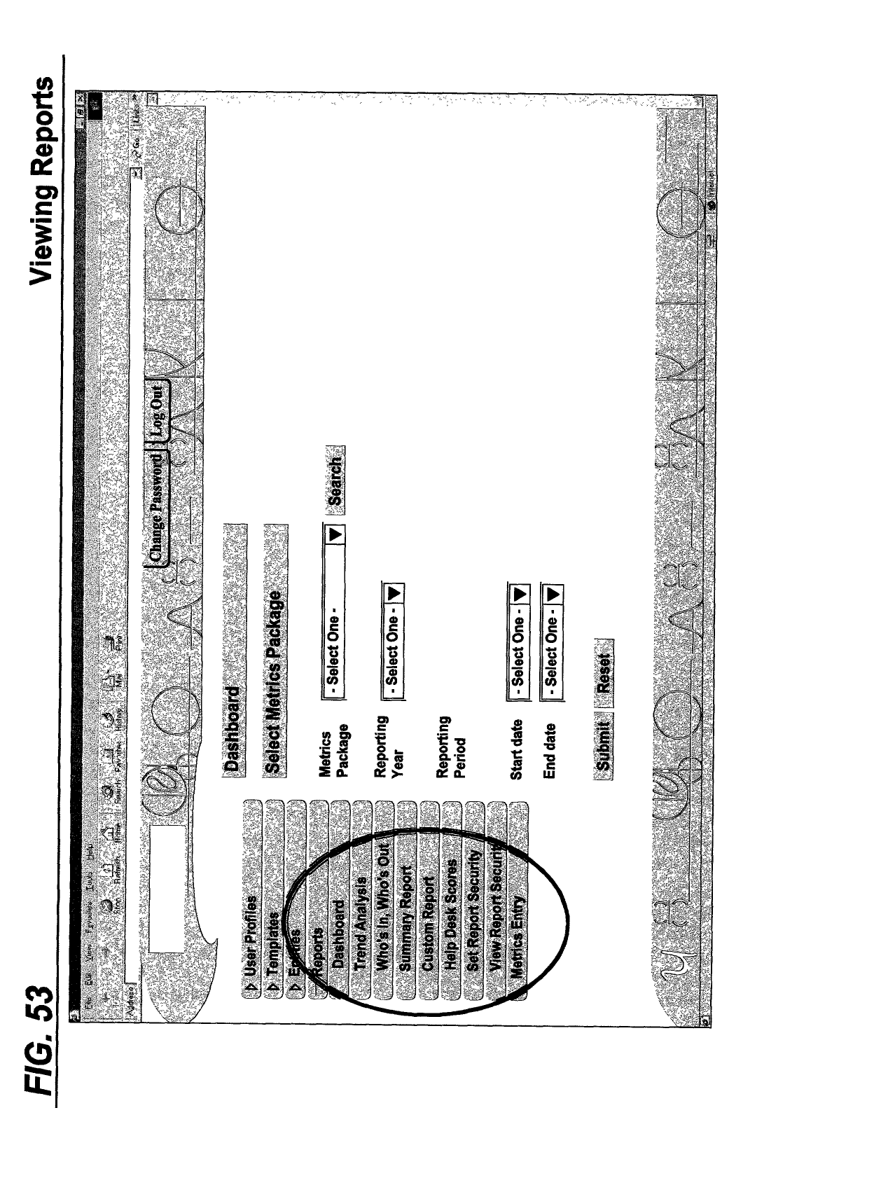

FIG. 53 is an illustrative web page interface which illustrates viewing of a report. Pull down menu 32 provides a series of major individual tabs. Tabs are also provided as to dashboard, trend analysis, Who's in Who's out, summary report, custom report, help desk scores, set report security, view report security. Tabs having to do with set report security and view report security are set up according to the choices of the system administrator, group administrator or users.

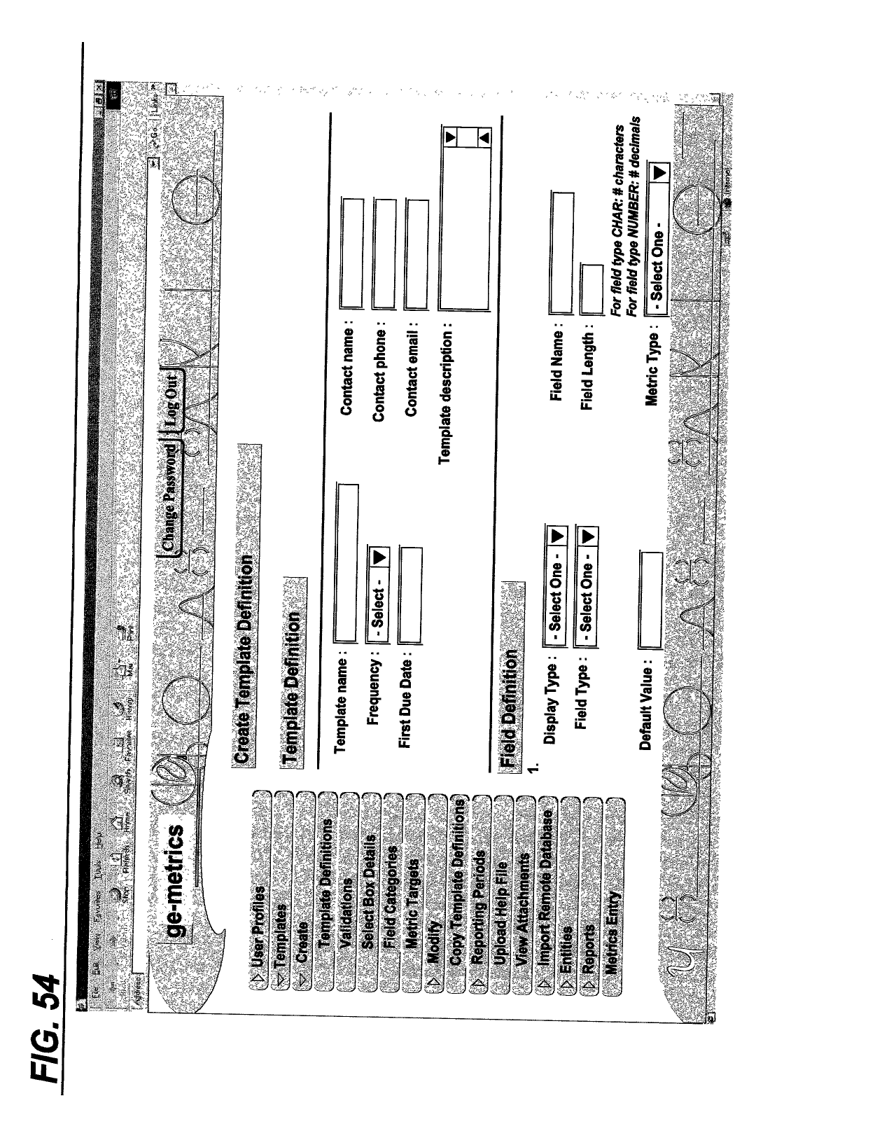

FIG. 54 is an illustrative web page relating to the Example herein which illustrates definition of a template.

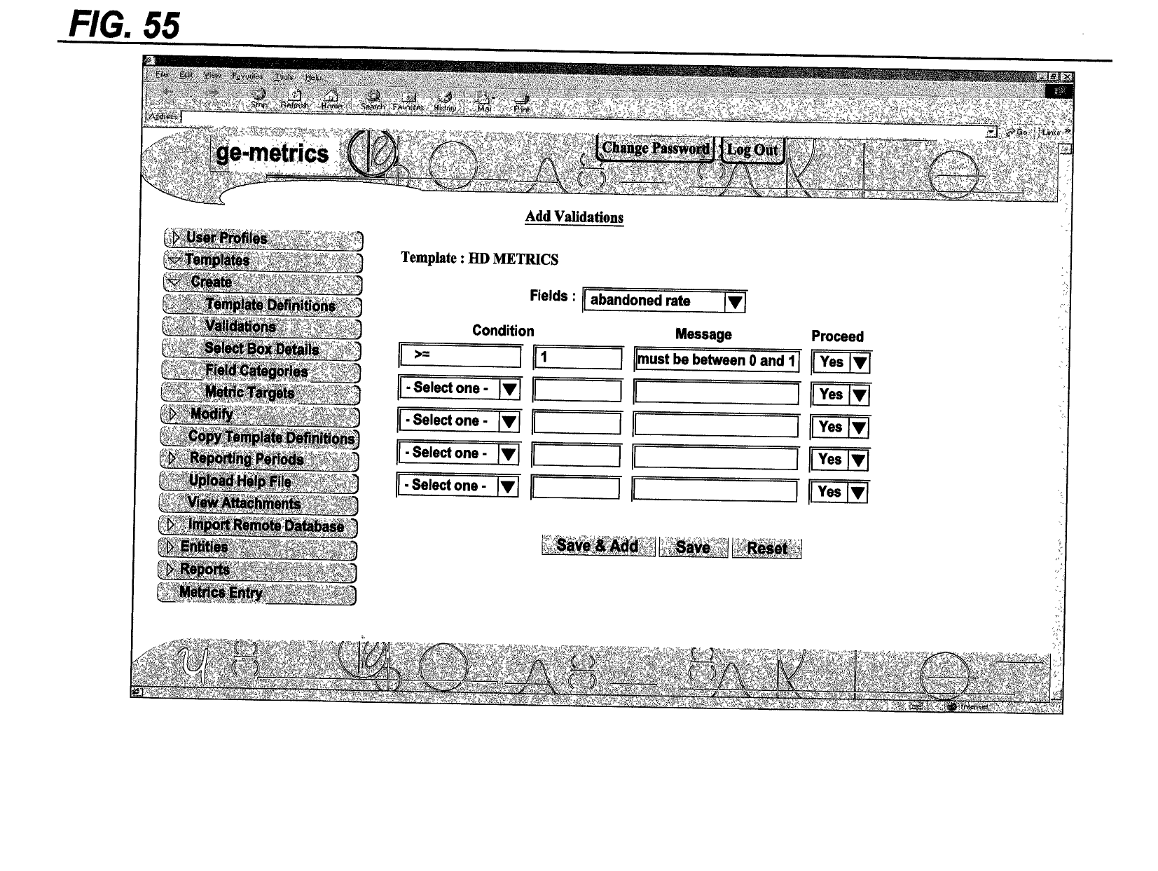

FIG. 55 is an illustrative web page relating to the Example herein which illustrates defining validations.

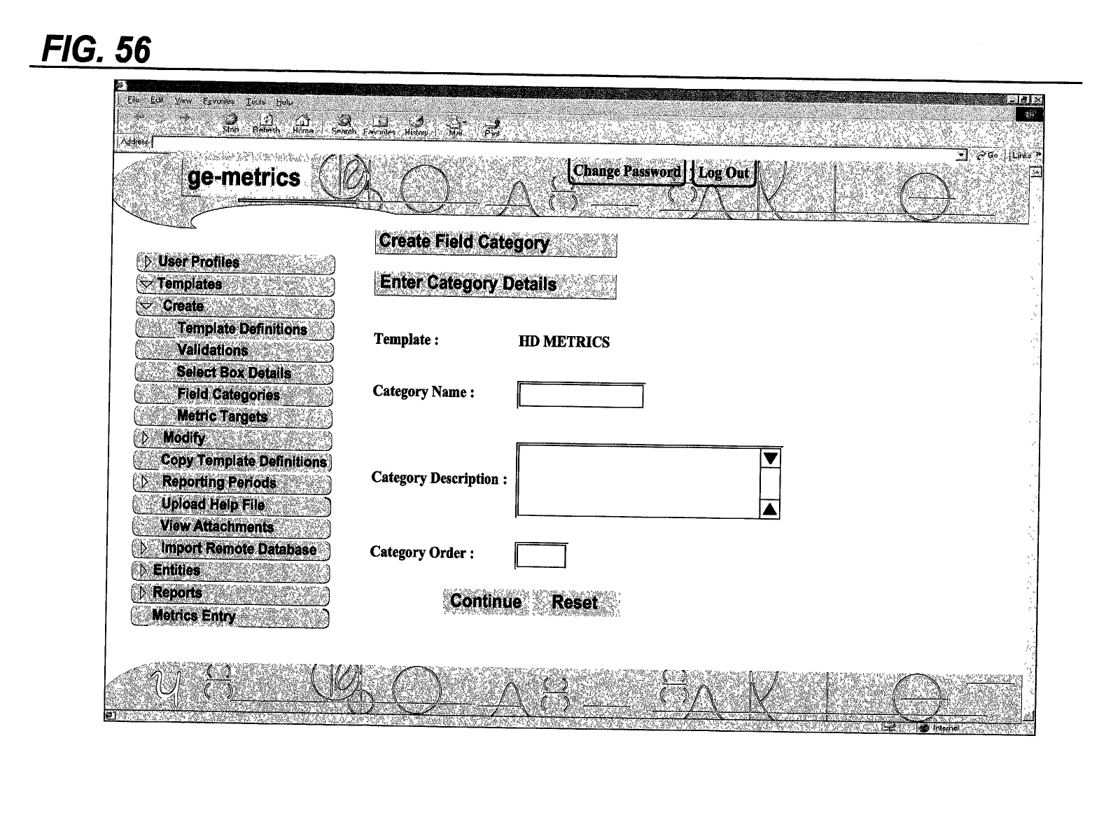

FIG. 56 is an illustrative web pages relating to the Example herein which illustrates field categories.

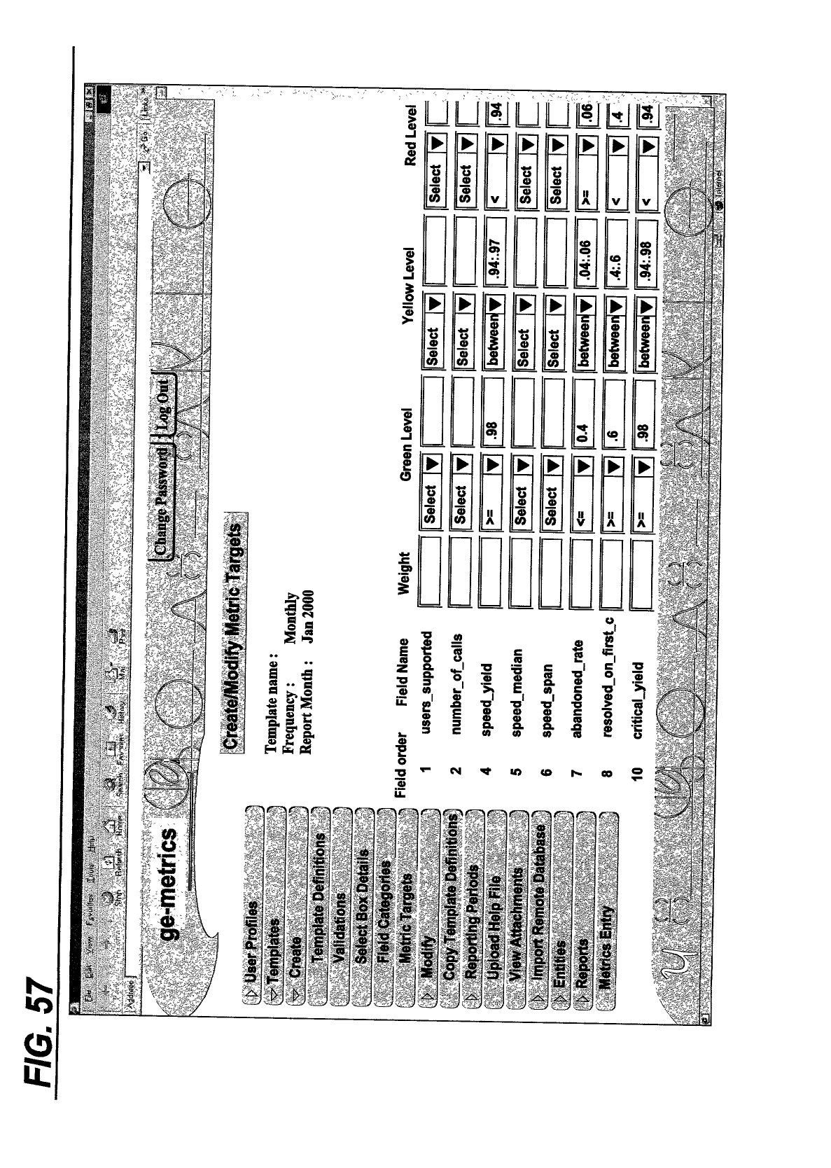

FIG. 57 is an illustrative web page relating to the Example herein which illustrates defining metric targets.

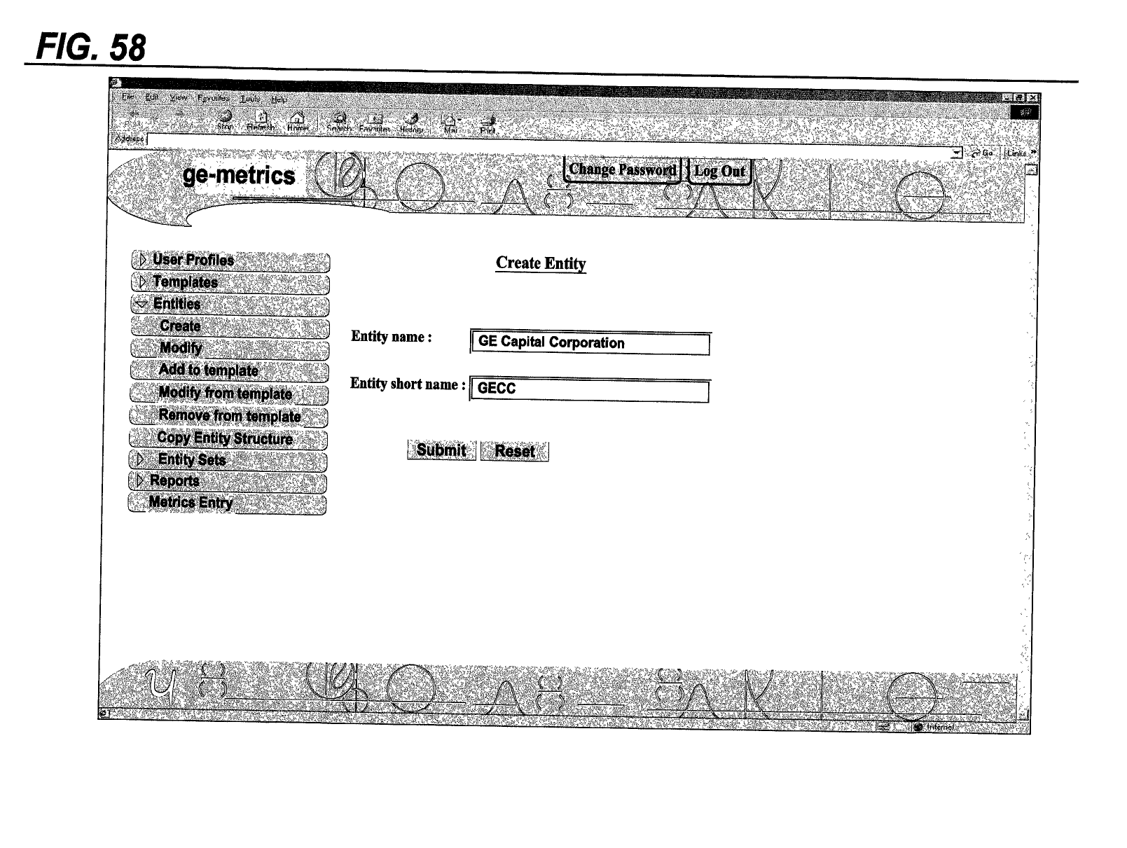

FIG. 58 is an illustrative web page relating to the Example herein which illustrates creating and adding entities.

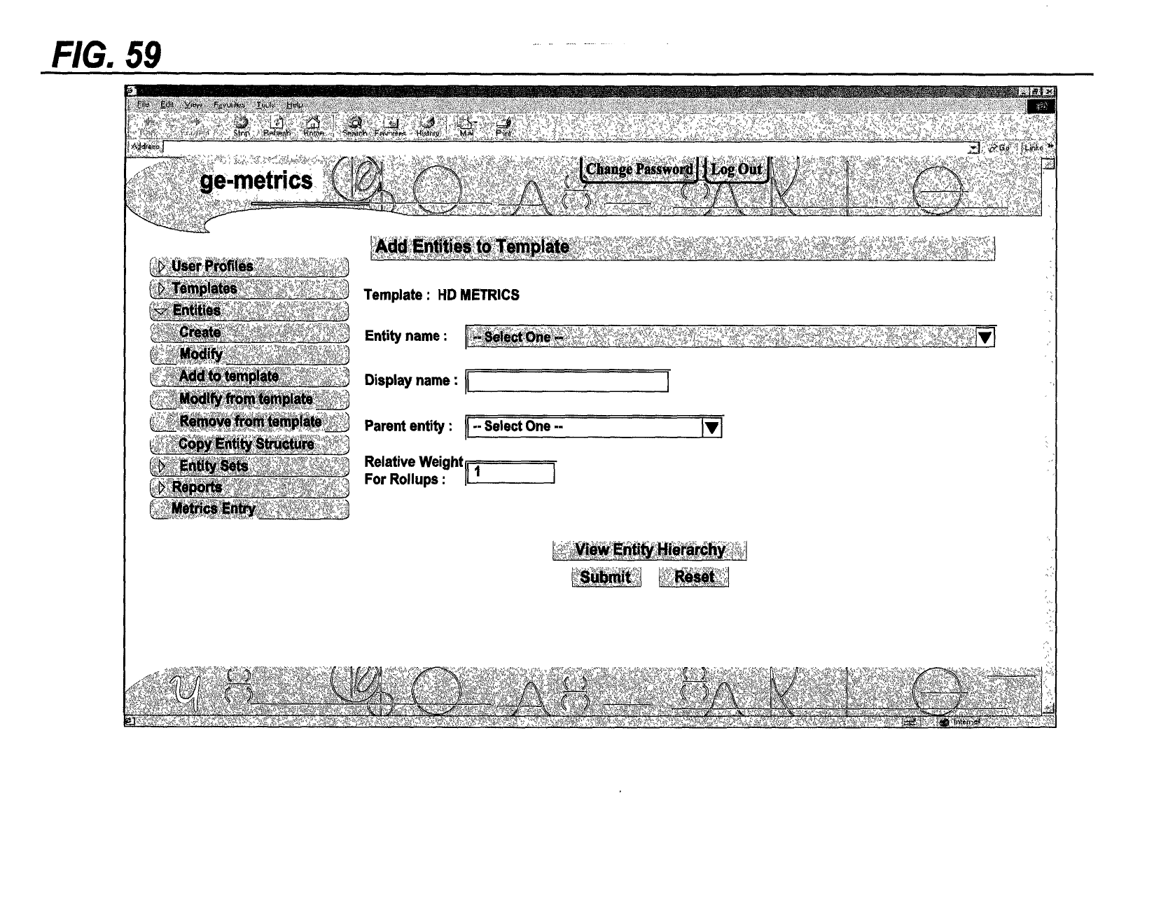

FIG. 59 is an illustrative web page relating to the Example herein which illustrates adding entities to a template.

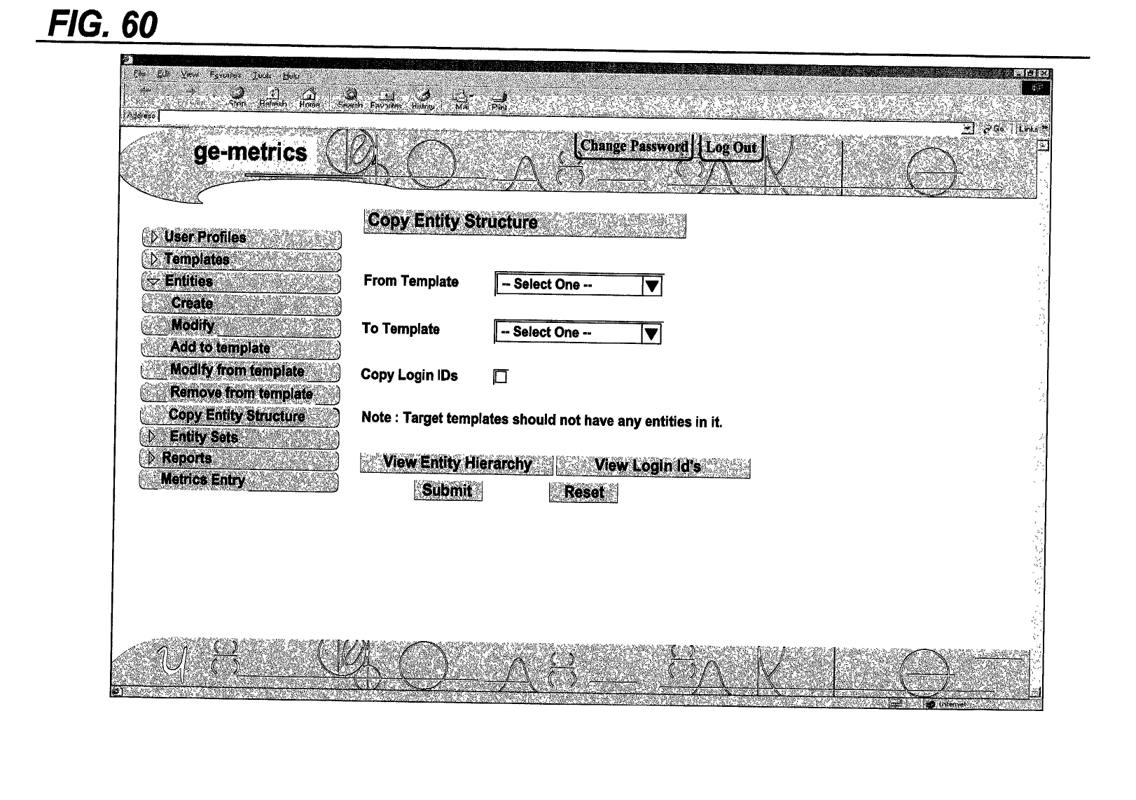

FIG. 60 is an illustrative web page relating to the Example herein which illustrates coping an entity structure.

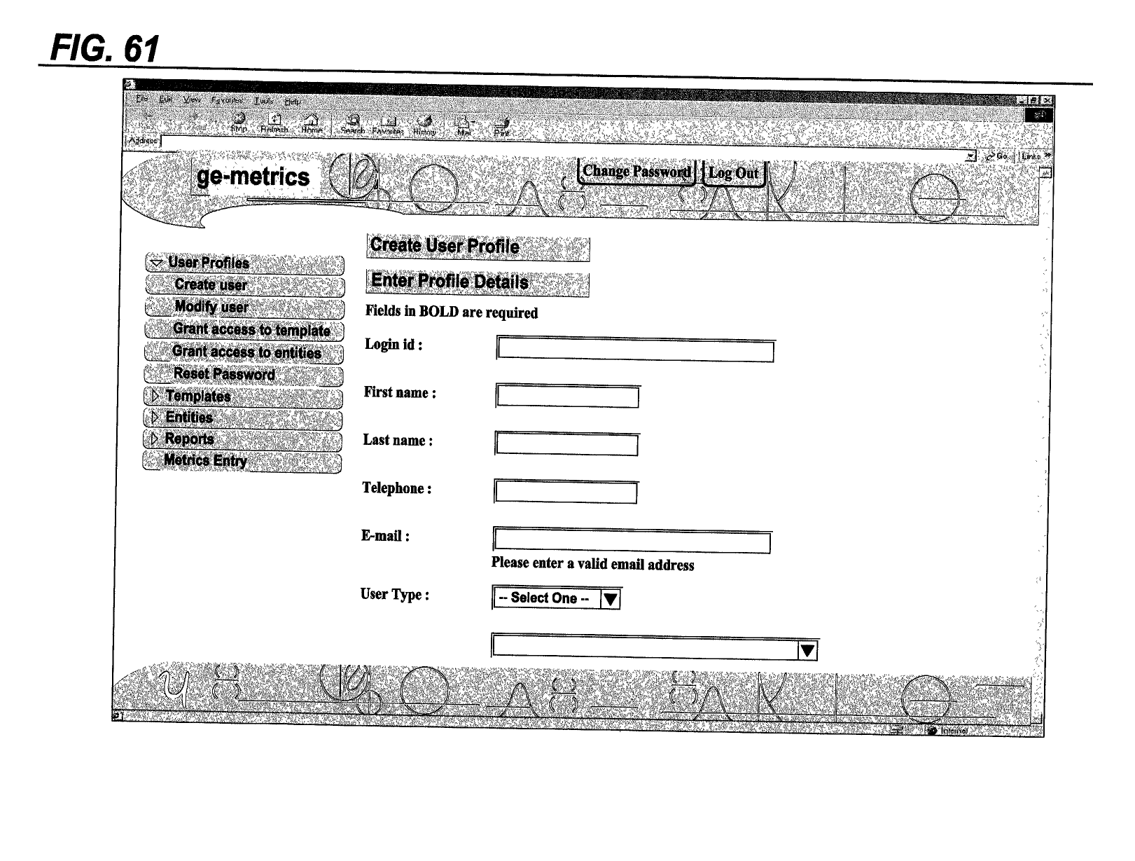

FIG. 61 is an illustrative web page relating to the Example herein which illustrates creating user profiles and creating users.

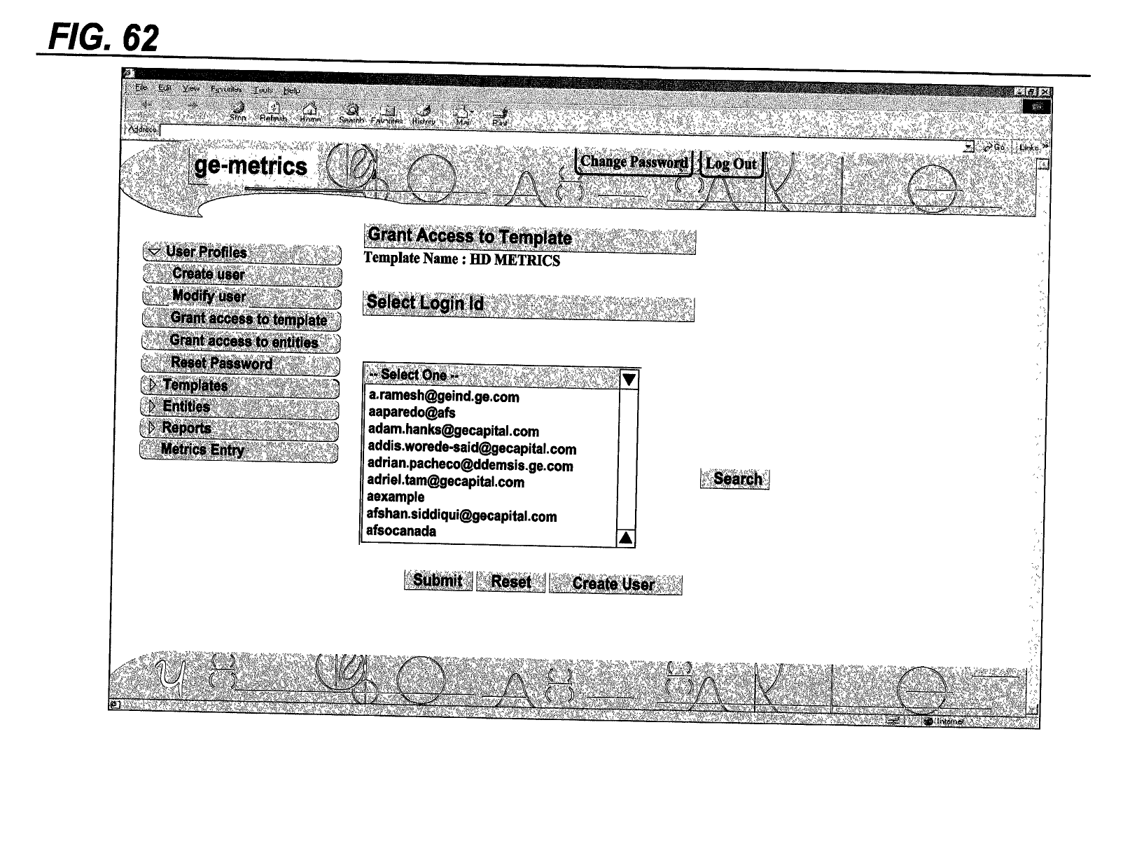

FIG. 62 is an illustrative web page relating to the Example herein which illustrates granting access to templates.

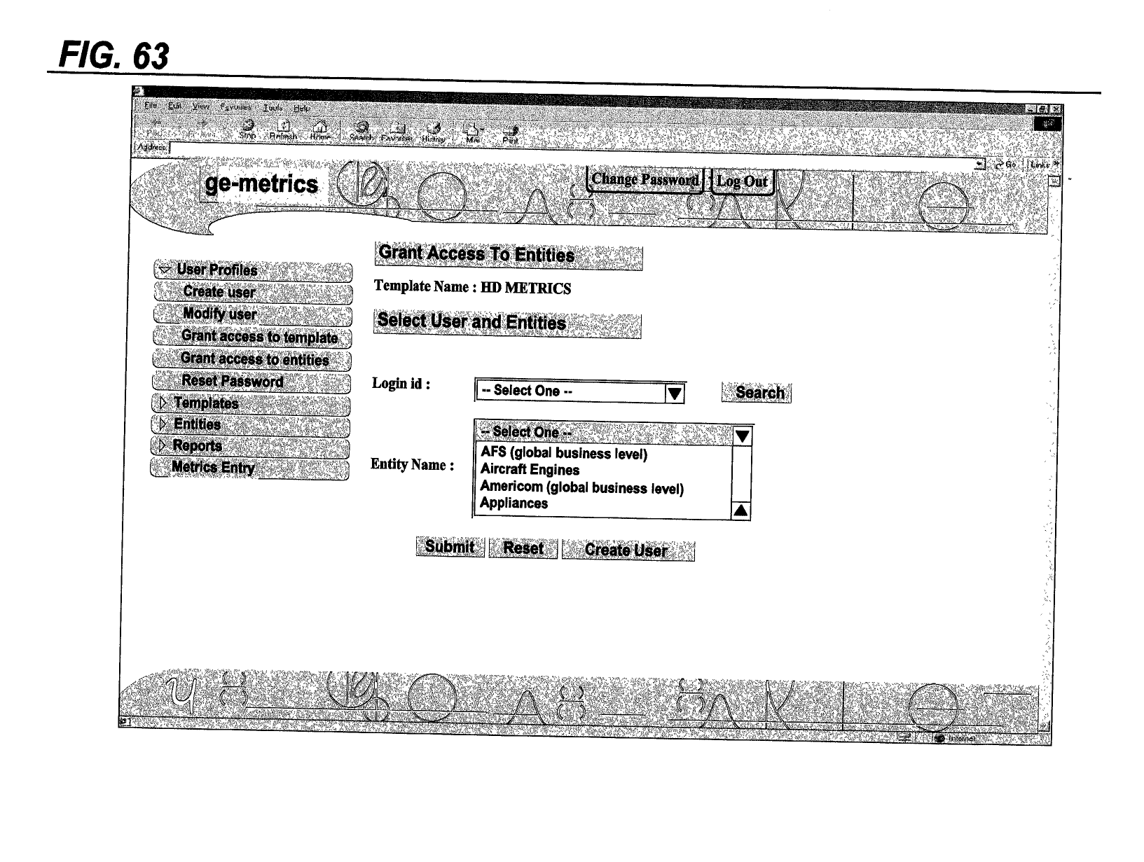

FIG. 63 is an illustrative web page relating to the Example herein which illustrates granting access to entities.

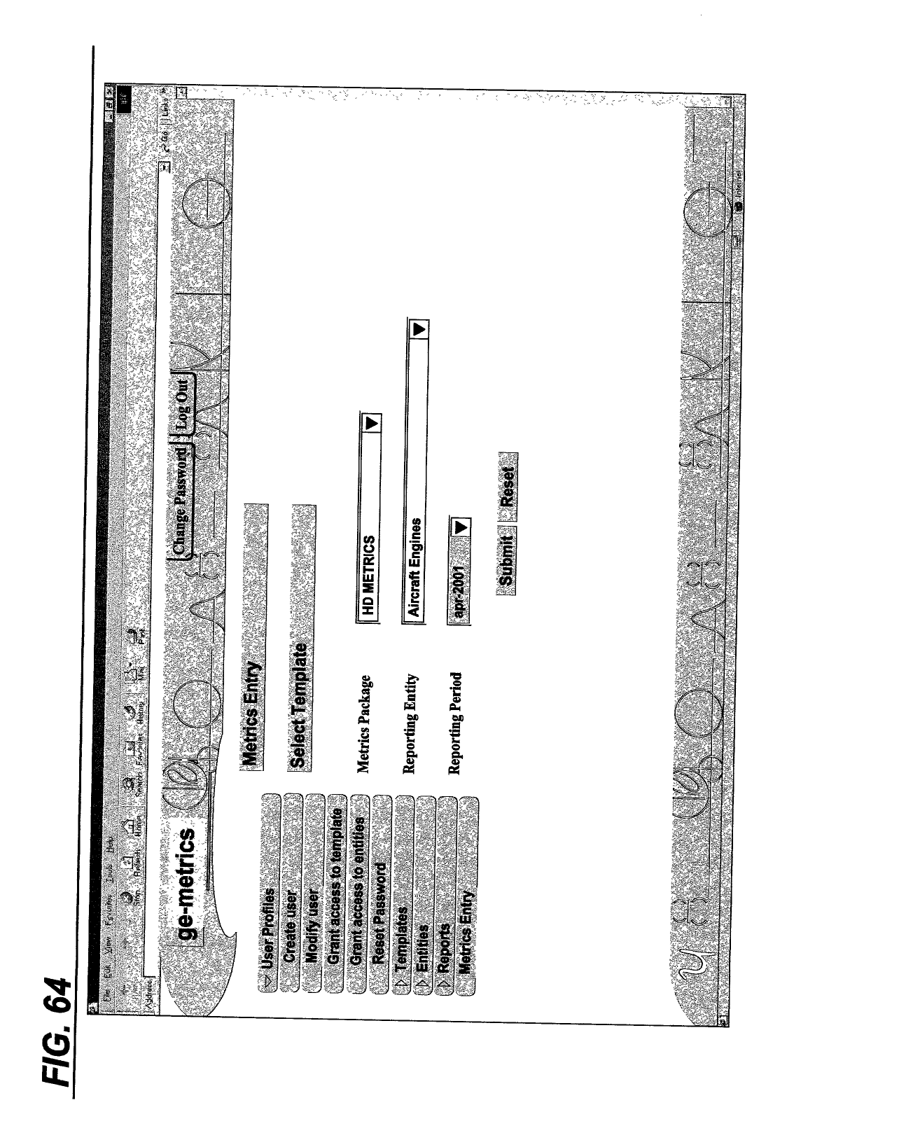

FIG. 64 is an illustrative web page relating to the Example herein which illustrates business metrics entry.

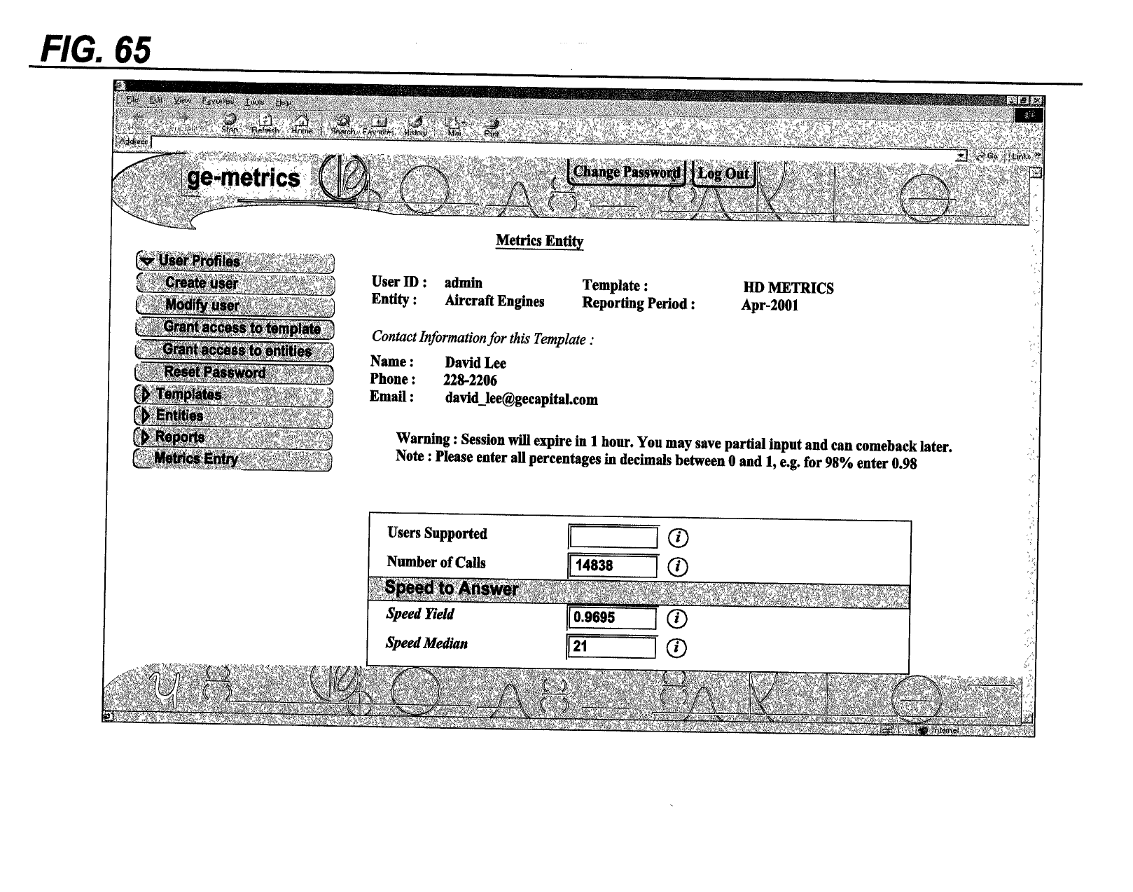

FIG. 65 is an illustrative web page relating to the Example herein which illustrates metric entry for a user ID of administration, a template HD Metrics, an entity of a corporation's Aircraft Engines business unit and a reporting period of April 2001.

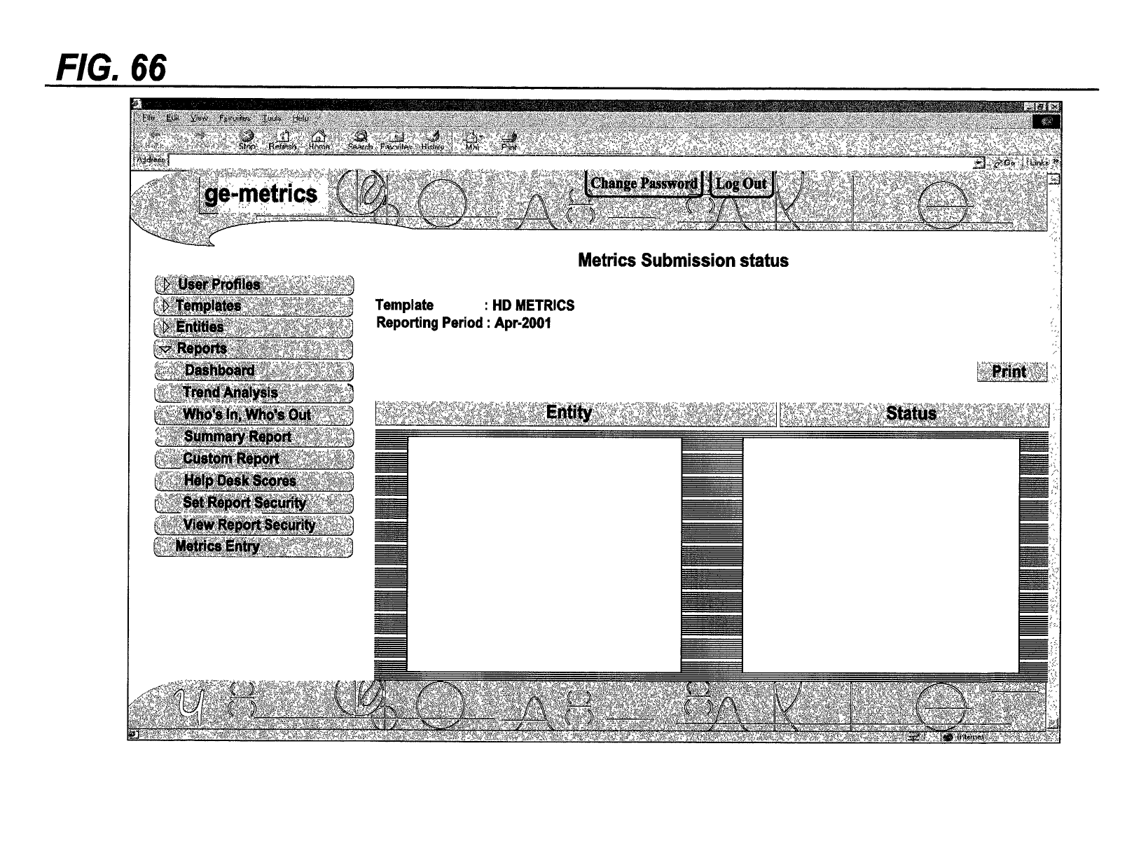

FIG. 66 is an illustrative web page relating to the Example shows Who's in Who's out for a template Help Desk Metrics and provides a metrics submission status.

FIG. 67 is an illustrative web page, a dashboard, for a business unit which lists business entities with each selected metric in the form of red, yellow and green traffic lights.

The invention is further described in the following Example which is not intended to limit or restrict the invention in any way.

### EXAMPLE

A corporate business group can collect business metrics data from various help desks of various corporate businesses around the world, can analyze the collected business metrics and can produce reports which helped in the business decision making process. The various businesses can have business parent business subsidiary corporate structures.

This corporate business group can:

Collect data from globally dispersed locations into a single database,

Automatically roll up numbers based on previously setup business entity hierarchy

Allow users to create their own data entry templates

Instantly view the reports on status of entry and entered data and

Allow access to the application to be independent of the web browser used.

A series of administrative steps can be taken by the Corporate Help Desk administrator to create and deploy a template to collect business metrics from users across a corporation. Prior to invoking the business metrics tool through a browser, the user can plan, collect and compile information:

Metrics which can be collected:

Users Supported

Number of Calls

Speed to Answer

Speed Yield

Speed Median

Speed Span

Resolved on First contact

Break/Fix & Deskside Support Critical

Number of Incidents

Critical Median

Critical Span

Break/Fix & Deskside Support Urgent

Number of Incidents

Critical Median

Critical Span

Break/Fix & Deskside Support Urgent

Urgent Yield

Number of Incidents

Urgent Span

Break/Fix & Deskside Support Normal

Normal Yield

Number of Incidents

Normal Median

Normal Span

Break/Fix & Deskside Support Special

Number of Incidents

Notes

Abandoned Rate

Critical Yield

Urgent Median

Attach Status Report

Business/entities from which metrics can be collected from business groups around the world.

The work group can note the hierarchical relationship among the businesses/entities.

An administrator can compile the business parent business subsidiary relationships among the business entities. Some of the businesses and the business relationships which can be noted include:

Card Services (global business level)

Card Services Salt Lake City, Utah, USA

Card Services Mason, Ohio, USA

Card Services Atlanta, Ga., USA

Card Services, Stamford, Conn., USA

Card Services iProcess—District of Columbia, USA

Commercial Direct

Commercial Equipment Financing

Commercial Finance

Fleet Services

Fleet Global—Fleet Services—PIT Project

Fleet North America

Fleet Europe

Fleet Japan

Fleet Australia

Business Unit Financial Assurance

Business Unit Insurance Holdings

Business Unit for Computer Supported Sites

If were to be compiled, the user could request the master administrator to grant that user access to the system. The Master Administrator can create a user id (identification) and can grant associated template privileges. The user can be an authorized template administrator.

The template administrator can execute a series of functions through various screens of the invention.

The template administrator can create a new template from a form which can be supplied by the system. Screens can be defined having metric fields, including validations, field categories and targets for metrics as will be explained more in detail hereinafter.

11. Define Template

The administrator can specify the template name, frequency of data collection, contact details of the template owner and obtain definition of metric fields. For each metric field several attributes can be specified. These attributes can include field name, field type, field length, rollup method etc. FIG. 54 provides an exemplary view of this function.

1.2 Define Validations

Specific validations can be set up for metric fields defined in the aforegoing paragraph. For example, upper and lower parameters can be selected as a range for some metric data. Data which was outside this range can be rejected by the system following this validation and thus the user can be prevented from entering certain data values into a field. FIG. 55 provides an exemplary view of this function.

1.3 Define Field Categories

The user can be create calculations based on a collection of metric fields. This screen can allow a user to create field groups and include fields into them. FIG. 56 provides an exemplary view of this exemplary function.

1.4 Define Metric Targets

The user can define the ranges and limits for red, yellow, and green targets for required business metrics on this screen. These target numbers canl determine the performance levels of a business which reports that corresponding metric. Based on these limits, dashboard report can display red, yellow and green traffic lights. FIG. 57 provides an exemplary view of this function.

2. Create/Add Entities

This function can allow the administrator to create new business entities and add already available entities to his/her template. It is possible to copy complete entity structure from another template using one of the options under this function.

2.1 Create Entity

The user can add new entities to the collection of available entities. FIG. 58 provides an exemplary view of this function.

2.2 Add Entities to Template

This function can allow a user to attach selected entities to a template from a collection of entities. FIG. 59 provides an exemplary view of this function.

2.3 Copy Entity Structure

This function can allow a user to copy entire entity structure from one template to another template. By doing this, the user can eliminate the repetitive entry. FIG. 60 provides an exemplary view of this function.

3. User Profiles

This function can allow the administrator to create user profiles and grant user access to various templates and entities. This functionality can be further divided into different exemplary screens as follows.

3.1 Create User

This function can allow the administrator to create new user profiles. There can be three types of user privileges in this system:

Template Administrator—This can be an administrator who can create a template and in turn can create other two types of users:

Group Administrator—This can be an administrator who can create sub entities and create a normal user.

Normal User—This can be a person who can have system access privileges and can enter data into templates and view reports.

FIG. 61 provides an illustrative view of this function.

3.2 Grant Access to Templates

Using this function the administrator can grant access rights to a user on a template. FIG. 62 provides an illustrative view of this function.

3.3 Grant Access to Entities

This function can allow the administrator to grant a user access rights to the entities. FIG. 63 provides an illustrative view of this function.

3.4 Metrics Entry

This function can allow a user to enter metrics data into templates. FIGS. 64 and 65 provide an illustrative view of this function.

5. Reports

This function can allow a user to view various canned (premade) reports and listings. Some reports are explained below.

5.1 Who's in, Who's out

This report can list all entities who can fill in a template for a given period. The report can display the status of data entry for each entity. The report can list the entities in hierarchical manner and can carry the business subsidiary's entry status to the business parent and so on. For example, if an entity does not enter data for the selected period, then the status of the business parent can be marked incomplete. FIG. 66 illustrates this function.

5.2 Dashboard

This exemplary report lists various entities and their performance with each selected metric in the form of red, yellow and green traffic lights. FIG. 67 illustrates this function.

While the invention has been described in terms of various specific embodiments, those skilled in the art will recognize that the invention can be practiced with modification within the spirit and scope of the claims.

What is claimed is:

1. A method for management of business metrics using a system including a server and at least one user accessible device communicative with the server, the server having a database and a web interface, said method comprising providing user with a web interface configurable to a template accommodating business metrics data by the user.

2. The method according to claim 1 wherein the web page interface is a hypertext markup language interface and the method further comprises creating a template from the web interface which accepts business metrics data..

3. The method according to claim 2 wherein the method comprises creating a field for entry of one or more business metrics definitions in a template and uploading the template into the database.

4. The method according to claim 3 wherein the method comprises entering a textual definition into one of the business metrics definitions.

5. The method according to claim 4 wherein the method comprises selecting and creating a validation for a user selected field of a template.

6. The method according to claim 4 wherein the method comprises adding a select box feature to a field of a template.

7. The method according to claim 6 wherein the method comprises electronically linking a metric target with a field of a template.

8. The method according to claim 7 wherein the method comprises linking a parameter selected from a level and a weight to one or more of the fields of a template.

9. The method according to claim 8 wherein the method comprises creating a field category for a template.

10. The method according to claim 9 wherein the method comprises changing a field of said template.

11. The method according to claim 9 wherein the method comprises modifying one of the field definitions of a template.

12. The method according to claim 9 wherein the method comprises modifying a template by changing the order of appearance of the fields.

13. The method according to claim 1 wherein the method comprises modifying a template by adding one or more entities to a template.

14. A business metrics management system comprising:
a computer;
a server configured with a database enabled for storing and retrieving a web page interface, said server further configured to upload and store user input regarding business metrics in a database;
a network communicative with the server and a user operated device connected to the network.

15. The system according to claim 17 which comprises a server which is configured to upload and store a template comprising business metric data.

16. The system according to claim 18 which comprises a database having templates having data fields which accept business metrics data.

17. The system according to claim 19 wherein the template has a data field containing business metric data.

18. The system according to claim 19 wherein the templates have validations for one or more data fields.

19. A method for providing business management with business metrics, said method comprising:
creating a business metric template which can accommodate business metrics data;
entering business metrics data into the template;
uploading the template into a database having enabled storage and retrieval capability for a business metric template
providing the business metric template to business management.

20. The method according to claim 24 wherein the template is r configured to accommodate business metric data comprising fields of user metric data.

21. The method according to claim 27 wherein the fields of user data comprise user selected business metrics.

22. The method according to claim 28 wherein a manager reviews a template and provides business instruction to a business unit associated with the template.

23. The method according to claim 30 wherein a user creates field categories for a template.

24. The method according to claim 30 wherein a user modifies a template by changing a field of a template.

25. The method according to claim 30 wherein a user modifies said template by modifying one of the field definitions of a template.

26. An apparatus comprising:
a computer;
a server configured with a database enabled for storing and retrieving a template, the server additionally configured to upload and store business metrics data in a database;
a network communicative with the server and a user device connected to the network.

27. An apparatus in accordance with claim 26 which comprises a server providing a hypertext markup language interface to the user device.

28. An apparatus in accordance with claim 26 which comprises a server providing a web interface configurable into a template.

29. An apparatus in accordance with claim 28 which comprises a server storing the template containing business metrics data.

30. An apparatus comprising:
means for providing a web interface to a user;
means for configuring the web interface to a template
means for entering business metrics data in the template
means for storing and retrieving the template.

31. An apparatus in accordance with claim 30 comprising means for providing a hypertext markup language interface to the user device.

32. An apparatus in accordance with claim 31 comprising means for a providing a web interface configurable into a template.

33. An apparatus in accordance with claim 32 comprising means for storing the template containing business metrics data.

34. A computer-readable medium executable by a computer connected to a user device, for controlling the computer to:
Receive a request to provide a web interface;
Provide a web interface configurable to a template;
Receive business metrics data in the template;
Store the template.

35. A computer-readable medium in accordance with claim 34 where
the computer is a server and is controlled to provide a hypertext
markup language interface to the user device.

36. A computer-readable medium in accordance with claim 34 where
the computer is a server and is controlled to provide a web interface
configurable into a template.

37. A computer-readable medium in accordance with claim 34 further comprising business metrics data.

37. A database comprising business metrics data obtained from a template.

38. A database in accordance with claim 37 further comprising relational data associated with the business metrics data.
